(19) United States
(12) Patent Application Publication
(10) Pub. No.: US 2025/0099893 A1
(43) Pub. Date: Mar. 27, 2025

(54) SELF-CLEANING FILTER MEDIA

(71) Applicant: Pyne Inc., Fremont, CA (US)

(72) Inventor: Vahid KHADEMI, Fremont, CA (US)

(21) Appl. No.: 18/647,317

(22) Filed: Apr. 26, 2024

Related U.S. Application Data
(63) Continuation of application No. PCT/US22/79258, filed on Nov. 3, 2022.
(60) Provisional application No. 63/275,930, filed on Nov. 4, 2021.
(60) Provisional application No. 63/275,931, filed on Nov. 4, 2021.
(60) Provisional application No. 63/275,932, filed on Nov. 4, 2021.

(51) Int. Cl. B01D 46/762; B01D 46/52; B01D 46/70

(52) U.S. Cl. CPC B01D 46/762; B01D 46/521; B01D 46/70

(57) ABSTRACT

Systems and methods of self-cleaning filtering may include: (a) filtering, via a filter media comprising a clean side and a dirty side, a fluid, thereby accumulating particles from said fluid on said dirty side; and (b) shaking, via one or more shaking sources, one or both of (i) a filter housing in physical contact with said filter media or (ii) a reinforced structure in physical contact with said filter media, thereby causing said filter media to shake to dislodge at least a portion of said particles from said dirty side of said filter media.

### CROSS-REFERENCE

This application is a continuation of International Application No. PCT/US22/79258, filed Nov. 3, 2022, which claims the benefit of U.S. Provisional Application No. 63/275,930, filed Nov. 4, 2021, U.S. Provisional Application No. 63/275,931, filed Nov. 4, 2021, and U.S. Provisional Application No. 63/275,932, filed Nov. 4, 2021, which are herein incorporated by reference in their entireties.

### BACKGROUND

Fluid filtration may include the filtering and purifying of fluid (e.g., gases, liquids, etc.), and may include or involve trapping, changing chemical composition, or otherwise eliminating (e.g., filtering, etc.) particles, or the like in such fluids. Fluid filtration may be applied to any industries where fluid needs to be purified or filtered; for example to automotive industry, heavy-duty vehicles, motor vehicles, public transportation (e.g., trains, airplanes, etc.), agricultural machineries, construction machineries, mining machineries, scientific research facilities, medical facilities, personal protective equipment (e.g., facemasks or respirators), residential and commercial, manufacturing, industrial plants, food and beverage industry, pharmacological industry, cleaning tools and machinery (e.g., vacuum cleaners), and other such fields of use.

Filter media may include fibrous or porous materials which remove solid particles (e.g., ash, dust, dirt, debris, granules, lint, mold, pathogens, pollen, powder, soot, etc.) from the fluid. Filters containing an adsorbent or catalyst such as charcoal (carbon) may also remove odors and gaseous pollutants such as volatile organic compounds or ozone. Some filters use foam, pleated paper, or spun fiberglass filter elements. Some filters use fibers or elements with a static electric charge, which attract particles. Some filters use oil baths to trap particles.

Fluid filtration may be important to the operation of machinery, such as a filter on a car that filters air before the air enters the engine or the cabin of the car. In some cases, fluid filtration may be important for health, such as an air purifier or a high efficiency particulate arrestor (HEPA) filter in a hospital that filters out infectious diseases such as COVID-19. In some cases, fluid filtration may be important for cleaning dust, such as a filter that operates inside a vacuum cleaner, such as an autonomous vacuum cleaner.

As filtration systems operate, the filter media (e.g., porous filter media) may become coated and filled with particles. The presence of the particles on the filter media may degrade performance of the filtration system with each usage and overtime over time. As such, to reduce performance degradation, filter media in filtration systems may be replaced relatively early in their lifespan. Replacement of filter media typically involves ceasing operation of the filtration system for at least the time spent replacing the filter media.

### SUMMARY

The present disclosure describes, in some cases, systems and methods for self-cleaning filter systems that enhance the performance of the filtering operations and reduce replacement cost (e.g., by increasing the lifetime of filter), maintenance cost, and labor cost. Additionally, the systems and methods described herein may reduce required power during operation of filter systems, while, in various cases, enhancing the fluid quality or otherwise imparting improvements compared to conventional filtering techniques.

In some aspects, the present disclosure provides a self-cleaning filtration system, comprising: (a) a filter media comprising a clean side and a dirty side, wherein said dirty side is configured to accumulate particles from a fluid while performing a filtering operation on said fluid; (b) one or both of (i) a filter housing in physical contact with said filter media or a (ii) reinforced structure in physical contact with said filter media; and (c) one or more shaking sources configured to shake one or both of said filter housing or said reinforced structure, thereby causing said filter media to shake to dislodge at least a portion of said particles from said dirty side of said filter media.

In some aspects, the present disclosure provides a self-cleaning filtering method, comprising: (a) filtering, via a filter media comprising a clean side and a dirty side, a fluid, thereby accumulating particles from said fluid on said dirty side; and (b) shaking, via one or more shaking sources, one or both of (i) a filter housing in physical contact with said filter media or (ii) a reinforced structure in physical contact with said filter media, thereby causing said filter media to shake to dislodge at least a portion of said particles from said dirty side of said filter media.

Additional aspects and advantages of the present disclosure will become readily apparent to those skilled in this art from the following detailed description, wherein only illustrative embodiments of the present disclosure are shown and described. As will be realized, the present disclosure is capable of other and different cases, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative cases, in which the principles of the invention are utilized, and the accompanying drawings (also “Figure” and “FIG.” herein), of which:

FIG. 1A-FIG. 1C illustrate three example filter media implementations, consistent with certain examples of the present disclosure.

FIG. 2 illustrates a diagram of example traditional or direct flow filtering operation (a.k.a. filtering operation), consistent with certain examples of the present disclosure.

FIG. 3 illustrates a diagram of an example self-cleaning filtering/flow operation or operation (a.k.a. self-cleaning operation), consistent with certain examples of the present disclosure.

FIG. 4A-FIG. 4D illustrate diagrams of three implementations, of cross sectional aspects of illustrative filters, e.g., related to filter and structure, filtering operation and particle dislodging processes or operations, namely FIG. 4A (filter structure and structure), FIG. 4B (filtering operation), and FIG. 4C (cleaning operation), and FIG. 4D (examples of relative applied load in an example examples), consistent with certain examples of the present disclosure.

FIG. 4E-FIG. 4G illustrate three example filter media implementations, consistent with certain examples of the present disclosure.

FIG. 5 illustrates various example waveforms applied as a process of shaking a filter to perform self-cleaning of the filter consistent with certain examples of the present disclosure.

FIG. 6 illustrates a diagram of example filter fibers of filter media accumulating various particles consistent with certain examples of the present disclosure.

FIG. 7A and FIG. 7B illustrate two example self-cleaning filtration system of representative self-cleaning filtration systems, which may be fixed relative to an X-Y-Z coordinate system (as shown, or otherwise), consistent with certain examples of the present disclosure.

FIG. 7C and FIG. 7D illustrate two relative positions of the example conic filter media in such self-cleaning filtration system, consistent with certain examples of the present disclosure.

FIG. 8A-FIG. 8F illustrate a top perspective view of various example self-cleaning filtration system assemblies, consistent with certain examples of the present disclosure.

FIG. 9A and FIG. 9B illustrates perspective and exploded views, respectively, of an example self-cleaning filtration system, consistent with certain examples of the present disclosure.

FIG. 10A illustrates an example filter including actuator/sensor components or compartments, consistent with certain examples of the present disclosure.

FIG. 10B illustrates another example filter including actuator/sensor components or compartments, consistent with certain examples of the present disclosure.

FIG. 10C illustrates still another example filter including several actuators/sensors compartments, consistent with certain examples of the present disclosure.

FIG. 11 illustrates a representation of an example self-cleaning filtration system or system, consistent with certain examples of the present disclosure.

FIG. 12 illustrates a representation of an example of filter components, e.g., such as the relative location of an example sensors with respect to an example main filter media, consistent with certain examples of the present disclosure.

FIG. 13A-FIG. 13F illustrate example actuators, consistent with certain examples of the present disclosure.

FIG. 14 illustrates a diagram of an example energy harvester, including the relative location of an example energy harvester with respect to an example main filter media, consistent with certain examples of the present disclosure.

FIG. 15 illustrates a diagram of an example of ducting and pre/post filters configuration with respect to an example filter media (e.g., an example including a secondary inlet and outlet), consistent with certain examples of the present disclosure.

FIG. 16 illustrates a diagram of an example filtration system including additional disinfecting or cleaning aspects, consistent with certain examples of the present disclosure.

FIGS. 17A-FIG. 17D illustrate example diagrams of various prefilter, main filter, and post-filter media or materials as may be utilized in example filtration mechanisms or filtration systems of the disclosed technology, consistent with certain examples of the present disclosure.

FIG. 18 illustrates an example electrostatic air filter with respect to which the disclosed filtration mechanisms or filtration systems may be utilized, consistent with certain examples of the present disclosure.

FIG. 19A-FIG. 19C illustrate diagrams of example flow paths for implementations of continuous filtration, with respect to which one or more aspects of the disclosed filtration mechanisms or filtration systems may be utilized, consistent with certain examples of the present disclosure.

FIG. 20A-FIG. 20F illustrate diagrams of example self-cleaning dual filtration systems and methods, consistent with certain examples of the present disclosure.

FIG. 21A and FIG. 21B illustrate diagrams of operation of an example self-cleaning cleaning filtration system, consistent with certain examples of the present disclosure.

FIG. 22A and FIG. 22B illustrate diagrams of operation of another example periodic cleaning filtration system, consistent with certain examples of the present disclosure.

FIG. 23A and FIG. 23B illustrate perspective and exploded views of an example filtration device, consistent with certain examples of the present disclosure.

FIG. 24A and FIG. 24B illustrate cross-sectional views of an example filtration device depicting illustrative directions of fluid flow paths for both filtering operation and for cleaning operation, consistent with certain examples of the present disclosure.

FIG. 25 illustrate a cross-sectional view of an example filtration device having planar filter media, consistent with certain examples of the present disclosure.

FIG. 26A-FIG. 26C illustrate diagrams of example self-cleaning filtration systems and methods consistent with certain examples of the present disclosure.

FIG. 27A and FIG. 27B illustrate diagrams of operations of one example periodic cleaning air filtration system, including filtering operation (FIG. 2A) and cleaning operation (FIG. 27B), consistent with certain examples of the present disclosure.

FIG. 28A and FIG. 28B illustrate diagrams of operations of another example periodic cleaning air filtration system, including filtering operation (FIG. 28A) and cleaning operation (FIG. 28B), consistent with certain examples of the present disclosure.

FIG. 29A-FIG. 29D illustrate example air purification systems, consistent with certain examples of the present disclosure.

FIG. 30 illustrates an exploded view of an example self-cleaning filtration system, consistent with certain examples of the present disclosure.

FIG. 31 illustrates an example process for assembling a filter structure, consistent with certain examples of the present disclosure.

FIG. 32 illustrates two perspectives of another example self-cleaning filtration system, consistent with certain examples of the present disclosure.

FIG. 33A and FIG. 33B illustrate perspective and exploded views, respectively, of an example self-cleaning filtration system, consistent with certain examples of the present disclosure.

FIG. 34A and FIG. 34B illustrate example self-cleaning filtration systems with rotary and linear actuators, respectively, consistent with certain examples of the present disclosure.

FIG. 35 illustrates an example self-cleaning filtration system with a grille and a collector, consistent with certain examples of the present disclosure.

FIG. 36A and FIG. 36B illustrates an example autonomous vacuum system implementing an example self-cleaning filtration system, consistent with certain examples of the present disclosure.

FIG. 37A-FIG. 37D illustrate various example performance data of a self-cleaning filtration system, consistent with certain examples of the present disclosure.

FIG. 38 illustrates example operating life data of a self-cleaning filtration system, consistent with certain examples of the present disclosure.

FIG. 39 illustrates a computer control system that is programmed or otherwise configured to implement methods provided herein, consistent with certain examples of the present disclosure.

FIG. 40 illustrates an example method for self-filtering media, consistent with certain examples of the present disclosure.

### DETAILED DESCRIPTION

In various examples, the systems and methods described herein may contribute to the elongation of the lifetime of filters and the increase of efficiency of filters of various uses. For example, implementing the systems and methods described herein on an intake air system, exhaust system, fuel system, cooling system, etc., may improve the efficacy and performance of the engine significantly. In another example, the systems and methods described herein may be utilized by emission systems to reduce the emission and improve the performance and lifetime of the emission systems. In another example, applying the systems and methods described herein to motor vehicles including off-road, heavy duty, agricultural, mining, or construction vehicles may reduce engine maintenance (e.g., oil changes, repair) as less such dust and other particles are sucked into the engines. While described in part in the Background Section, additional examples in which the systems and methods described herein may improve filter efficiency and performance include: motor vehicles, transportation (e.g., trains, airplanes, buses, etc.), agricultural, construction, mining, industrials and manufacturing, industrial plants, healthcare, utilities, consumer goods, residentials, HVAC systems, home appliances (e.g., vacuum cleaners), air purifiers, power generation, oil and gas machinery, chemical and petrochemicals, paper and painting, process industry, food and beverage, semiconductors and electronic, packaging, water/liquid filtration systems, power metallurgy industries, 3D printing industries, heavy-duty vehicles, scientific research facilities, personal protective equipment, food and beverage industry, pharmacological industry, cleaning tools and machinery (e.g., industrial vacuums), and other such industries where the filtration technologies are needed.

Additional advantages of the disclosed technology may include extending the lifetime of filter media, thereby reducing waste and use of excess filter media. Accordingly, various upflow processing requirements (e.g., at fabrication, etc.) and downflow processing (e.g., with respect to disposal, etc.) of such filter media are reduced. The systems and methods described herein may be highly economical, providing direct savings in the fabrication and use of such filters (e.g., less replacement parts needed, lower replacement part costs, less labor costs, or less maintenance time, among others). Further, the systems and methods described herein may be highly economical via providing indirect savings when integrated and used in existing systems and technologies, such as increased efficiency, improved miles-per-gallon for gasoline/diesel/compressed natural gas, or other fuel-based or hybrid automobiles or other motor vehicles, etc., better acceleration and efficiency for vehicles, less engine repair over time, less labor cost, among other related or indirect benefits. In many examples, one or more of the maintenance cost, part cost, or labor cost may be reduced significantly by implementing the systems and methods described herein while at least maintaining the quality or purity of cleaned fluid. In another example, the systems and methods described herein can be implemented to current filtration systems by modifying their designs. Also, for some implementations, new filtration systems may be designed based on these technologies for any desirable applications.

As described in further detail below, improved performance may be characterized by lifetime of filter, required power, velocity, pressure drop, number of particles with specific sizes in flow, flow rate of the fluid or filter mass, or other parameters at the inlet or outlet. Moreover, by utilizing the disclosed systematic or automatic self-cleaning filtration systems or methods, the quality of cleaned fluid may be improved or higher as compared against the quality of cleaned fluid by conventional filtration during the lifetime as the filter media cleaned frequently as follow. The quality of the filtered fluid may be characterized by the concentration of particles, or visual quality of the inlet and outlet flow.

In some cases, the present disclosure includes systems and methods for self-cleaning filter media, before, during, or after filtering operation, that dislodge particles (e.g., ash, dust, dirt, debris, granules, lint, pathogens, mold, pollen, powder, soot, etc.) from the filter media. In some cases, the systems or methods described herein may be utilized during the filtering operation with or without interrupting the filtering operation. Further, in some cases, the systems or methods described herein may also include or involve systems and methods configured to clean filters externally, e.g., systems or methods that may be built as a separate system to specifically clean used or dirty filters (e.g., such as a system to clean the used filter, etc.) or implemented on other system (e.g., such as implemented on or via an air purifier, implemented on or via a vehicle intake air box, implemented on or via a vehicle exhaust system, a vacuum cleaner, etc.) based on the disclosed technologies or which may be utilized to clean the filters.

Various self-cleaning systems and methods described herein include various techniques for external and self-cleaning of the filter via one or more mechanical, chemical or radiation techniques that can clean the filter, extend its useful operational time, increase efficiency, and improve the quality of the filtered fluid without the need to physically replace the filter media, among other features and advantages set forth or inherent herein. In some cases, the mechanical techniques may include shaking the filter or the filter housing, either directly or indirectly. As used herein, “shaking” (as well as other tenses of “shaking,” such as, “shake,” “shakes, “shook,” “shaken”) may refer to one or more of: agitating, beating, bumping, convulsing, disturbing, flapping, flickering, fluttering, hitting, impacting, jarring, jerking, jolting, moving, oscillating, palpitating, perturbing, pulsating, pulsing, quaking, rattling, resonating, reverberate, rippling, rocking, shaking, shivering, shuddering, stimulating, swaying, swinging, throbbing, tottering, trembling, tremoring, undulating, upsetting, vibrating, waggling, waving, wiggling, or whipping, or any other mechanical motion that may be one or more of: repetitive in some respect, not repetitive in some respect, periodic, non-periodic, about an equilibrium, not about an equilibrium, or in one or more directions. Shaking the filters, e.g., mechanically, electromechanically, by other sonic or wave energy, or via other techniques set forth herein, including but not limited to via shaking, vibrating, hitting, impacting, moving, scrubbing the filter media, or impacting the filter mechanically or with sonic/wave/any bombardment/etc. of energy to release the undesirable particle from the filter media. In some cases, shaking may refer to propagation of a mechanical wave, such as a mechanical wave with a high frequency (e.g., the frequency may be about 1 kHz to about 500 kHz) and a low amplitude (e.g., 10 nanometers to 100 micrometers). In some cases, the mechanical techniques may include reversing flow direction, which may include mechanically causing fluid to flow from a clean side of the filter toward a dirty side (e.g., the side of the filter in which particles accumulate) of the filter to facilitate the release of undesirable particles from the filter media. In some cases, the chemical or radiative techniques may be used to disinfect the filter media, such as destroying pathogens, particles or undesired chemical compounds present in, on, or near the filter media. For example, the chemical techniques may include implementation of chemical reactions in, on, or near the filter media. For example, the radiative techniques may include application of Ultraviolet (UV) radiation, thermal radiation, etc. to or near the filter media or on the path of the flow. In some cases, the system may be equipped with Artificial Intelligence (AI), Machine Learning (ML), and other such technologies to determine or optimize the cleaning operation and filtering operation. Filter media may be cleaning once or frequently by dislodging the particles that accumulated (e.g., diffuse, permeate, attach, adhere, build up, are trapped, etc.) at the filter media before, during, or after the filtering operation (depending on applications). In some cases, a pre-cleaner mechanism may be used to separate some particles from a fluid before filtration by a filtration system. In some applications, the filtration system may send or receive the data to or user which may be another device, systems, controller, or a human. In some cases, self-cleaning filtration, may be used in conjunction with other cleaning techniques as well as with other techniques to dislodge particles or disinfect, destroy, or kill pathogens accumulated at filter media. According to implementations herein, the time interval between cleaning operations may be determined based on each application, as discussed elsewhere herein.

### Example Filter Implementations

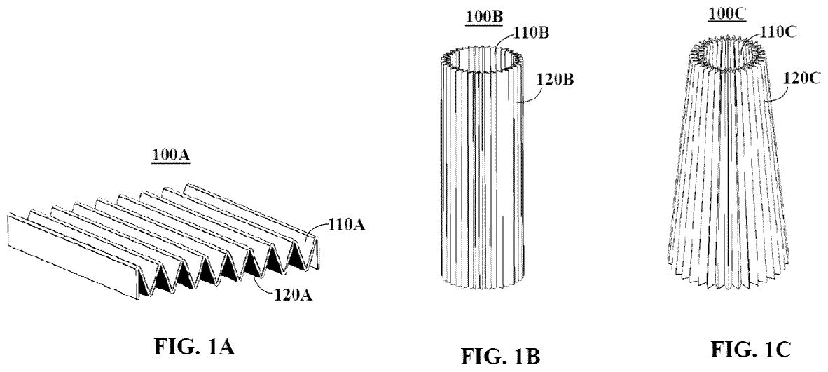

FIGS. 1A, 1B, and 1C are diagrams illustrating three example filter media/filter implementations or shapes, consistent with examples of the present disclosure.

FIG. 1A illustrates a flat filter 100A. As illustrated, the flat filter 100A includes a clean side 110A and a dirty side 120A. The flat filter 100A (also known as “flat panel filters”) may be commonly used in an HVAC system as it is flat and may be comprised of disposable panels. The flat filter 100A, as used in HVAC systems may be comprised of fiberglass and may be among the most inexpensive options for HVAC systems. The flat filter 100A, as used in HVAC systems, may be porous, allowing air to pass through freely while accumulating larger particles. Flat filters, like the flat filter 100A, may also be placed inside a box connected to the throttle body with duct work when used in fuel injected vehicles. The zig-zag shape of the flat filter 100A increases the surface area of the filter media in proportion to the overall footprint of the flat filter 100A. The flat filter 100A may be used in motor vehicles, vacuum cleaners, air purifiers, etc. The flat filter 100A may be used in other applications such as motor vehicles, transportation (e.g., trains, airplanes, buses, etc.), agricultural, construction, mining, industrials and manufacturing, industrial plants, healthcare, utilities, consumer goods, residentials, HVAC systems, home appliances (e.g., vacuum cleaners), air purifiers, power generation, oil and gas machinery, chemical and petrochemicals, paper and painting, process industry, food and beverage, semiconductors and electronic, packaging, water/liquid filtration systems, power metallurgy industries, 3D printing industries, heavy-duty vehicles, scientific research facilities, personal protective equipment, food and beverage industry, pharmacological industry, cleaning tools and machinery (e.g., industrial vacuums), and other such industries where the filtration technologies are needed.

FIG. 1B illustrates a cylindrical filter 100B. As illustrated, the cylindrical filter 100B includes a clean side 110B and a dirty side 120B. As an example, Heavy duty motor vehicles that may use a cylindrical air filter like the cylindrical filter 100B that is often between 100 millimeters and 400 millimeters in diameter.

FIG. 1C illustrates a conical filter 100C. As illustrated, the conical filter 100C includes a clean side 110C and a dirty side 120C. Performance motor vehicles may use a conical air filter like the conical filter 100C. In some cases, the conical filter 100C includes a clean side 120C and a dirty side 110C

According to various examples, the geometry of filter media can be flat, cylindrical, conical, or any other arbitrary geometry depending on application, usage, and assigned space for filtration system. While various illustrative examples are shown and described herein, these implementations and the figures herein are provided as example representations, for illustration., and do not limit the scope of the disclosed technology and innovations herein.

### Example Filtering Operation

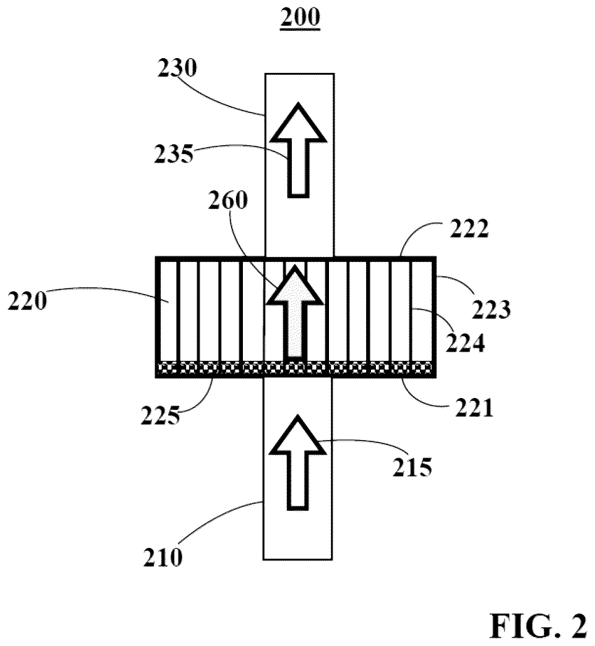

FIG. 2 is a diagram illustrating an example traditional or direct flow filtering operation for (a.k.a. filtering operation) filter media 220 (which may be the same as or similar to any of the other filter media discussed herein, e.g., any of the filter media 100A-C), consistent with examples of the present disclosure. Referring to FIG. 2, the filtering operation begins with a main inlet 210, which is the entrance for raw fluid flow 215, which travels into the filter media 220 from dirty side 221 of the filter media 220. The filter media 220 may be in physical contact with a filter housing 223 and a reinforced structure 224.

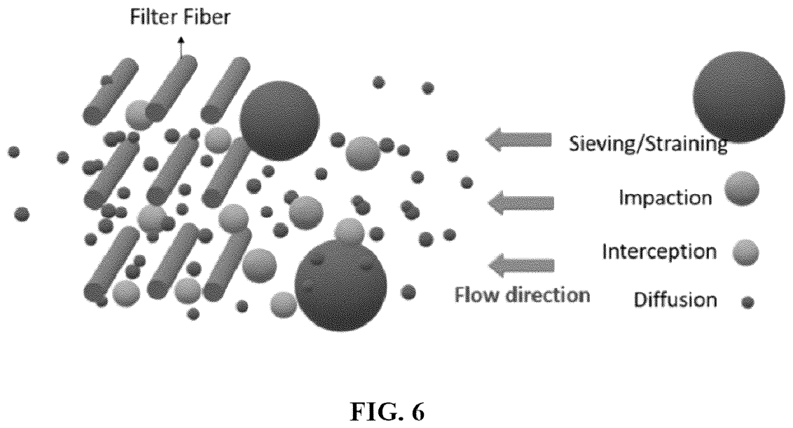

Once the raw fluid flow encounters the filter media, the raw fluid flow 215 may leave an accumulation of particles 225 at the dirty side 221 of the filter media 220. The accumulated particles 225 may be at different depths in the filter media (e.g., as described with respect to FIG. 6) depending on size of each of the accumulated particles 225, the properties (e.g., pore size) of the filter media 220, or the properties (e.g., speed, direction, particle type, electrical charge, etc.) of the raw fluid flow 215.

After filtration of the raw fluid flow 215 and the accumulated particles 225 in the filter media 220, cleaned fluid 235 exits from clean side 222 of the filter media 220. The cleaned fluid flow 235 may include reduced particles as compared to the raw fluid flow 215. The cleaned fluid flow 235 may exit through a main outlet 230, which provides the cleaned fluid flow 235 (e.g., to an engine, or any other systems as described in the Background Section, for example).

In this illustrated example, during filtering operation of the filtration, the flow is from the dirty side 221 of the filter media 220 (here, at bottom) to the clean side 222 of the filter media 220 (here, at top). The raw fluid 215 enters the system via main inlet 210. The raw fluid 215 passes through the filter media 220, which traps, destroys, or kills the particles to purify the raw fluid 215 into the cleaned fluid flow 235.

The main outlet 230 may cover the whole clean side 222 of filter media 220. The main inlet 210 may cover the whole dirty side 221 of filter media 220. It should be understood that inlets, outlets, and ducts shown herein are to illustrate examples of relative positions of the inlets, the outlets, and the ducts with respect to filter media, and not necessarily the geometry of the inlets, the outlets, and the ducts.

### Example Self-Cleaning Operation

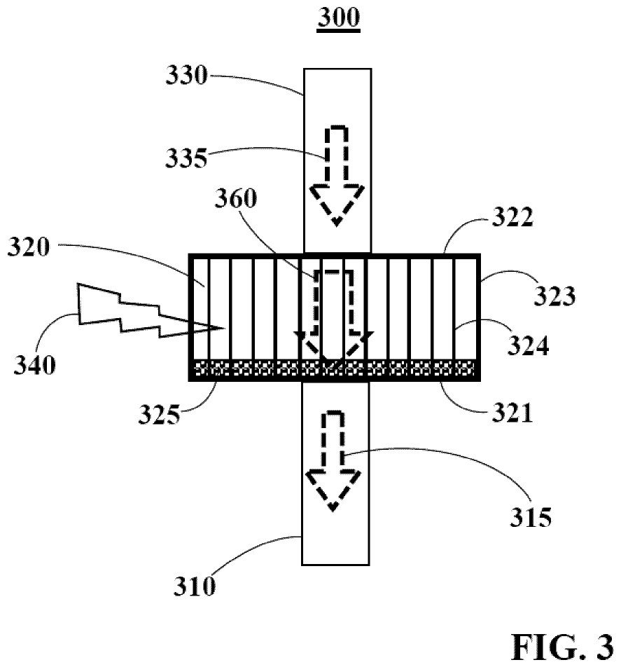

FIG. 3 is a diagram 300 illustrating an example automatic, self-cleaning operation of filter media 320 (which may be the same as or similar to any of the other filter media discussed herein, e.g., the filter media 220), consistent with examples of the present disclosure. As previously-discussed, one or more mechanical, chemical or radiation techniques may be used for cleaning filter media. FIG. 3 illustrates the use of two mechanical techniques, namely (i) shaking and (ii) reversing flow direction.

Referring to FIG. 3, a fluid flow 335 enters the filter media 320 from a clean side 322 of the filter media 320. This reverse flow (flow from the clean side 322 of the filter 320 to a dirty side 321 of the filter 320) passes through the filter media 320 in an opposite direction as described during filtering operation with respect to FIG. 2. The reverse flow 335 may not be implemented in some applications.

As further illustrated in FIG. 3, the filter media 320 may be shaken, as shown at 340. In some cases, the shaking at 340 may occur while the reverse flow is occurring. In some cases, the shaking at 340 may occur before or after the reverse flow is occurring. Such reverse flow and shaking 340 aspects may dislodge the accumulated particles 325 from the dirty side 321 of the filter media 320, thereby creating a dirty flow 315 that leaves the filter media 320, via an outlet 310. The example shown in the diagram 300 includes at least one shaking operation, which may include one or more of the various types of shaking disclosed elsewhere herein. According to certain implementations, the filter media 320 may be placed in a filter housing 323 or in a reinforced structure 234 during cleaning operation.

With regard to such examples that include a shaking operation on the filter media 320, the filter media 320 may be manipulated or engaged in a manner forcing the filter media 320 to shake (e.g., vibrate, oscillate, wobble, impact, beat, hit, move, rotate, translate, scrub, shock, resonated, sonically or otherwise impinged with wave or similar energy, etc.), directly or indirectly, in any of the 6 degrees of freedom (DOFs) in space, with respect to a fixed coordinate system, or any combination of them (e.g., 3 translational DOFs and 3 rotational DOFs, etc.) to enhance or facilitate the dislodging (e.g., release or removal) of the accumulated particles 325 from the filter media. The shaking 340 may be applied in various ways, including but not limited to in one step, in multiple steps, in a cyclic way for desired durations of time, at desired frequency or frequency range, at desired speed (subsonic, or supersonic, or ultrasonic), at desired amplitude (from nano meter to tens of millimeters) depending on applications. In some cases, the shaking 340 can include any shock, impulsive force, impact, continuous or intermittent oscillations, or the like where a force is applied as a function of factors such as at a target period, based on the specific particles to be dislodged (e.g., size, weight, composition, chemical composition or nature, structure, mechanical bonding, electrical charge, etc.). In some cases, the shaking 340 may generate mechanical wave at high frequencies (e.g., 1 kHz to 500 kHz, etc.) and low amplitudes (e.g., tens of nanometers to tens of micrometers). In some cases, the shaking 340 may be applied directly or indirectly to the filter housing 322 or to the filter media 320 by any intermediate tool that applies shaking forces thereto. Further, in some cases, the frequency, magnitude, and amplitude of force or displacement of the applied shaking forces causing the shaking 340 may be random, constant, repeating, or swiping a range of frequencies, magnitudes, and amplitudes (e.g., actuators may shake at a frequency range between about 0.01 Hz and about 1 kHz, between about 1 kHz and about 500 kHz, from nanometer to mm, depending on application, particles or other parameters set forth herein). Additionally, in some cases, the shaking 340 can be forced control or displacement control or both.

In some cases, the filter media 320 may be fixed or held by filter housing 322 or a reinforced structure 324 in a manner that the filter media 320 has no relative motion with respect to the reinforced structure 324 or filter housing 323 in attached areas. In some cases, the filter housing 323 is a structure that holds the filter media 320. The reinforced structure 324 is a structure that reinforces the filter media 320, adding stability and durability to the filter media 320 and reducing wear, creep, bucking, etc. of the filter media 320 during cleaning operation when the filter media 320 shakes 340. In some cases, the filter housing 323 and reinforced structure 324 may be one integrated structure. Further, in other cases, the filter housing 323 and reinforced structure 324 may be two or more separate components. The filter media 320 may be attached to the reinforced structure 324 or filter housing 323 by compression force, glue, rubber, or any other techniques in a way that the filter media 320 does not have any relational movement, displacement, or sliding with respect to filter housing 323 and reinforced structure 324 during cleaning operation. In some cases, the elastic modulus of the filter housing 323 and reinforced structure 324 may be higher, in order of magnitude to provide enough rigidity with respect to the filter media. The rigidity or elastic modulus of the filter housing 322 or reinforced structure 324 may be relatively higher than rigidity or the elastic modulus of the filter media 320 in order to prevent the wear, creep, buckling, distortions, tear, damage, or the like to the filter media 320 when the load is applied during cleaning operation. Here, for example, the elastic modulus of the filter housing 323 and reinforced structure 234 may be on the order of about 1 MPa to 700 GPa depending on filter housing 323 materials and reinforced structure 234. The reinforced structure 324 or filter housing 323 may be made of metallic materials, plastic materials, polymer materials, composite materials, or any other structural materials or a combination of several materials. In some cases, it may also be important that the shaking forces are not applied directly to the filter media 320 (e.g., because the filter media 320 may buckle). Hence, the shaking forces may be applied (e.g., by actuators) to the reinforced structure 324 or to the filter housing 323, or to at least one other component (for example rubber, polymer, etc.) that cover the filter media 320 in contact areas, or the like.

In some cases, the shaking 340 may be the result of shaking forces applied by one or more actuators during the cleaning operation. The actuators may apply the force to the filter housing 323 or the reinforced structure 324, which causes the filter media 320 to shake. In some cases, to reduce the accumulation of particles 325 into the filter media 320 via the particles 325 diffusing or penetrating into the filter media 320, the component of applied shaking force in the surface normal direction of the dirty side 321 of the filter media 320 may be zero or negative (e.g., here, where the outward direction to the surface normal of the dirty side 321 of the filter media 320 is considered the positive direction). For example, if the net force applied to the filter housing 323/the reinforced structure 324/the filter media 320 by actuators is perpendicular to the normal vector of the surface of the dirty side 321 of the filter media 320, then the component of force in normal direction to the surface of filter media 320 is zero (the component of force due to the actuators, on the filer media 320 in normal direction to the dirty side 321 of the filter media 320 is zero). As a result of this condition, the accumulated particles 325 may not diffuse/penetrate back into the filter media 320 because of the shaking 340. Hence, among other benefits, the lifetime, filtration efficiency, or the performance of the filter media 320 may increase. In some cases, during the cleaning operation, e.g., in order to minimize accumulation of the particles 325 at the filter media 320 via the particles 325 diffusing into the filter media 320, the component of the net acceleration due to the shaking 340, etc., in normal direction of the dirty surface of the filter media 320, applied from the filter media 320 to undesired might be zero or negative.

In some cases, to accelerate or improve the efficiency of the cleaning operation, a reverse flow 325 may be applied. The reverse flow 325 may be applied before, during, or after shaking process 340, depending on application. In some cases, the reverse flow 335 may not be applied, depending on application.

### Cross Section of Example Filter Media

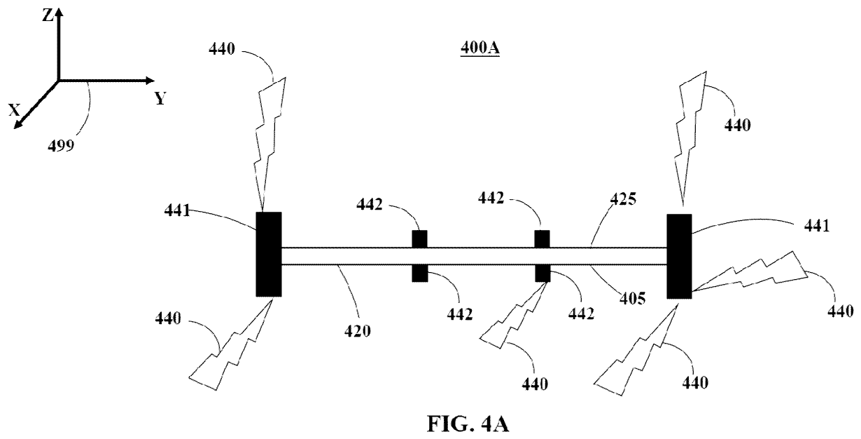

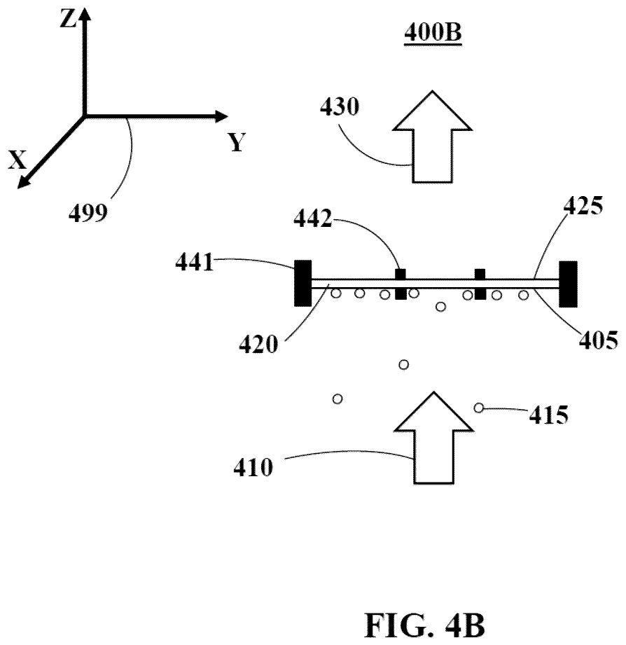

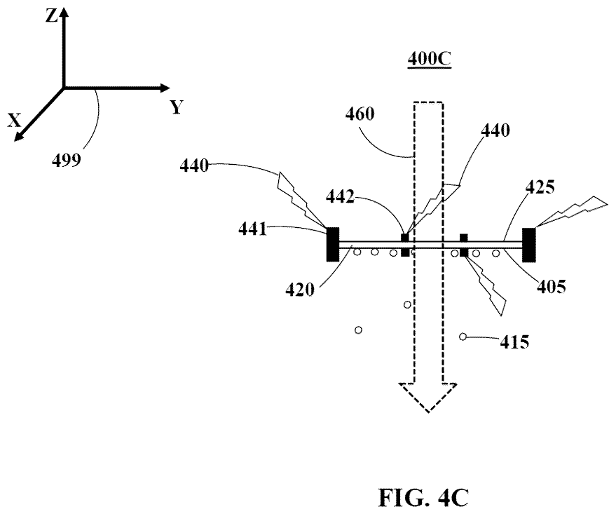

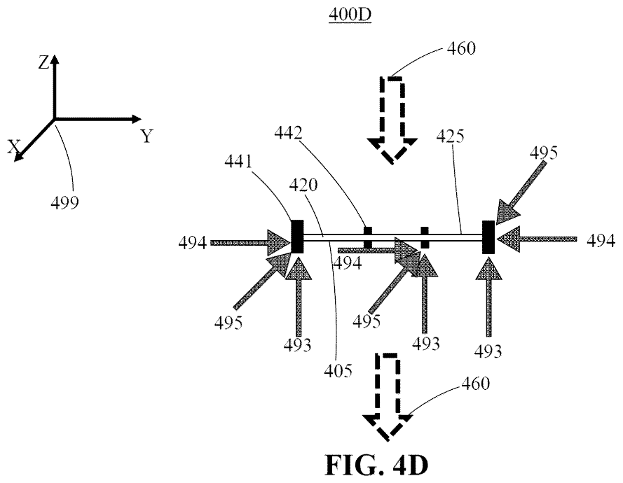

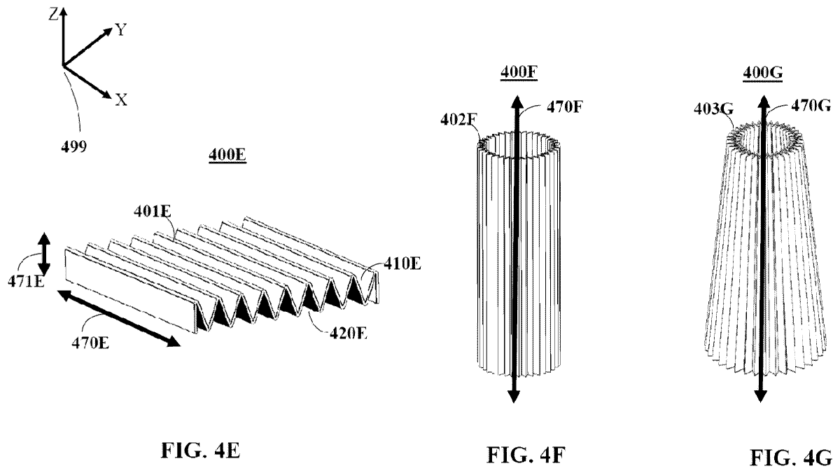

FIGS. 4A-4D illustrate cross section diagrams 400A-400D, respectively, of three implementations of e.g. cross sectional aspects of illustrative filters related to filter and structure, filtering operation and particle dislodging processes or operations, consistent with certain examples of the present disclosure. One or more components of the diagrams 400A-400D may be the same as or similar to other components of filters shown and described herein; for example, filter media 420 may be the same as or similar to the filter media 320 of FIG. 3.

FIG. 4A illustrates the cross section diagram 400A including the filter media 420 along with a filter housing 441 and a reinforced structure 442. The filter housing 441 and reinforced structure 442 may be made of a structural martials such a metallic, plastic, polymer, rubber, or composite materials, or the like. One function of the filter housing 441 and the reinforced structure 442 may be to provide stability (e.g., structural stability) to the filter media 420 during cleaning operation. Another function of the filter housing 441 and the reinforced structure 442 may be to hold the filter media 420 tightly such that there is no or minimal relative motion between the filter media 420 and the filter housing 441 and the reinforced structure 442 on the attached areas during a cleaning operation (e.g., when the filter media 420 is shaking). The filter housing 441 or reinforced structure 442 may transfer the force/mechanical wave/displacement applied by actuators (not shown here) through the filter media 420 during the cleaning operation, which may dislodge the particle from the filter media 420. The reinforced structures 442 may provide more structural stability to the filter media, which may prevent or reduce the wear, creep, tear, buckling, damage, rupture (e.g., due to shaking), while improving energy transmission through the filter media 420 during cleaning operation. The filter media 420 may be attached tightly to the filter housing 441 or reinforced structure 442 by glue, compression force, rubber, or the like. The filter media 420 may be attached tightly to the filter housing 441 or reinforced structure 442 and may be built as an integrated compartment during manufacturing. The applied shaking force that may causes the filter media 420 to shake during the cleaning operation may be transfer by the filter housing 441 or reinforced structures 442. The geometry, shape, structure, and materials of the filter housing 441 and the reinforced structure 442 may be dependent on application and design requirements.

During the cleaning operation, in order to reduce the wear rate, creep rate, and prevent buckling of the filter media 420, and to minimize the damage to the filter media 420, actuators may apply a shaking force 440, directly (e.g., actuators are attached to the filter housing 441 or the reinforced structure 442, etc.) or indirectly (e.g., by electromagnetic force, etc.), to the filter housing 441 or the reinforced structure 442. As a result of the shaking force 440, the filter media 420 may shake as the filter media 420 is tightly connected to the filter housing 441 and the reinforced structure 442.

FIGS. 4B and 4C are cross section diagrams 400B and 400C, respectively, illustrating two implementations related to filtering operation and dislodging of particle processes or cleaning operations. More specifically, FIG. 4B illustrates an example filtering operation and FIG. 4C illustrates an example cleaning operation, consistent with examples of the present disclosure.

Referring to FIG. 4B, during the filtering operation, a raw fluid flow 410, including particles 415, enters an inlet (at bottom) and moves toward a dirty side 405 of filter media 420. As the raw fluid flow 410 encounters the filter media 420, an accumulation of the particles 415 forms at the dirty side 405 of the filter 420. After such filtration of the particles 415 from the raw fluid flow 410, the cleaned fluid flow 430 exits from the clean side 425 of the filter media 420, and then the cleaned fluid flow 430 leaves the filtration system, out an outlet (at top).

Referring to FIG. 4C, the self-cleaning operation begins with a reverse flow 460 starting at an inlet (at top), passing into filter media 465 from a clean side 425 of the filter media 420. During such cleaning operation, the reverse flow 460 passes through the filter media 420 from the clean side 425 to a dirty side 405, while the filter media 420 is shaken 440, due to applied force at filter housing 441 or reinforced structure 442. The reverse flow 460 and shaking 440 may dislodge accumulated particles 415 from the dirty side 405 of the filter media 420, creating a dirty flow that exits the filter media 420 via an outlet (at bottom). The inlet for cleaning operation may be the same as the outlet for filter operation in some applications, or have some common path, at least. The outlet for cleaning operation may be the same as the inlet for filtering operation, in some applications or have some common path, at least.

FIG. 4C shows a cross section of filter media 420, to which particles 415 attached during a normal filtration process (e.g., as depicted with respect to FIG. 4B). In some cases, to dislodge the particles 415, the filter media 420 may be shaken 440 due to applied force (which may come from actuators such as physical, wave or energy, etc.) at filter housing 441 or reinforced structure 442, as set forth in more detail elsewhere herein. Further, in some cases, during the cleaning operation, such external forces from the actuators may be applied to the filter media 420, thereby shaking the filter media 420.

Further, in some implementations, during the cleaning operation illustrated in FIG. 4C, to generate the reverse flow 460 from the clean side 425 of the filter media 420 to the dirty side 405 of the filter media 420 and out the filter media 420 as a dirty flow, the direction of flow (compared to normal filtering direction) may be reversed. While in other cases (not shown), the filter media 420 can be flipped over such that, while keeping the relative flow direction the same (compared to normal filtering direction), the flow travels from the dirty side 405 of the filter media 420 to the clean side 425 of the filter media 420.

In some cases, as shown in FIG. 4B, during the filtering operational process, fluid flows (push/pull) from the dirty side 405 toward the clean side 425 of filter media 420. In cleaning operation examples at FIG. 4C, the fluid flows (push/pull) from the clean side 425 to the dirty side 405 of the filter media 420. According to examples of the disclosed technology, the source (e.g., jet pulse, motor, fan, blower, pressure differences between clean side and dirty side 405 of filter media, any other such mechanism or system, etc.) to generate the flows may be implemented or utilized on either side of the filter media 420 to generate the desired flow direction. In some cases, one flow source may generate both the forward (e.g., flow 410 and 430) and the reverse flow (e.g., the flow 460). In some cases, more than one flow source may generate the forward (e.g., flow 410 and 430) and the reverse flow (e.g., the flow 460).

Referring to FIG. 4D, the cross section may represent that the filter media 420 is placed in the XY-plane (considering the XYZ-coordinates 499), where the dirty side 405 of filter 420 is in the negative Z-direction and the clean side 425 is in the positive Z-direction. To reduce the accumulation (e.g.,) diffusion of particles, especially the small size particles (order of tens of nanometers to micrometers) into the filter media 420, the net relative acceleration and velocity of the particles with respect to the filter media 420 in the Z-direction may be zero or negative. To satisfy this condition, the frequency, direction, and the magnitude of the shaking force may be adjusted accordingly during the cleaning operation. In some cases, the cleaning operation may include shaking the filter housing 441 or reinforced structure 442. In other cases, the cleaning operation may shake the filter housing 441 or reinforced structure 442 while the reverse flow 460 is present.

Referring to FIG. 4D, the cross section may include the filter media 420, the filter housing 441, and the reinforced structure 442. The Z-axis (see axes 499) is defined to be perpendicular to the filter media 420 surface, locally), where the dirty side 405 of filter 420 is in the negative Z-direction and the clean side 425 is in the positive Z-direction. In some cases, that actuators may generate mechanical waves with high frequencies (e.g., from about 1 kHz to 500 kHz) and low amplitudes (such as tens of nanometers to tens of micrometers), which the waves may transfer to the filter media via the filter housing 441 or reinforced structure 442 along the X-direction. The transferred mechanical waves may cause the filter media 420 to shake, which may result in particles 415 being dislodged from the dirty side 405 the filter media 420.

Referring to FIG. 4E, in some cases, a dirty side 420E of filter media 401E may face downward (e.g., toward the ground or the center of the Earth). In some cases, the filter media 401E is shaken such that the applied force has one component in Z-direction (see coordinate system 499; such Z-axis is defied to be perpendicular to the ground (here the ground is parallel to the XY-plane) and the positive Z-direction is defined from bottom to top, such that the positive Z-direction is defined to be in the oppositive direction of gravitational force of the Earth). During the cleaning operation, the component of the net applied force, (e.g., F_{Z} 493 of FIG. 4D), on the filter media 420E in the Z-direction may be zero or positive to reduce the accumulation of particles at the filter media 420 via the particles diffusing into the filter media 420E. When the filter media is moving toward the Earth, net acceleration of particles due to actuator and reverse flow in Z-direction is equal to a+b, where a acceleration due to actuator and b is acceleration due to reverse flow) should be equal or less than g, where g is the gravitational acceleration of the Earth (9.81 m/s²) to reduce the accumulation of particles at the filter media 401 via the particles diffusing into the filter media 401.

When the shaking force is applied repeatedly to the filter housing 441 or reinforced structure 442, the frequency of net applied load in Z-direction may be set lower than √(|g+a|/2X), where X is the maximum distance that the filter media 420 travels during half of a cycle of shaking. In some cases, g may be set as an upper bound for the shaking acceleration. In some cases, g+a may be set as an upper bound for the shaking acceleration. In some cases g+a−d, where d is an amount of acceleration of the particles lost due to drag, may be set as an upper bound for the shaking acceleration. These various possible conditions may extend the life of the filter media 420 significantly, especially when the displacement of the filter media 420 is on the order of millimeters or the frequency of the applied load is relatively low (less than 500 Hz) or the size of particles is relatively small (e.g., on the order of nanometers or micrometers). For example, consider a situation where the dirty side 491 of the filter media 420 faces the ground and actuators are placed on the dirty side 405. Then, the net force that is applied by the actuators is from the dirty side 405 to a clean side 425 (in positive direction of Z-axis). However, there is no limitation on frequency of applied force components in X- and Y-directions and when the amplitude of the displacement is very low (e.g., on the order of tens nanometer to tens of micrometers in some cases, etc.), the frequency of applied load may be very high (e.g., higher than about 500 Hz in some cases, etc.).

Referring to FIG. 4E, the flat filter media 401E may be shaken along the longitudinal direction 470E of the filter media during the cleaning operation. By shaking the filter media 401E along the longitudinal direction 470, the shaking direction is perpendicular to the dirty side 420E of the filter media 401E to reduce the accumulation of particles at the filter media 401E via the particles diffusing into the filter media 401E.

Referring to FIGS. 4F and 4G, the cylindrical filter 402F and conical filter 403G may be shaken along their central axis 470F and 470G, respectively, to reduce the accumulation of particles caused by the particles diffusing into the filter media 402F and 403G, respectively.

### Example Waveforms

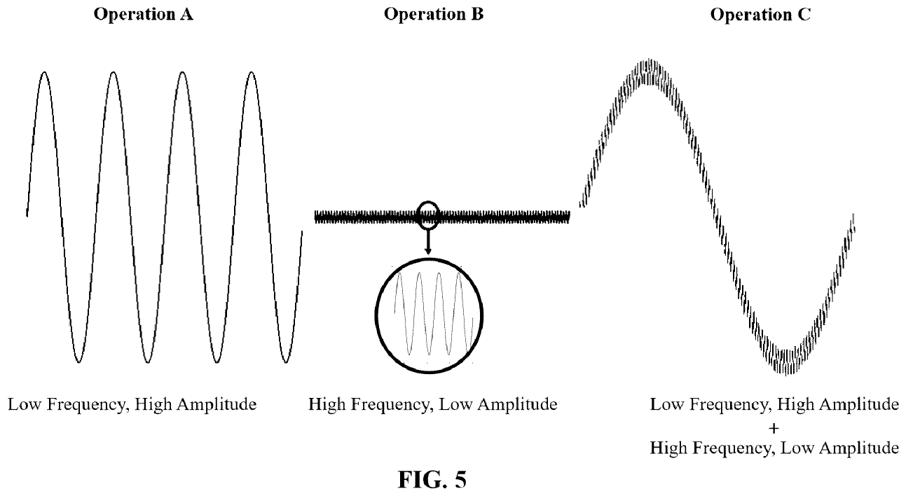

FIG. 5 illustrates various example waveforms applied as a process of shaking filter media (e.g., any of the filter media described herein such as the filter media 420 of FIG. 4D) to perform self-cleaning of the filter consistent with certain examples of the present disclosure. As previously discussed, the shaking of filter media may be, in some cases, periodic, as illustrated in FIG. 5. As also previously discussed, the shaking of filter media may be, in some cases, multistep, as also illustrated in FIG. 5.

In general, filter media may be shaken by one or more sources from one or more directions at one or more frequencies. Properties of the shaking (e.g., frequency, magnitude, amplitude, duration, wavelength, steps, speed, peak-to-peak distance, modal shapes, modes of shaking, etc.) of the filter media may be determined based on each application, as discussed elsewhere herein. For example, to dislodge some particles, the shaking may be applied at low frequency range (e.g., between about 0.01 s Hz to about 10 s Hz, or between about 10 Hz and about 100 Hz, or between about 100 Hz and about 1000 Hz, or any sub-combination of such lower and upper boundary ranges, etc.), and for dislodging some particles, the load may be applied at higher frequency (for example, on the order of thousands of Hz, e.g. between about 1 kHz, to about 10 kHz, or between about 10 kHz to about 100 kHz, or between about 100 kHz to about 500 kHz, or between about 20 kHz to about 40 kHz, or any sub-combination of such lower and upper boundary ranges, etc.). In some cases, actuators may sweep a wide range of frequencies to cover both low frequency and high frequency loading. Additionally, in some cases, different types of actuators may be utilized to cover a set of frequency ranges to improve the performance of cleaning operation. Further, in some cases, the low and high frequency (e.g., 0.01 kHz-1 kHz, 1 kHz-10 kHz, 10 kHz-100 kHz, more than 100 kHz, etc.) shaking may be applied to the filter media simultaneously or in any other order, sequence, or in variations of both order, sequence, timing, or the like. In addition, in some cases, all such properties of the shaking may be adjusted, including on the fly (during operation), such as via artificial intelligence or machine learning techniques, including techniques that measure (e.g., via sensors or other detection and monitoring mechanisms) the flow of the particles being dislodged from the dirty side of the filter media during cleaning operations. In some cases, the duration or other factors/parameters of the cleaning operation may be determined by the end user. In some cases, data may be transmitted to the other devices or users as notifications to report the status of the cleaning operation or the filtration system.

In some cases, when the frequency of the shaking is relatively high (e.g. on the order of about hundreds or thousands of Hz, etc.), or the displacement is relatively small (e.g., one the order of 500 micrometers or less, or higher), the shaking may be applied continuously to the filter housing or the reinforced structure, or the shaking may be applied continuously to the filter media, housing etc., or the like, in order to improve the efficiency of the cleaning operation and enhance the lifetime of other components.

Turning more specifically to FIG. 5, the various example waveforms applied as a process of shaking filter media to perform self-cleaning of the filter include three main steps. In Operation 1, a low frequency (0.01 Hz to 1000 Hz) and high amplitude (100 s of micrometers to millimeters) shaking may be applied to the filter media (e.g., via a filter housing or a reinforced structure). At Operation 1, some particles may be more easily dislodged from the filter media. In Operation 2, a high frequency (e.g., 0.5 kHz-1 kHz, 1 kHz-10 kHz, 10 kHz-100 kHz, more than 100 kHz, etc.) and low amplitude (e.g., between 10 nanometers and 100 micrometers) shaking may be applied to the filter media. At Operation 1, some particles may be more easily dislodged from the filter media. In Operation 3, a superposition of low and high frequency and low and high amplitude shaking may be applied to the filter media. At Operation 3, particles of various sizes, such as smaller, medium, and larger, may be dislodge from the filter media. While not always necessary, in some cases, a reverse flow may be applied to the filter media before, during, or after shaking to assist in dislodging the particles of various sizes.

### Example Filter Fibers of Filter Media

FIG. 6 illustrates a diagram 600 of example filter fibers of filter media accumulating various particles consistent with example aspects of certain examples of the present disclosure. Four filtration mechanisms are illustrated in the diagram 600, categorized by size. Specifically, the filtration mechanisms, by size (from largest to smallest) are sieving/straining mechanism, impaction mechanism, interception mechanism, and diffusion mechanism. The different size particles are accumulated by different mechanisms (e.g., filter fibers) in the filter media. As illustrated, the largest particles included in the diagram 600, the sieving/straining particles, do not permeate the filter media, instead accumulating at the surface of the filter media. Similarly, as illustrated, the some particles included in the diagram 600, filtered by the impaction, do not substantially permeate the filter media, instead accumulating to the surface of the filter media. As illustrated, the smallest particles included in the diagram 600, filter by the interception and diffusion mechanisms, may permeate the filter media, accumulating at a deeper point in the filter media, with the diffusion particles permeating deeper into the filter media than the interception particles. The accumulation of small size particles filtered by the diffusion and the interception mechanisms may clog the filter media overtime, thereby reducing the lifetime and efficiency of the filter media.

### Further Examples of Self-Cleaning Filtering systems

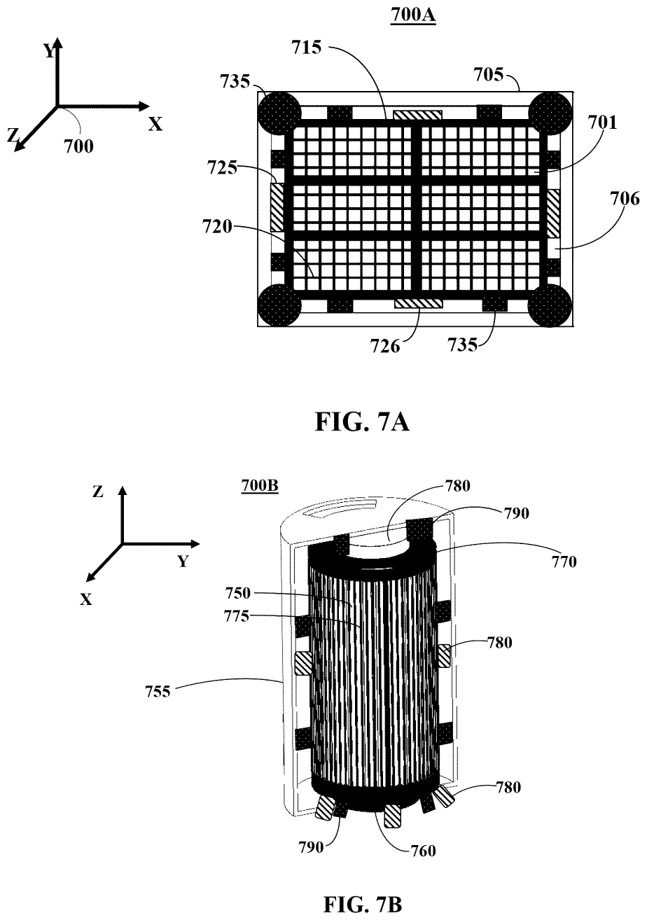

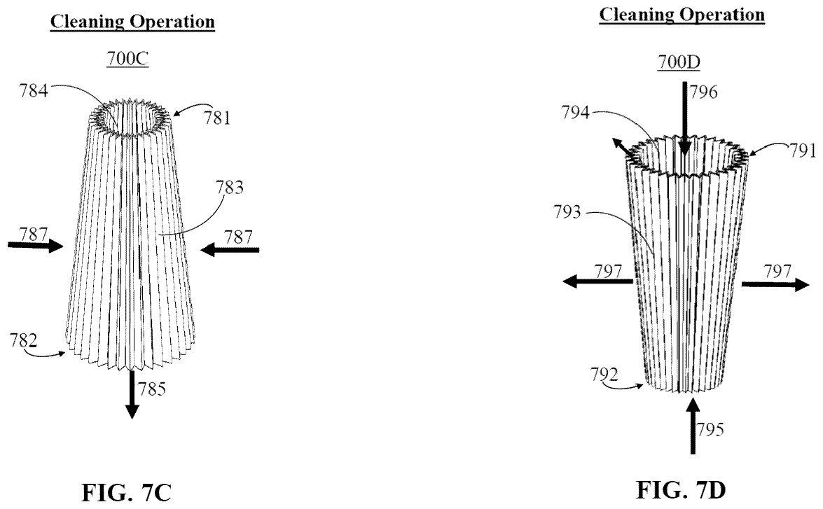

FIG. 7A and 7B are two diagrams illustrating an example of self-cleaning filtration systems, namely a flat filter 700A and a cylindrical filter 700B, respectively, which may be fixed relative to an X-Y-Z coordinate system, consistent with examples of the present disclosure. The example self-cleaning filtration systems of FIGS. 7A and 7B may be the same as or similar to any of the filters described herein. Referring to the example of FIG. 7A, a main frame 705 may be fixed relative to the reference X-Y-Z coordinate system. In some cases, during cleaning operations, a filter housing 715 or a reinforced structure 720 may be shaken by actuators 725 or 726. The actuators 725 or 726 may be connected to the main frame 705, the filter housing 715, reinforced structure 720, or a sealing element 706. The actuators 725 or 726 may apply a shaking force to the filter media 701, either directly, or indirectly (e.g., via applying the shaking force to one or more of the filter housing 715, the reinforced structure 720, the main frame 705, or the sealing element 706. For example, the actuators 725 or 726 may apply the shaking force indirectly to the filter media 701 via physical contact with the filter housing 715, or reinforced structure 720 (e.g., the actuators hit, impact, or hammer the filter housing 715, or reinforced structure 720, directly), which may result in the filter media 701 shaking. In some cases, the actuators 725 or 726 do not have any physical contact with the filter media 701 as the filter media 701 may be delicate (e.g., susceptible to tearing). In some cases, the actuators 725 do not have physical contact with any of the filter housing 715, the reinforced structure 720, the main frame 705, the sealing element 706, or the filter media 701 and the actuators 725 or 726 are instead connected via a wave, or electromagnetic impulse, etc. The non-physical-contact method has some advantages over direct method such as: less noise, less wear, and less maintenance, among other benefits.

The actuators 725 or 726 may apply the shaking force at high frequency (e.g., 1 kHz to 100 kHz) and a low amplitude (e.g., 10 nanometers to 100 micrometers). In such cases, in order to transmit the shaking efficiently into the filter media, the actuators 725 or 726 may be attached to the filter housing 715 with glue, welding, or such methods, or integrated as one compartment into filter housing 715 and reinforced structure 720. For example, the actuators 715 may be made of piezoelectric or shape memory alloys or be an ultrasonic transducer.

In some cases, as shown in FIG. 7A (and also in FIG. 7B), the flat filter 700A may have some elastic compartments 735 (790 in FIG. 7B) that may constrain the motion of the filter housing 715 (770 in FIG. 7B), the reinforced structure 720 (775 in FIG. 7B), and the filter media 701 (750 in FIG. 7B). In some cases, the elastic compartments 735 may serve to create a hard stop for shaking of the filter housing 715 (770 in FIG. 7B). In some cases, the sealing element 706 (760 in FIG. 7B) may be used between components (e.g., the filter housing 715 and the main frame 705) to prevent any leakage between a dirty side and a clean side of the filter media 701 (750 in FIG. 7B). The elastic compartments 735 may be made of one or more of rubber or a metallic spring, or the like to allow the filter housing 715 and the reinforced structure 720 to shake during the cleaning operation. In some cases, the elastic compartment 735 may be particularly important when the shaking frequency is low (e.g., 0.01 Hz to 1000 Hz) and the shaking amplitude is relatively high (e.g., 100 micrometers to 10 millimeters).

In some cases, the main frame 705 may include a plurality of the filter media 701, with each filter media of the filter media 701 having corresponding components including one or more of a sealing element 706, a corresponding filter housing 715, a reinforced structure 720, one or more actuators 725 or 726, one or more elastic elements 735, etc. The plurality of the filter media 701 (and the corresponding components) may be arranged in any suitable pattern within the main frame 705, such as in a grid or array. Having the plurality of the filter media 701 may present certain advantages, such as, enabling a first filter media of the filter media 701 to be in operation while a second filter media of the filter media 701 is out of operation (e.g., for cleaning, for changing, due to maintenance, due to a failure, etc.).

FIG. 7B illustrates the cylindrical filter 700B. The cylindrical filter 700B may include one or more of a main frame 755, which may be fixed with respect to a reference coordinate system XYZ, the filter media 750, the filter housing 770, the reinforced structure 775, the sealing element 760, actuators 780, and the elastic compartments 790. Similar to FIG. 7A, during the cleaning operations, the actuators 780 may apply force to the filter media 750 directly or indirectly, with or without physical contact with any of the other components of the cylindrical filter 700B.

Referring to FIG. 7C and 7D, in some cases, conical filters 700C and 700D may be utilized instead of the cylindrical filter 700B. For example, the conical filters 700C and 700D may be utilized instead of the cylindrical filter 700 for application-specific reasons.

Referring to the illustrative implementation of FIG. 7C, in some cases, the larger side 782 of the conical filter 700C may face to the ground (e.g., towards the center of the Earth). In such cases, the dirty side 784 may be inside of the conical filter 700C. Hence, during cleaning operation, the reverse flow direction 787 may be from outside 783 of the conical filter 700C toward or into the inside 784 of the conical filter 700C. Accordingly, the particles may fall towards the ground while the conical filter 700C is shaken during cleaning operation.

In some cases, other placements/arrangements may be utilized, such as a conical filter 700D of FIG. 7D. As illustrated, the smaller side 792 of the conical filter may face to the ground and the dirty side 793 may be outside 793. Accordingly, during cleaning operation, the reverse flow direction may be from inside 794 of the conical filter 700D towards the outside 793 of the conical filter 700D. In such cases, the particles may fall towards the ground while the conical filter 700D is shaken during cleaning operation. Accordingly, this configuration (e.g., as compared to the conventional cylindrical filter 750) may enhance the cleaning operation as the particles may downward while the conical filter 700D is shaken during the cleaning operation.

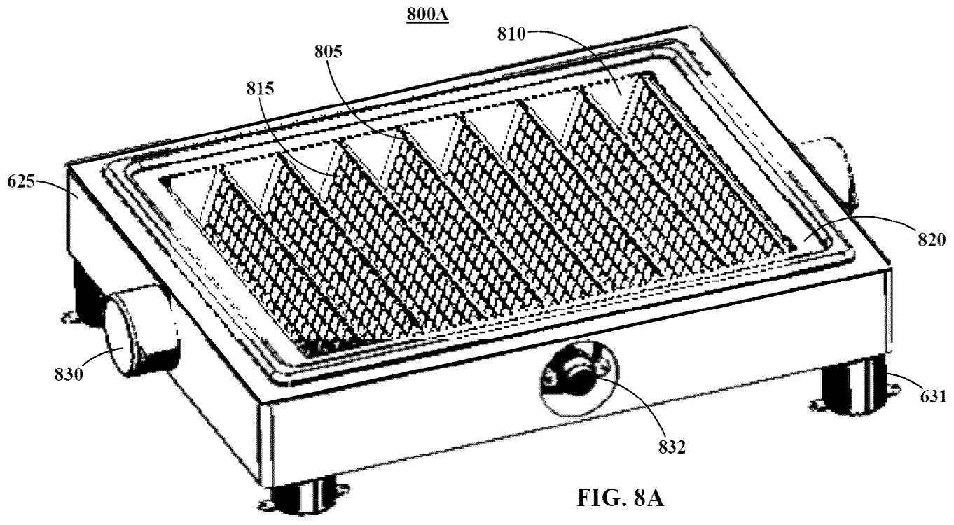

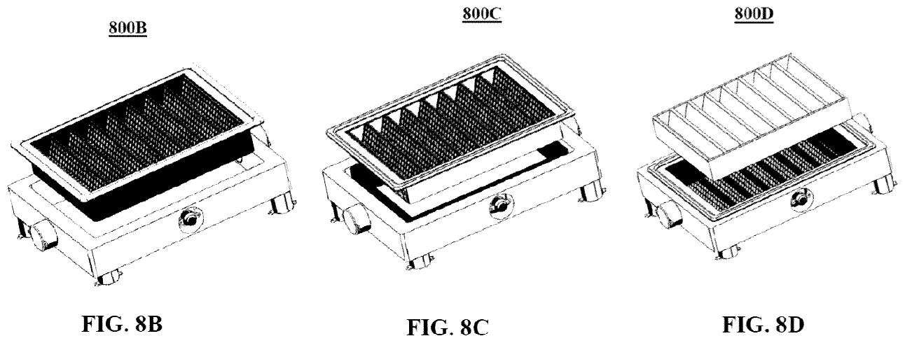

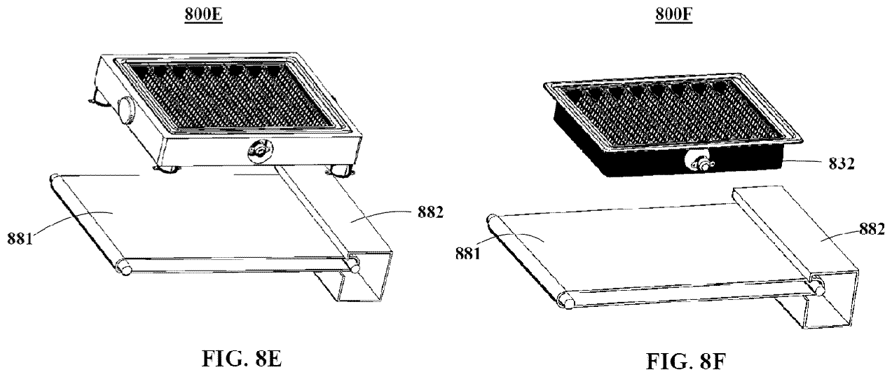

In some cases, filter media may be permanently fixed, held, connected, glued, etc. to one or more other components such as a filter housing, a filter reinforced structure, sealing components or the like. Hence, after the lifetime of the filter media, when the filter media is needed to be replaced, the attached component to the filter media may be replaced with the filter media as well. In some cases, filter media may not be permanently fixed to any other components. Some examples of such configurations are shown in FIGS. 8B, 8C, 8D.

FIGS. 8A, 8B, 8C, 8D, 8E, and 8F are top perspective views of example self-cleaning filtration systems. The example self-cleaning filtration systems of FIGS. 8A-8F may be the same as or similar to any of the filters described herein (e.g., the filter 700A of FIG. 7A). Referring to FIG. 8A, an example self-cleaning filtration system 800A is shown, including a filter main frame 825, filter media 815, and various actuators 830, 831, 832, (such as solenoid actuators, magnetic actuators, a piezo (piezoelectric) actuator, ultrasonic actuator, or any such similar actuator or force-delivering mechanism, wave or energy source, etc.), filter housing 810, reinforced structure 805, and sealing element 820. Via the actuators or sources, shaking force may be applied to the filter media 815 (directly or indirectly). In some cases, the filter media 815 is attached to the filter housing 810 or filter reinforced structure 805 firmly such as by glue, compression force, or the like such that there is no relative motion or sliding between filter media 815 and the filter housing 810 or filter reinforced structure 805, especially at the attached areas, lines or points during cleaning operations. Referring to FIG. 8A, the main frame 825 may be structured, positioned or attached so that the filter media 815 may be shaken by the actuators 830-832 with various load, force, energy, etc. that may be applied continuously (for example using a piezoelectric actuator), applied repetitively, or applied in various ascending or descending ranges of displacement, frequency, force, or type or mode of impetus or application.

In some cases, the filter housing 810, the reinforced structure 805, the sealing element 820, and the filter media 815 may be assembled as one comportment. In such cases, when it is time to replace the filter media 815, the one comportment (including the filter housing 810, the reinforced structure 805, the sealing element 820, and the filter media 815) may be replaced, while the main frame 825 and the actuators 830-832 may not need to be replaced (provided they are functional). An example illustration of such filter with the one comportment structure is shown as filter 800B in FIG. 8B. For example, this configuration may be used where the filter media 815 is relatively small, such as for an autonomous vacuum cleaner.

In some cases, the reinforced structure 805, the sealing element 820, and the filter media 815 may be assembled as one comportment. In such cases, when it is time to replace the filter media 815, the one comportment (including the reinforced structure 805, the sealing element 820, and the filter media 815) may be replaced, while the main frame 825, filter housing 810, part of reinforced structure 805, and the actuators 830-832 may not need to be replaced (provided they are functional). An example illustration of such filter with the one comportment structure is shown as filter 800C in FIG. 8C.

In some cases, either (i) the sealing element 820 and the filter media 815, or (ii) only the filter media 815 may need to be replaced after the lifetime of filter media 815, while the main frame 825, the filter housing 810, the reinforced structure 805 and the actuators 830-832 may not need to be replaced (provided they are functional). An example illustration of such filter is shown as filter 800D in FIG. 8D.

In one example, referring to FIG. 8E, a conveyor belt 881 (or other similar mechanisms) may be utilized to guide particles to a collector 882. For example, during a cleaning operation, the filter media may be shaken (possibly before, after, or during the reverse flow), which releases the particles onto the conveyor belt 881.

In another example, referring to FIG. 8F, a piezoelectric actuator or ultrasonic transducer 832 may attached to the filter housing 810 or the reinforced structure 805. During the cleaning operation, the piezoelectric actuator or ultrasonic transducer 832 may cause the filter media 815 to shake with a high frequency (e.g., 0.5 kHz-1 kHz, 1 kHz-10 kHz, 10 kHz-100 kHz, more than 100 kHz, etc.) with a low amplitude (e.g., on the order of tens of nanometers to tens of micrometers, etc.). In some applications, the piezoelectric actuator or ultrasonic transducer 832 (using, e.g., 500 Hz-900 kHz with a small amplitude on the order of tens of nanometers to tens of micrometers) may be used in cleaning operations due to minimal maintenance. Due to the shaking, the particles may release from the filter media 815 and fall onto the conveyor belt 881. Such implementations with the conveyor belt 881 may enhance the cleaning operation when the size of particles is fine (e.g., on the order of tens of nanometers to tens of micrometers, etc.).

Again, it is noted that the various illustrative or suggested ranges set forth above or herein are specific to their examples and are not intended to limit the scope or range (e.g., frequencies, amplitudes, etc.) of disclosed technologies, but, again, merely provide example ranges for the illustrative or respective examples or use cases.

In some cases, at least one of the actuators 830-832 of one or more of FIGS. 8A-8F shake (e.g., vibrate, beat, impart energy, etc.) the filter housing 810 or the reinforced structure 805 and hence the filter media 815. The actuators 830-832 may be categorized as one or more of several types, including: continuous actuators, impulsive actuators (dis-or non-continuous actuators), direct (physical) contact actuators, or contactless actuators, which may include a range of wave, energy and or sonic actuators, including but not limited to rotary actuators, mechanical actuators, elector-mechanical actuators, solenoid actuators, magnetic actuators, electromagnetic actuators, piezoelectric actuators, ultrasonic transducers, reciprocating actuator, linear actuators, rotational actuators, rotary eccentric mass, or other type of actuators or sources.

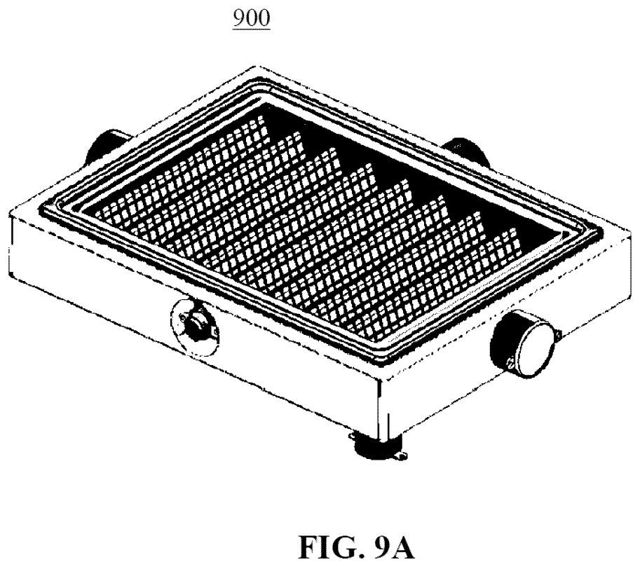

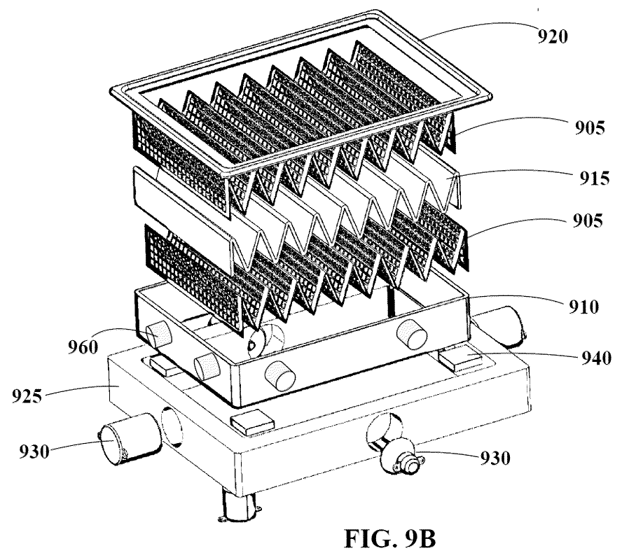

FIGS. 9A and 9B are perspective and exploded views, respectively, of examples of self-cleaning filtration systems. The example self-cleaning filtration systems of FIGS. 9A and 9B may be the same as or similar to any of the filters described herein (e.g., one or more of the filters 800A-800F of FIGS. 8A-8F). FIG. 9A illustrates one example of a self-cleaning filtration system 900, which is shown in an exploded view in FIG. 9B.

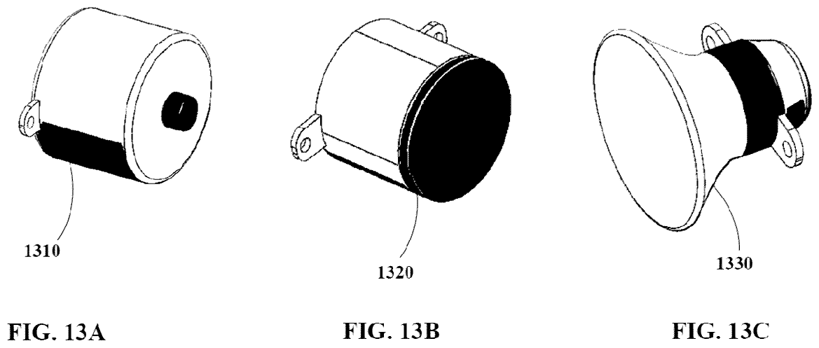

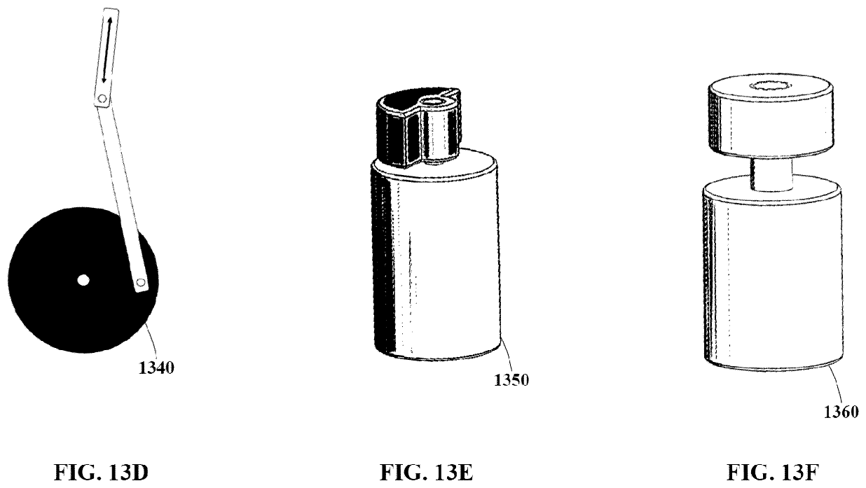

Referring to FIG. 9B, the self-cleaning filtration system 900 may comprise a main frame 925, a seal 920, a filter housing 910, elastic elements 960, filter media 915, reinforced structural 905 and 906, which may all (or any subset of them) be the same structural component, and which may also be a multi-piece structure (not shown). The self-cleaning filtration system 900 may also include one or more actuators or sensors 930, such as those shown and described in connection with FIGS. 13A through 13D or the like. In some cases, the actuators 930 may apply a shaking force to the filter housing 910 or reinforced structure 905 continuously, or such actuators 930 may apply such force non-continuously. In some cases, the actuators 930 may apply the shaking force by physical contact to the filter housing 910 or reinforced structure 905 or by contactless methods. Further, the actuators 930 may be configured such that the shaking force (e.g., forces, loads, impulses, etc.), may be delivered in one or more of all 6 degrees of freedoms (DOFs). In certain cases, one or more permanent magnets/coils 940 may be utilized in the self-cleaning filtration system 900 if an induction actuator is included in the actuators 930. Further, in some cases, the self-cleaning filtration system 900 may have an elastic compartments 960, especially if the actuator works at low frequency (e.g., 0.01 Hz to 1000 Hz) and generates high amplitude (e.g., 100 microns to 10 millimeters), or is discontinuous; for example, if the actuators 930 apply the shaking force by repetitive impact force (impulsive force), one or more elastic compartments 960 (e.g., springs or rubber) may be utilized to bring the filter housing 910 or filter reinforced structure 905, and the filter media 915 in the opposite direction (e.g., back to equilibrium), during the cleaning operation.

According to some examples herein, the self-cleaning filtration system 900 or main frame 925 may also be contained with a housing (not shown). Here, for example, the self-cleaning filtration system 900 can be within or have its own separate system or housing, which may contain all components for the self-cleaning filtration system 900, such as the filter media 915, the filtering housing 910, the reinforcement structure 905, the sensors or actuators 930, at least one communication system or component (e.g., for receiving and sending data, etc.), a microprocessor, a duct, a fan, a blower, shock absorbers, a control system, wiring, attachment, brackets, sealing components (e.g., the sealing element 920 or other seals), or the like.

Further, as shown and described in connection with FIG. 9B, a filter housing 910 or a reinforced structure 905 may be placed on or otherwise used for or with filter media 915. The filter housing 910 or the reinforced structure 905 may have any shape and geometry, such as a grid (e.g., as a metallic or plastic net) to prevent the wear, creep, and bucking of the filter media 915 and transfer the load/displacement to the filter media 915 during a cleaning operation. Generally, the filter housing 910 may have any shape or geometry as long the filter housing 910 tightly holds the filter media 915 during the cleaning operation. The elastic modulus of the filter housing 910 or the reinforced structure 905 may be at least about 10 times that of the elastic modulus of filter media 915. The elastic modulus of the filter housing 910 or the reinforced structure 905 may be on the order of Mega Pascals (MPa) (e.g., when the filter housing/reinforced structure is made of plastic/polymer/composite materials, their elastic modulus may be in order of about 10 s MPa or about 100 s MPa, etc.), or on the order of Giga pascal (GPa) (e.g. when the filter housing/reinforced structure is made of metallic/composite materials, their elastic modulus may be in order of about 10 s of GPa or about 100 s of GPa, etc.). The elastic modulus of the filter housing 910 or the reinforced structure 905 may be designed according to application and design requirements.

The filter housing 910 may be added to the filtration system 900 to add structural stability and durability to the filter media 915 and also transfer the shaking force to the filter media 915 during the cleaning operation. As shown in FIG. 9B, the filter housing 910 may be placed or sandwiched between the filter media 915 and the main frame 925 via the sealing element 920. However, in some cases, the filter media 915 may be placed directly against the main frame 925, such as in cases that have no filter housing, e.g., the filter housing 910. The filter housing 910 may be extended (e.g., opened, expanded, etc.) when the filter media 915 needs to be removed or reinserted. Then, after placing the filter media 915 in filter housing 910, the filter housing 910 may be tightened to keep the filter media 915 securely in place (e.g., in contact with frame, etc.). Accordingly, systems and methods described herein achieve one or more of easier replacement of the filter media 915, less damage/tears to the filter media 915, or may be more user friendly.

Further, according to different and various examples herein, the filter media 915 may be comprised of one or more materials including metal, activated carbon/charcoal, fiberglass, fiber carbon, polymer, cotton, filter paper, woven or non-woven fabric, mesh, cordierite, silicon carbide, ceramic, ceramic monolith, or other materials that may use as filter media, depending on usage, application, particulate matter being filtered, or other factors related to the filtration needs.

The self-cleaning filtration system 900 may include the main frame 925, which while shown as a rectangular box structure in FIG. 9B, may be constructed in various other shapes, geometries, and sizes. The main frame 925 may be structured as a box which connect the filtration system to adjacent body or housing structures, and shock absorber may be placed between the main frame 925 and such body structures. The main frame 925 can be made from composite materials, plastic, metals, woods, or any combination of these or any other materials. One or more components of or associated with the self-cleaning filtration system 900 such as microprocessors, sensors, etc. can be placed outside of the main frame 925, depending on application.

In some cases, the filter media 915 may be coated for different purposes, such as to enhance the antibacterial effect, improve the durability, enhance the filtration performance, act as catalysts to increase the rate of desired chemical reactions, absorb some specific materials or odor, or perform known functionality. Further, in some cases, a non-stick coating may be applied to the filter media 915, which make the dislodging (e.g., removing) of particles easier.

Aspects of the disclosed systems and methods may also be utilized for varying types of filtration systems, such as liquid filtration (e.g., filter press, cartridge filters, drum filters, depth filters, bag filters, clean in place filters, and other such liquid filtration types), gas or air filtration (e.g., HEPA, ULPA, PTFE membrane, porous filters, ceramic filter, monolith filter, bag filters, electrostatic precipitator and others), and other filtration types such as cartridge filters, cold plasma, electrostatic filtration, or the like. Also, the presently-disclosed systems and methods may be utilized to reduce the emission and improve the fuel efficiency by cleaning the exhaust system of automotive, trucks, construction machinery, agricultural machinery, mining machinery, as well as power plants. For example, the disclosed systems and methods may be used to clean porous filters, ceramic, or ceramic monolith, and any other type of filters used in exhaust systems, to clean, dislodge the ash and soot and other particles from exhaust system of internal combustion engines or the exhaust of power plants, or the like.

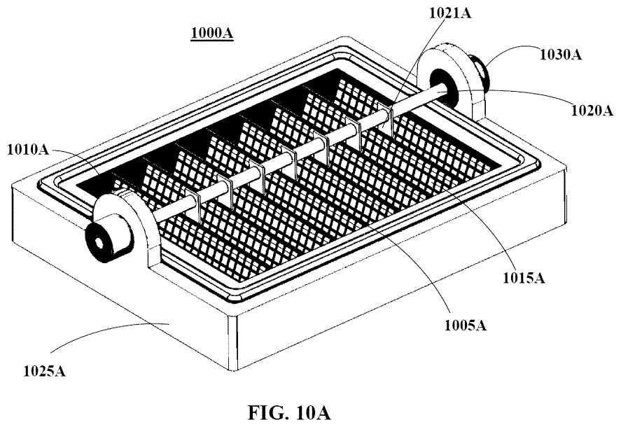

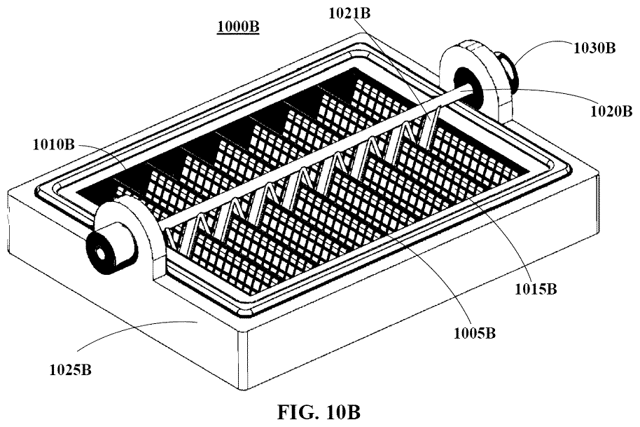

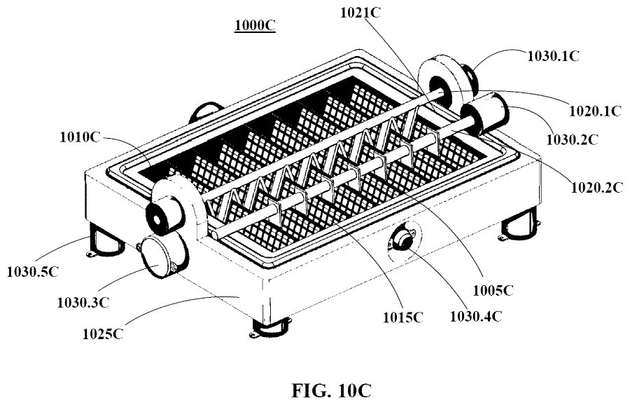

FIG. 10A illustrates a top perspective view of an example filtration system 1000A. Referring to FIG. 10A, the filtration system 1000A is shown including a filter housing 1010A, filter media 1015A, actuator/sensors 1030A, a transfer structure 1020A (here, a rod, though other structure and forms may be used in addition or in alternative), and attachment mechanisms 1021A that transfer a shaking force (e.g., a load) from the transfer rod 1020A to the reinforced structure 1005A or the filter housing 1010A (depending on design) and hence to the filter media 1015A. In use, the actuators/sensors 1030A may apply the shaking force to the transfer structural rods 1020A, which transfer the shaking force to the filter media 1015A via the reinforced structure 1005A or the attachment mechanisms 1021A and the reinforced structure 1005A. Depending on implementation or need, one or more transfer structural structures 1021A may be utilized. The transfer structure 1020A compartment may also be placed on clean side of the filter media 1015A or on the dirty side of the filter media 1015A.

FIG. 10B illustrates a top perspective view of another example filtration system 1000B, including actuator/actuator elements 1030B, 1020B, 1021B, consistent with examples of the present disclosure. Referring to FIG. 10B, the example filtration system 1000B is illustrated as including a filter housing 1010B, filter media 1015B, an actuator 1030B, a transfer structure 1020B (here, a rod with a sawtooth shaped filter-media-engaging portion 1021B, though other structure and forms are within the ambit of the present innovations), where the sawtooth portion of the transfer rod 1020B engages the reinforced structure 1005B or the filter housing 1010B, and hence the filter media 1015B. In use, the actuators/sensors 1030B may apply a shaking force (e.g., a load) to the transfer structural rods 1020B, which transfer the shaking force through the transfer structure portion 1021B (or other structure that is shaped to abut/align to/engage to the reinforced structure 1005B or the filter housing 1010B, and hence the filter media 1015B). Depending on implementation or need, one or more transfer structures 1020B may be utilized. The transfer structure 1020B compartment may also be placed on clean side of the filter media 1015B or on the dirty side of the filter media 1015B.

FIG. 10C illustrates a top perspective view of yet another example filtration system 1000C including actuator/sensors 1030.1C-1030.5C. All the sensors and actuators 1030.1C-1030.5C are connected to the electrical control system (ECU), sending and receiving signals. Referring to FIG. 10C, the filtration system 1000C is shown including a main frame 1025C, filter media 1015C, several the actuators/sensors 1030.1C-1030.5C, and transfer structures 1020.1C and 1020.2C (here, both types of rods and associated structures shown in FIGS. 10A and 10B, respectively, engage the reinforced structure 1005C or the filter housing 1010C in the same ways described above, or the like). Further, the filtration system 1000C may also include a piezo actuator 1030.4C (also shown in FIG. 13C) that applies force to the filter housing 1010C or the filter reinforce structure 1005C, e.g., continuously, or otherwise. Further, as set forth in examples described above, the actuator/sensors 1030.1C-1030.5C may generate or deliver a shaking force to the filter housing 1010C or to the filter reinforced structure 1005C via physical contact. For example, by piezo/ultrasonic actuator or impact force, continuously (for example by piezo/ultrasonic actuator, which is in contact with the filter housing 1010C or the reinforced structure 1005C at all the time during cleaning operation) or discontinuously (for example by repetitive impact force or impulsive force). In some examples, the actuator/sensors 1030.1C-1030.5C may generate or deliver a shaking force to the filter housing 1010C or to the filter reinforced structure 1005C without physical contact. For example, the actuator/sensors 1030.1C-1030.5C may generate or deliver the force to the filter housing 1010 or filter reinforced structure 1005, by inducing magnetic or electromagnetic fields, other energy, etc., continuously, or discontinuously.

### Example Representations of Self-Cleaning Filtering Systems

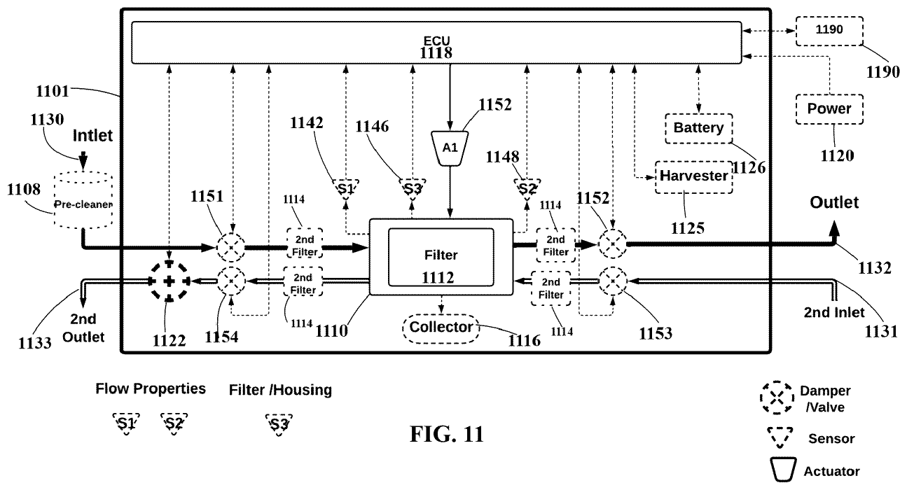

FIG. 11 is a representation of example self-cleaning filtration systems and methods, consistent with systems and methods described herein (e.g., the FIGS. 10A-10C). Referring first to FIG. 11, an example automatic self-cleaning filtration system is depicted, including a main frame 1101, one or more filters 1112, a filter housing 1110, shaker sources 1152 (e.g., actuator, energy source, etc.) to shake the filters 1112, an electrical control system (ECU) 1118, a source 1122 to generate the reverse flow during cleaning operation in the filters 1112, at least one power source 1120 (to power the other compartments), a battery 1126, an energy harvester compartment 1125, a collector compartment 1116 to collect particles (e.g., dust, drips, etc,), a main inlet 1130, a main outlet 1132, and (optionally) a secondary inlet 1131 and secondary outlet 1133.

According to some cases, the ECU 1118 may be configured to send data from the sensors 1142, 1146, 1148 and shaker sources 1152 for various processing or user, e.g., at user components 1190. The user components 1190 may be one or more of operators (e.g., human operators), at least one computing device, a machine, storage, AI, cloud, or the like. In some cases, the ECU 1118 may be configured to control the cleaning operation via an algorithm/AI, depending on the application. For example, in some cases, the cleaning operation duration may be controlled as a function of filtration time, the mass of the filter, pressure drops, and other relevant data, system parameters, or the like. For example, in some cases, the cleaning operation may be stopped when a motion is detected by a motion detector sensor (not shown), which, for example, may be utilized in air purifier implementations. Further, in certain cases, a user component 1190 (e.g., controlled by a user) can over-write the ECU 1118 command, (e.g., the user component 1190 can turn on or off, re-program or otherwise control the cleaning operation). The ECU 1118 may send a signal to the user component 1190 if anything goes wrong or malfunctions with the filtration system. In some cases, the sensors 1146 or the shaker sources 1152 may be mounted in the main frame 1101. The filter media 1112 may be held within in the filter housing 1110 or the reinforced structure (not shown). The ECU 1118 may also be placed within main frame 1101, or outside of the main frame 1101, depending on application. Further, the shaker sources 1152 may be connected to the ECU 1118 via wire or wireless interconnections (e.g., to send and receive signals, note: all thin arrows illustrated in FIG. 11 represent connectivity). Further, whenever it is mentioned that other components herein are connected to the ECU 1118, any or all such components may be connected to the ECU 1118 wired or wirelessly.

Referring to FIG. 11, the self-cleaning filtration system may have the sensors 1146 to measure or characterize the quality of the inlet flow 1142 and the outlet flow 1148, and the status of the filter media 1112. Also, the self-cleaning filtration system may have additional actuators and sensors to control and to empty particles from the collector 1116. Further, as such cleaning operations are performed, the particles (large or otherwise) that are released from the filter media 1112, fall toward the bottom of the filter box 1110. The bottom of the filter box 1110 may function as a particle collector. However, in some application, to improve the efficiency of cleaning prosses, the particles, such as large particles, may be collected in a dedicated collector, the collector 1116 which, in certain cases, may be specially designed and integrated into the main frame 1101.

The collector 1116 may have actuators (not shown) configured to empty the collector 1116 via one or more mechanically or electro-mechanically implemented mechanisms. The actuator of the collector 1116 may be connected to ECU 1118 and receive an on/off signal therefrom. Also, sensors (not shown) can be attached the dust collector 1116 to measure the amount of the particles in the collector 1116, the previous time that the collector 1116 was emptied, or any other measurement to track the performance and functionality of the collector 1116.

In some cases, to generate the reverse flow during the cleaning operation, from the clean side to dirty side of the filter 1112, a compartment 1122, such an electro-mechanical fan, blower, or a pressure vessel may be utilized to generate flow (e.g., a pulse jet flow, etc.). In these cases, such device 1122 may be placed (i) on the dirty side of main filter 1112 to impel or suck the fluid flow, or (ii) somewhere in flow path to pull the flow from clean side of the filter to dirty side of the main filter 1112. In some cases, the device 1122 may be connected to the ECU 1118 to send and receive control and feedback signals therewith, therethrough, or to different monitoring or control components.

In some cases, one or more dampers or valves 1151, 1152, 1153, and 1154 may be utilized to control, direct, or redirect the flow path during filtering operation as well as during cleaning operation. In some cases, the main inlet 1130 and the main outlet 1132 may also use as a secondary outlet or secondary inlet, and vice versa, depending on design and application. Also, by utilizing the damper or valves 1151-1154, the cleaning operation may be a closed system (e.g., no flow will enter, or exit, the filtration system during the cleaning operation).

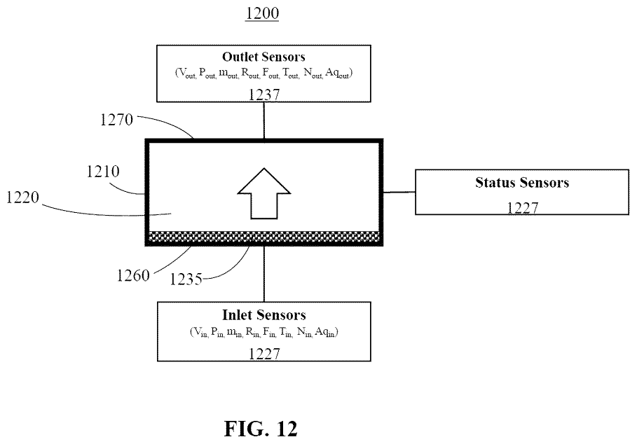

FIG. 12 is a representation of an example filtration mechanism, consistent with examples of the present disclosure. Referring to FIG. 12, the self-cleaning filtration system may have multiple (e.g., three, etc.) separate set of sensors (e.g., sensors 1227 on a dirty side 1260, and sensors 1237 on a clean side 1270) on different sides of filter media 1220, respectively, to measure and characterize the inlet and outlet fluid quality, respectively. For example, the sensors 1227 and 1237 may measure the flow rate, pressure, temperature, number of particles, the size of particles, humidity, relative humidity, chemical or other compositions, parameters, compounds, or the like of inlet and outlet fluid before and after filtration, respectively. Also, the self-cleaning filtration system may have third sensors 1247 that measure and characterize the status or response of the filter housing and or reinforced structure 1210, or filter media 1220 such as motion status, position, velocity, acceleration, and the mass of the filter housing and filter media 1220. The self-cleaning filtration system may have all the three 1227, 1237, and 1247 sensor sets, two sets, or one sets, or even may have none of them, depending on application and design requirement. Also, in some cases, various other type of sensors and actuators may be utilized, depending on application and design requirements.

FIG. 12 and other figures herein show how certain examples of the illustrative, simplified general filtration mechanism works. Here, it is noted that many filters with different media and structures may be used in one filtration system, depending on applications. In FIG. 12, V is Velocity, P is Pressure, m is mass rate, F is Flow rate, T is Temperature, R is Relative humidity, M is total mass of the filter system, N is the number of particles with different sizes, and AQ is a measure of all parameters of air quality. In some cases, during filtering operation, the particles are trapped by the filtration system. Hence, the accumulation of particles results in an increase in the total mass M of filtration system. These particles act as a barrier to the flow. As a result, the filter performance declines over time (e.g., with the same input power to the filtration system, the output V: velocity, P: Pressure, m: mass rate, F: Flow rate, may be reduced). Moreover, the reduction in performance may further result in pathogens growing in or on the filter media. As a result, the quantity and quality of the filtered fluids at the outlet may be negatively impacted (decreased and of less healthy or pure quality) as particles accumulate at the filter through the time by using the filtration system. As such, in some cases, the filtration system may be equipped with such mechanism to disinfect the filter media or the fluid (described further elsewhere herein).

### Example Actuators

FIGS. 13A, 13B, 13C, 13D are diagrams of example actuators that may be used in self-cleaning filtration systems to shake filter media. The actuators 13A-13D may be the same as or similar to various actuators described herein (e.g., the actuators 1030.1C-1030.5C of FIG. 10C). FIG. 13A depicts one illustrative solenoid-type actuator 1310, FIG. 13B depicts one illustrative magnetic-type actuator 1320, FIG. 13C depicts one illustrative piezoelectric (ultrasonic transducer)-type actuator 1330, and FIG. 13D depicts one illustrative reciprocating actuator 1340. Additional types of actuators that may be utilized in one or more examples described herein include rotary actors, linear actuators, other types of mechanical actors, other type of electromechanical actuators, shape memory alloy actuators, ultrasonic actuators, continues or direct actuators, contactless actuators, induction actuators, servo actuators, other magnet-based actuators, any type of magnetic, electromagnetic, mechanical, electro-mechanical actuators, or the like.

In various examples described herein, one type of actors may use to shake the filter media such that the filter media experiences a wide range of displacement (e.g., the shaking amplitudes may vary from tens of nanometer to tens of millimeters) to enhance the cleaning operation performance. Also, the frequency ranges of applied shaking forces may be swept through a wide range to improve the performance of cleaning operation. For example, to dislodge some particles, lower frequency ranges or higher amplitudes may be used. Whereas, for dislodging some particles, the shaking may be at higher frequencies or lower amplitudes. In some cases, more than one type of actuators may be needed to generate such wide range of displacement or frequency, especially when the size of particles is not uniform. For example, a solenoid or magnetic actuator, with large amplitude (e.g., on the order of millimeters, etc.), and lower frequencies, (e.g., on the order of 0.01 to 1000 Hz) may be utilized to dislodge the larger particles and, also piezoelectric or ultrasonic transducer with a small amplitude (e.g., on the order of micrometers, etc.) and a high frequency (e.g., 0.5 kHz-1 kHz, 1 kHz-10 kHz, 10 kHz-100 kHz, more than 100 kHz, etc.) may be utilized to increase the dislodging rate of fine particles.

### Example Energy Harvester

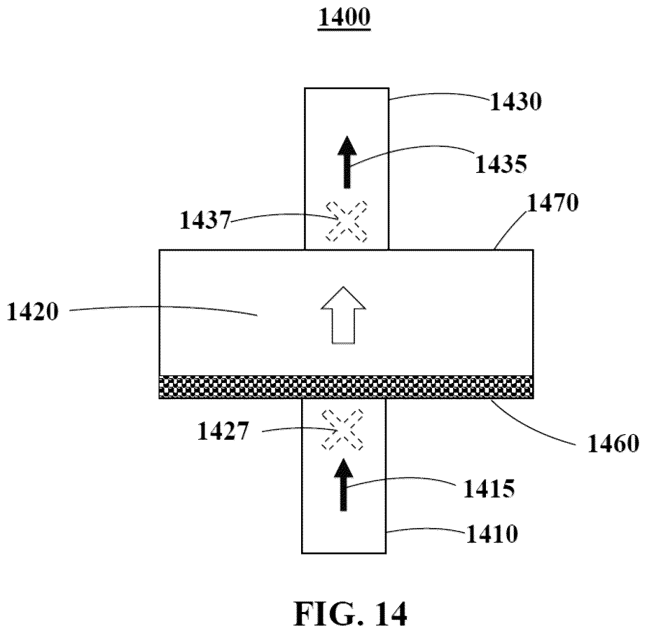

FIG. 14 is a diagram of an example, energy harvester 1400 of a self-cleaning filtration system that may be the same as or similar to one or more of the self-cleaning filtration systems described herein. In some applications, it may not be feasible to have an easy access to a power source for self-cleaning operation and other components. In these applications, the energy harvester 1400 may be added to the self-cleaning filtration system to generate energy during filtering operation. The energy harvester 1400 may further store the energy in an energy storage compartment (not shown). Hence, during the cleaning operation, components, such as actuators, sensors, fans, etc. may use the stored energy. Also, some components (such as sensors and ECUs) may use part of the stored energy during filtering operation. Referring to FIG. 14, energy harvester components 1437 and 1427 may be placed on either side (one or more of a dirty side 1460 or a clean side 1470) of filter media 1420, depending on application. As an example, the energy harvester 1400 may be an electrical generator which has blades to generate energy from flows 1415 and 1435 from a main inlet 1410 to a main outlet 1430 during filtering operation and convert part of the kinetic energy of the flows 1415 and 1435 to electrical energy, which may be stored in a storage device via ECU. As an alternative option to a generator, a vibrator harvester may be used to harvest energy, especially for applications where the main frame is attached to a structure that experience some vibration, such as automotive, construction and agricultural and mining machineries.

### Example Ducting

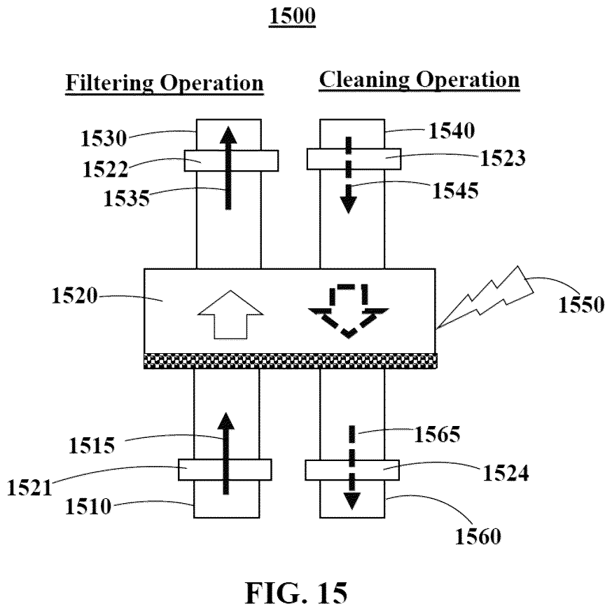

FIG. 15 is a diagram 1500 of an example filtration system having a general ducting, pre-filter and post-filter, secondary inlet, secondary outlet, consistent with examples of the present disclosure. Referring to FIG. 15, an illustrative example is shown having a main inlet 1510, main outlet 1530, secondary inlet 1540, secondary outlet 1560, filter media 1520, second filter media 1521, 1522, 1523, and 1524. During the filtering operation, raw flows 1515 enter the filter media 1520 via the main inlet 1510 from a dirty side of the filter media 1520. During the filtering operation, cleaned flows 1535 leave the filter media 1520 via the main outlet 1530 from a clean side of the filter media 1520.

During cleaning operation, flow 1545 may enter the clean side of the filter media 1520 from the secondary inlet 1540. During cleaning operation, a dirty flow 1565 may exit from the dirty side of the filter media 1520. As shown in FIG. 15, the flow 1545, during the cleaning operation may enter from the secondary inlet 1540 (the clean side) of filter media 1520 (dashed arrows depict the flow direction during cleaning operation while solid arrows show the flow 1545 during filtering operation). The flow 1545 may come from the same reservoir as the raw flows 1515, or it may come from a cleaned air reservoir, or partially from both. Sources of this shaking are described elsewhere herein. Further, the raw flows 1545 may be generated by the same source that generate the cleaned flow 1535, or another source can be implemented, or both can be used.

Referring to FIG. 15, in some examples, during the cleaning operation, the raw flow 1545 may enter the filtration system from the main outlet 1530. Also, in some cases, during the cleaning operation, the dirty flow 1565 may leave the filtration system from main inlet 1510.

In some other examples, during the cleaning operation, the flow 1545 may enter the filtration system from the main inlet 1510 or the main outlet 1530. Also, in some cases, during the cleaning operation, the dirty flow 1565 may leave the filtration system from the main outlet 1530 or main inlet 1510, depending on applications.

Referring to FIG. 15, in some examples, during the cleaning operation, the flow may not enter the filtration system due to the fact the ducts or flow paths or such are controlled by valves/dampers to use the fluid inside of the filtration system during the cleaning operation (e.g., the cleaning operation may be a closed loop where no fluid enters, nor exists the filtration system during the cleaning operations).

Referring to FIG. 15, in some examples, the secondary/pre filters 1521 or 1523 may be used with the main inlet 1510 or on secondary inlet 1540, respectively. Also, in some cases, the post filters 1522 and 1524 may be utilized after the main filter 1520 on the main outlet 1510 or on the secondary outlet 1540, respectively.

### Example Disinfecting Filtering system

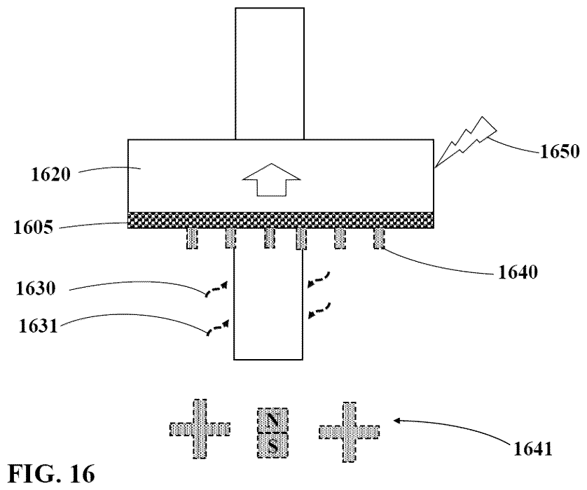

FIG. 16 is a diagram of an example filtration system having additional disinfecting or cleaning aspects, consistent with examples of the present disclosure. Referring to FIG. 16, a filtration system 1620 may have one or more disinfection or cleaning components or compartments such as heating 1631 component, a UV 1630 component, or a charge providing device 1640, in addition to the shaking sources 1650.

The heating compartments 1631 may, during filtering operation or the cleaning operation, raise the temperature of fluid (e.g., in, on, or around the filtration system 1620), via various heating techniques or via radiation, to destroy or kill pathogens and or other harmful compounds. Additionally, the UV (ultraviolet) 1630 or cold plasma sources 1630 may be utilized to perform or accelerate the disinfection processes.

In some cases, the filtration system 1620 may include the one or more electrical charge providing devices 1640, by which the particles on the dirty side of filtration system can be electrically charged. The electrical charging of the particles may enhance the release of particles from the filter media of the filtration system 1620. Furthermore, by creating a magnetic or electromagnetic field, a magnetic force may be further cause dislodging (e.g., removing, knocking off, releasing, easing, etc.) of particles from filtration system 1620. These disinfection techniques may be combined with any other methods at any time sequential, or simultaneously.

In some cases, disinfection techniques may also include or involve chemical or radiation cleaning devices and techniques. For example, a shaking process may be accompanied by a chemical agent or process to facilitate disinfecting, neutralizing, destroying, or killing the particles or pathogens (e.g., COVID-19). Detergents and various other chemicals may be utilized, alone or along with the mechanical process, to facilitate with the disinfecting, neutralizing, destroying, or killing the particles. Further, in some cases, a chemical coating may be applied on the filter media of the filtration system 1620. The chemical coating may also have non-stick properties in addition of abovementioned properties. The cleaning operations and chemical or radiation cycles can occur at same time or in any other order depending on application.

According to examples herein, the operations (note: one or more of which may be omitted) of (1) reversing the flow, (2) shaking (mechanical or wave, beam or energy based), (3) electrical charge provision, or (4) chemical or radiation cleaning may occur at the same time or in any order with a timing gap (e.g., at one time, in sequence, in combination or repeatedly) until the required or desired cleaning levels are achieved, or the system is turned off by any mechanism (e.g., manually or by a control system, such as an ECU).

### Example Filter Media

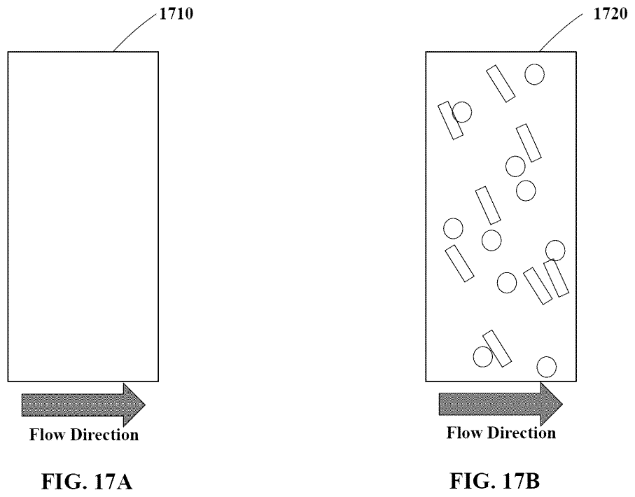

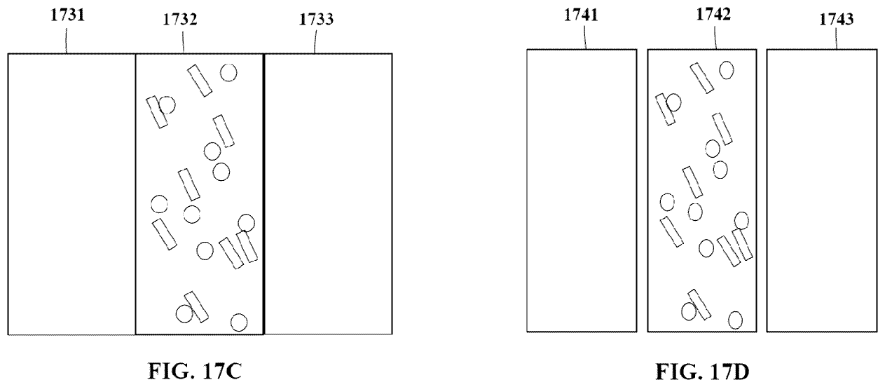

FIGS. 17A-17D are diagrams illustrating various filter media or materials that may be utilized in the disclosed filtration mechanisms or filtration systems, consistent with examples of the present disclosure. Various examples of filtration systems herein may contain one or multiple pre-filter media 1731/1741 and post-filter media 1733/1743, which can be attached to (see FIG. 17C) or separate from (see FIG. 17D) main filter media 1732/1742. As shown in FIG. 17B, some additive materials (e.g., different materials, shown here as circular and rectangular particles) may be utilized in filter media 1720 to absorb or destroy some pathogens or chemical compounds.

The filter media 1710/1720/1732/1742 may include fibrous or porous materials which may remove solid particles (e.g., ash, dust, dirt, debris, granules, lint, mold, pathogens, pollen, powder, soot, etc.) from fluid. The filter media 1710/1720/1732/1742 may be clean porous filters, ceramic, or ceramic monolith, or any other type of filters.

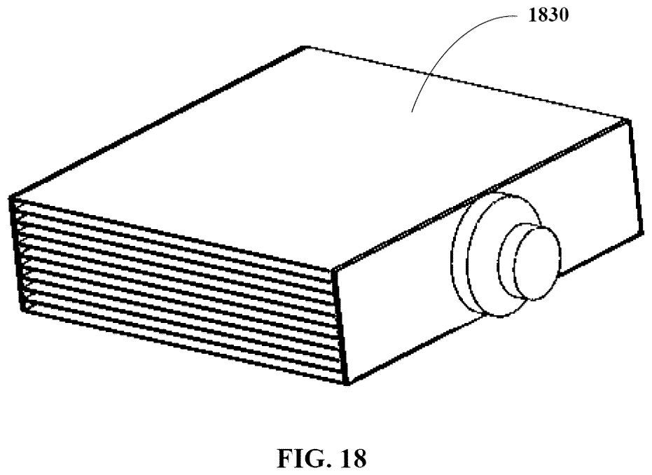

FIG. 18 is a diagram illustrating an example of an electrostatic air filter 1830 including filter media (e.g., as described with respect to FIGS. 17A-17D) with respect to which the disclosed filtration systems may be utilized, consistent with examples of the present disclosure.

### Example Flow Paths

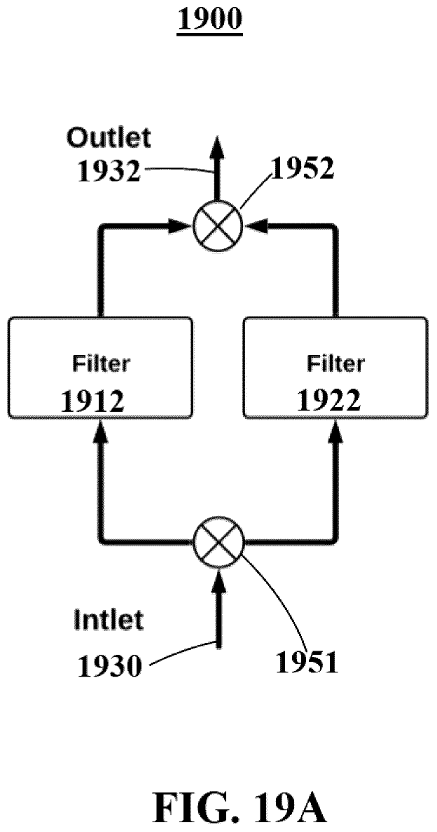

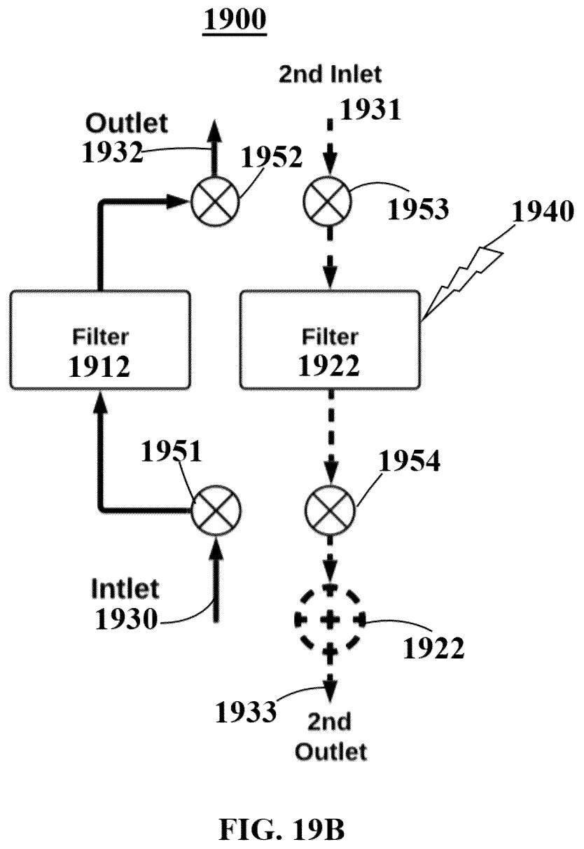

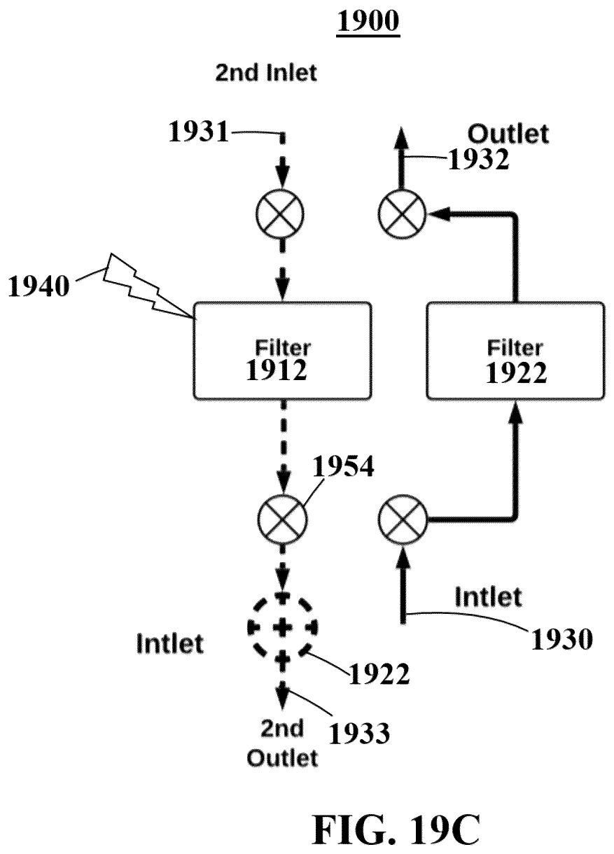

FIG. 19A, 19B, and 19C illustrate diagrams of example flow paths for implementations of continuous filtration, with respect to which one or more aspects of the disclosed filtration systems may be utilized, consistent with examples of the present disclosure. At a high level, in some application where continuous cleaned flow is desired, at least two filters may be utilized. For example, while one filters is cleaned, the other filter provides cleaned fluid, and vice versa.

Referring to FIG. 19A, an example filtering operation of a filtration system 1900 is shown. The solid arrows show the path of fluid flow. The raw fluid enters the filtration system 1900 from an inlet 1930, then particles are trapped in dirty sides of two filters 1912 and 1922. The cleaned fluid then leaves the filtration system 1900, out a main outlet 1932. In some cases, the filtration system 1900 may have some dampers or values 1951 and 1952 to adjust, direct, or redirect the flow path.

FIG. 19B and 19C present example cleaning operations of a filtration system 1900 and filtration system 1900C, respectively, during filtering operation. Referring to FIG. 19B, the raw fluid may enter the filtration system 1900 from a main inlet 1930. Then, the fluid may pass through the first filter 1912. Then, the cleaned fluid may leave the filtration system 1900 from main outlet 1932 (the solid arrows show the flow path of filtering operation), while the second filter 1922 is being cleaned. In FIG. 19B, the dashed arrows from 1931 through 1933 show the flow path for cleaning operation of the second filter 1922. In some cases, to clean the second filter 1922, the fluid enters the second filter 1922 from a clean side of the second filter 1922 and the leaves the second filter 1922 from a dirty side while the second filter 1922 is being cleaned (e.g., shaken at 1940). Then, the dirty flow may leave the filtration system via a secondary outlet 1933. According to some cases, the filtration system 1900 may have a component or compartment 1960 to generate the reverse flow (from the clean side of the second filter 1922 to the dirty side of the second filter 1922) during cleaning operation. In some cases, the user component 1960 may be placed after the filters 1912 or 1922 to draw or suck-in the fluid, or it may place before the filters 1912 or 1922 to push the fluid towards the filters 1912 or 1922.

Referring to FIG. 19C, after the second filter 1922 is cleaned, the filtration system 1900 may then start the filtering operation with the second filter 1922 (shown in the solid arrows on the right, between the inlet 1930 and the outlet 1932). Then, in such cases, the cleaning operation may start to clean the first filter 1912 (e.g., following the dashed arrows between 1931 and 1933 for the fluid path), while the second filter 1922 performs the filtering operation such that cleaned fluid leaves the filter media from main outlet 1932. As also shown in FIG. 19C, the reverse flow may come from secondary inlet 1931, then pass through the first filter 1912 from clean side and then leave from dirty side while the first filter 1912 is cleaned (e.g., shaken). Hence, the particles are released from the dirty side of the first filter 1912 and may leave the filtration system via secondary outlet 1933. After the first filter 1912 is cleaned, the filtration system may start the filtering operation. As shown in the illustrative examples of FIGS. 19A-19C, at all times (even during cleaning operation), the raw fluid may enter the main inlet 1930 and the cleaned fluid leaves the filtration system from main outlet 1932 (e.g., such that there is no interruption in filtering operation, even while the filters is begin cleaned). In some cases, the filtration system 1900 may have a component or compartment 1960 to generate the reverse flow (e.g., from clean side of the first filter 1912 to the dirty side of the filter) during cleaning operation.

The disclosed systems and methods may be utilized in conjunction with other filter cleaning method such as jet pulse, cyclone filtration system, vortex filtration system, centrifugal filtration system, or the like. In some cases, the dirty side of the filters 1912 and 1922 may be positioned facing towards the ground. Further, to enhance the performance of cleaning operation, the shaking force (e.g., load, impulse, etc.) may be applied in opposite direction of gravitation force to prevent re-accumulation (e.g., diffusing, permeating, attaching, adhering, building up, etc.) of the particles at the filters 1912 and 1922 during the cleaning operation. Additionally, consistent with techniques described herein, the applied shaking force may pull or push the filter toward the opposite direction of gravitation force, depending on application.

### Examples of Self-Cleaning Dual Filtering systems

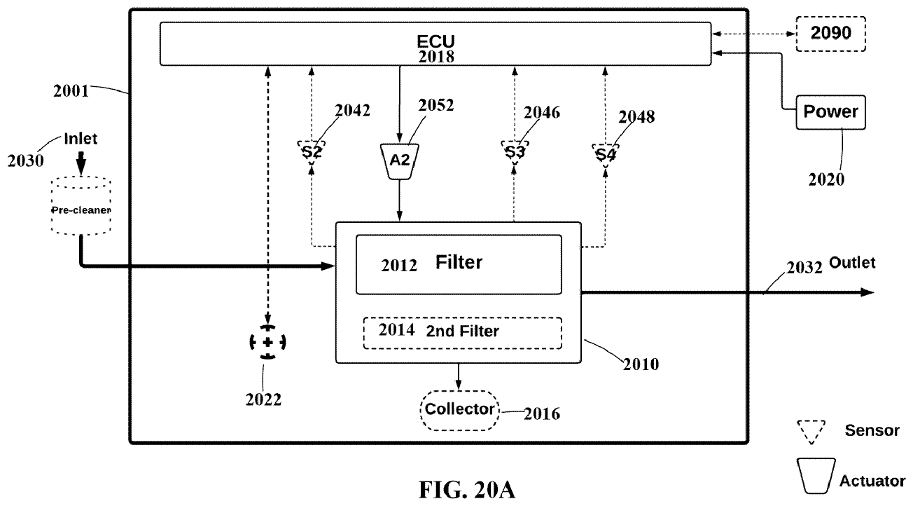

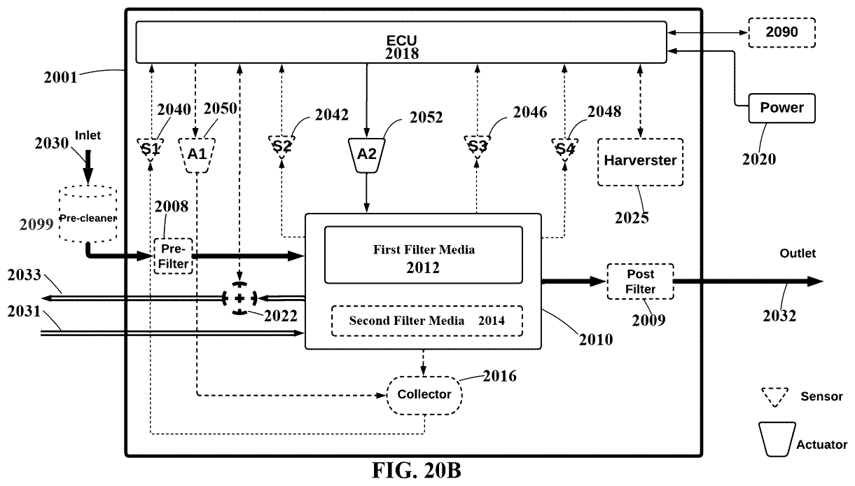

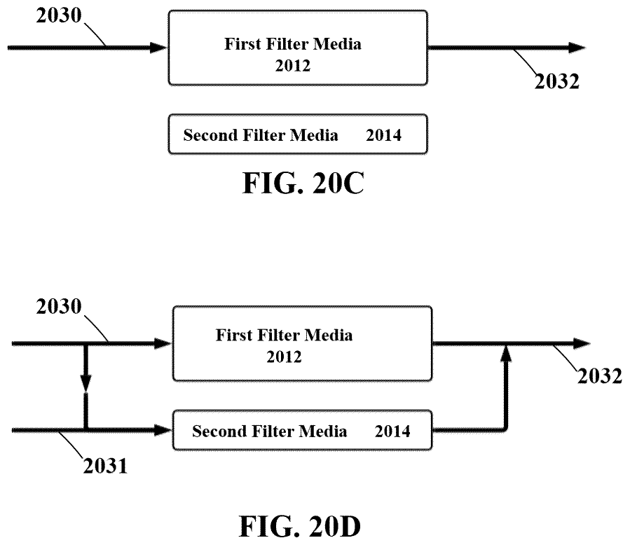

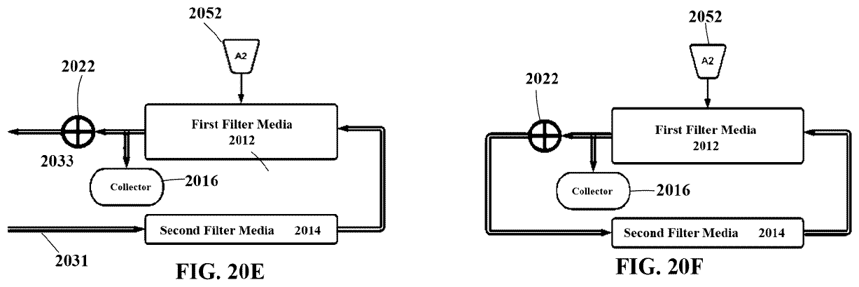

FIGS. 20A, 20B, 20C, 20D, 20E, and 20F illustrate diagrams of example self-cleaning dual filtration systems and methods, consistent with certain examples of the present disclosure. Specifically, FIGS. 20A and 20B are diagrams of examples of self-cleaning filtration systems and methods that have at least two filter media: a first filter media 2012 and a second filter media 2014. FIGS. 20A-2OF may have certain similarities to FIG. 11; as such, one or more components or techniques described with respect to FIGS. 20A-20F may be the same as or similar to components or techniques described with respect to FIG. 11.

Referring first to FIG. 20A, an example automatic self-cleaning filtration system is illustrated, including a main frame 2001, the first filter media 2012, the second filter media 2014, a filter housing 2010, sensors 2042-2048, a shaking source 2052 (e.g., actuator, energy source, etc.) to shake the filters 2012 or 2014 during cleaning operation, an electrical control system (ECU) 2018, a source 2022 to generate a reverse fluid (e.g., gas, liquid) flow during cleaning operation in the filters 2012 or 2014, at least one power source 2020 or an energy harvester compartment 2025 (see, e.g., FIG. 20B) to power the self-cleaning filtration system (e.g., the ECU 2018, the reverse flow source 2022, the sensors 2042-2048, the shaking source 2052, and other components), a collector component 2016 to collect the particles (e.g., dust, drips, etc.) a main inlet 2030, and a main outlet 2032, among other elements described below.

According to some embodiments, the ECU 2018 may be configured to send or receive data from the sensors 2042, 2046, 2048 and shaking source 2052. User components 2090 may be one or more of operators (e.g., a human operator), at least one computing device, a machine, storage, cloud, or the like. In some aspects, the ECU 2018 may be configured to control the cleaning operation via an algorithm, AI (artificial intelligence) depending on application. For example, in some cases, the cleaning operation duration may be controlled as a function of filtration time, the mass of the filter, pressure drops, and other relevant data, system parameters, or the like. Further, in certain cases, the user component 2090 can over-write command from the ECU 2018 (e.g., a user can turn on or off, re-program or otherwise control the cleaning operation). In some embodiments, the ECU 2018 may send a signal to the user components 2090 when anything goes wrong with the filtration system. All the sensors 2042-2048 and the shaking sources 2052 may be mounted in the main frame 2001. The first and second filter media 2012 and 2014 may be held within in the filter housing 2010. The ECU 2018 may also be placed within main frame 2001, or outside of the main frame 2001, depending on application. Further, according to certain systems herein, the sensors 2042-2048 and the shaking sources 2052 may be connected to the ECU 2018 via wire or wireless interconnections (e.g., to send and receive signals; note: in FIG. 20A, all of the thin arrows to and from ECU 2018 are representative of connectivity between various components and the ECU 2018). Further, whenever it is mentioned that other components herein are connected to the ECU 2018, any or all such components may be connected to the ECU 2018 wired or wirelessly.

Referring to FIG. 20B, the self-cleaning filtration system may have additional components, passageways or compartments such as secondary inlet 2031, secondary outlet 2033, sensors 2040, actuators 2050 associated with the collector 2016, and an energy harvester 2025 (or a battery) when the source power 2020 is not accessible or operable.

Referring to FIG. 20A and 20B, the self-cleaning filtration system may have a series of sensors 2040-2048 to measure or characterize the quality of inlet flow 2042, and of outlet flow 2048. More specifically, in some cases, the sensors 2046 measure the status of the first filter media 2012 or 2014. In some cases, additional sensors may be included to measure the status of the collector 2016. Also, the system may have one or more additional actuators 2050 to empty or control the collector 2016.

The collector 2016 may have actuators (not shown) configured to empty the collector 2016 via one or more mechanically or electro-mechanically implemented mechanisms. The actuator of the collector 2016 may be connected to ECU 2018 and receive an on/off signal therefrom. Also, sensors 2040 can be attached the dust collector 2016 to measure the amount of the particles in the collector 2016, the previous time that the collector 2016 was emptied, or any other measurement to track the performance and functionality of the collector 2016.

In some cases, to generate the reverse flow during the cleaning operation, from the clean side to dirty side of the first filter media 2012, a compartment 2022, such an electro-mechanical fan, blower, or a pressure vessel may be utilized to generate flow (e.g., a pulse jet flow, etc.). In these cases, such device 2022 may be placed (i) on the dirty side of first filter media 2012 to impel or suck the fluid flow, or (ii) somewhere in flow path to pull the flow from clean side of the filter to dirty side of the first filter media 2012. In some cases, the device 2022 may be connected to the ECU 2018 to send and receive control and feedback signals therewith, therethrough, or to different monitoring or control components.

### Examples of Filtering Operation

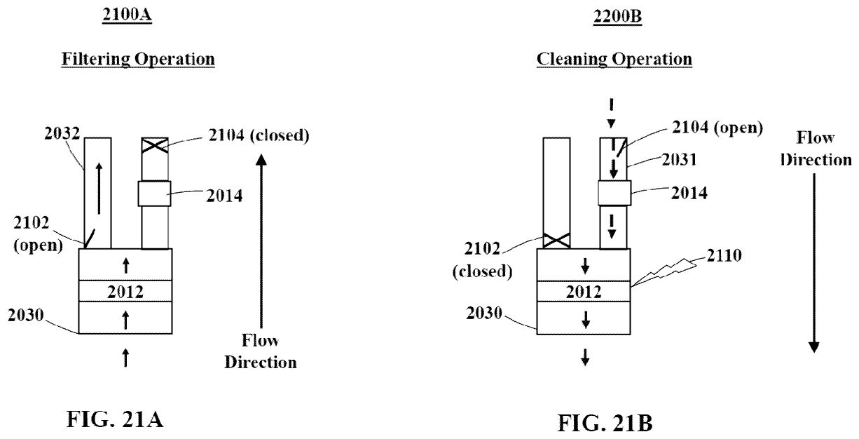

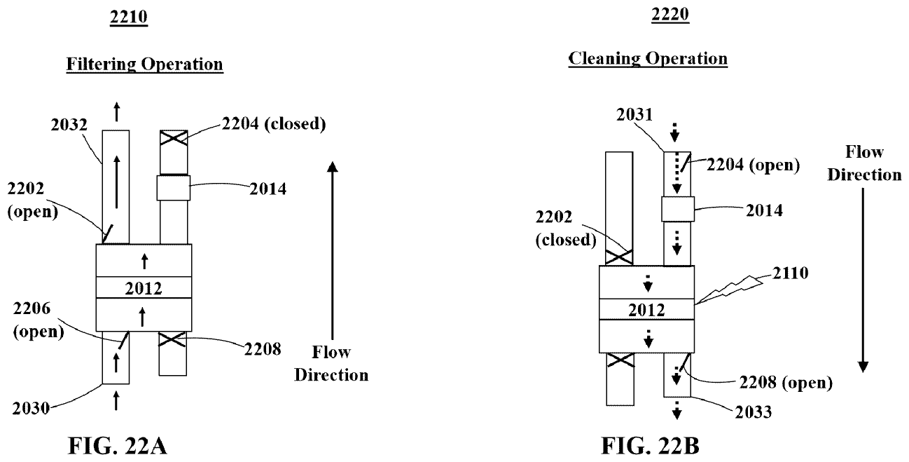

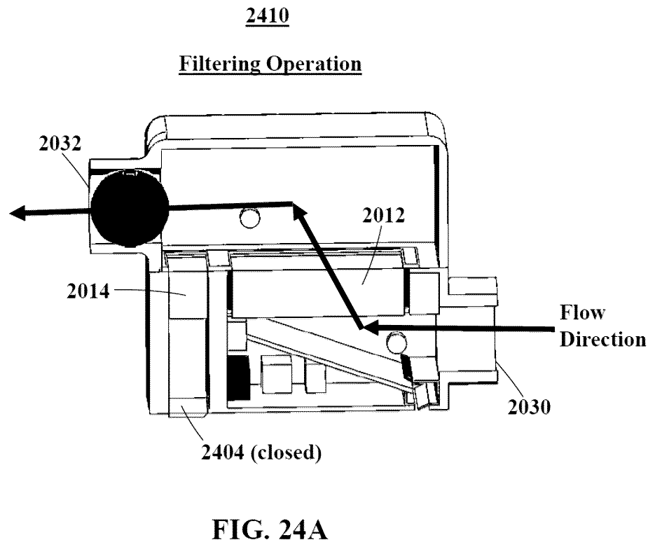

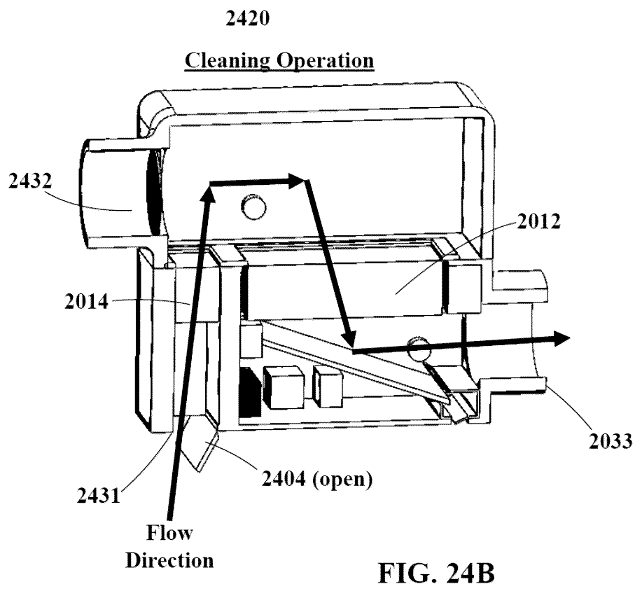

Various example aspects of normal (filtering) operation are discussed in connection with FIGS. 20A, 20C, 20D, 21A, 22A, and 24A. In these drawings, arrows 2030/2032 (FIGS. 20A and 20C), arrows 2030/2031/2032 (FIG. 20D), the arrows from 2030 to 2032 (FIGS. 21A and 22A), and the arrows from 2030 to 2032 (FIG. 24A) present the example flow paths during normal filtration in the above-described figures and drawings. In some cases, during filtering operation, the raw fluid (e.g., air) flow enters the filter box housing 2010 via the main inlet 2030. In addition to the main inlet 2030, in certain cases, the raw flow may also enter from the secondary inlet 2031 (see, e.g., FIG. 20D).

During filtering operation, after the raw flow enters the filter main frame 2001, the raw flow passes through the first filter media 2012 from dirty side of the filter. As a result of filtration, the particles are trapped in the dirty side of the first filter media 2012. Furthermore, depending on application, the raw flow also may pass through the second filter media 2014 during the filtering operation as shown in FIG. 20D, (e.g., from 2031 through second filter media 2014, to 2032). In this case, the raw flow that passes through the second filter media 2014 may enter the main inlet 2030 or via the secondary inlet 2031. After such filtration, the cleaned flow exits the main frame 2001 via the main outlet 2032. In some cases, dampers or valves may be used, placed on, or positioned in connection with the main frame 2001 to control, regulate, direct, or redirect during filtering operation as well as cleaning operation.

According to some embodiments, during the normal filtrating operation, the shaking sources 2052 may be set or switched off. In addition, the sensors 2042 and 2048 may be positioned and configured to measure or characterize the quality of raw flow and the cleaned flow such as flow rate, pressure, temperature, humidity, number of particles, chemical compositions, respectively, and transfer the data to the ECU 2018, or directly to user components 2090. Further, in some cases, the parameters (e.g., velocity, acceleration, weight, displacement, or other parameters) or status of the filter media 2012 and 2014 may be measured or characterized and transferred by sensors 2046, such as in real-time, to the ECU 2018 or to the user components 2090. Such transmission may also be performed via one or more of the sensors 2040-2048. In some cases, the sensors 2046 may also be integrated to one of the other sensors 2040, 2042, 2044, or 2048. Further, systems and methods herein may be configured to set or adjust the sampling rate of the sensors 2040-2042 depending on the application, e.g., as a function of system requirements, the filtration or cleaning status for each such application, or other factors.

According to FIG. 20B, to still other examples, additional filters, such as any pre-filters 2008 or post-filters 2009 may also be utilized in addition to the two filter media 2012 and 2014, depending, for example, on application and design requirements.

In some cases, during filtering operation, the energy harvester 2025 (e.g., a generator which is placed in flow path, or a vibration harvester placed inside the main frame 2001) may convert the kinetic energy into electrical energy that is then stored (e.g., in a battery). The stored energy may be used to power the ECU 2018, the sensors 2040-2042, the shaking sources 2052, or any other components that may consume power during filtering operations and cleaning operations.

### Examples of Cleaning Operations

Various example aspects of cleaning operations are discussed in connection with FIGS. 20B, 20E, 20F, 21B, 22B, and 24B. According to some examples herein, the normal filtrating operation are stopped before the cleaning operation is to be started. While in other examples herein, the filtering operations may continue during at least part of the cleaning operations.

In cases where the filtering operations are stopped before the cleaning operation, no flow passes the main outlet 2032 during the cleaning operation. Some example flow paths, during cleaning operations, are shown via arrows 2031 to 2033 in FIGS. 20B, 20E, 20F, 21B, 22B, and arrows 2431 to 2033 in FIG. 24B. During the cleaning operation, the fluid may flow from the clean side of the second filter media 2014 to the clean side of the first filter media 2012. During various cleaning operations of the disclosed technology, to clean the first filter media 2012, the fluid flow may enter the main frame 2001 from secondary inlet 2031 or main inlets 2030. Then, the inlet flow passes through the second filter media 2014 from the dirty side to the clean side, thereby cleaning the flow. Then, the cleaned flow passes through the first filter media 2012 from cleaned side to dirty side, while the shaking sources 2052 (e.g., one or more actuators) are triggered to shake the first filter media 2012. As a result of such shaking (e.g., by electrical-mechanical, electromagnetic, ultrasonic, etc.) the first filter media 2012, the particles are released from the dirty side of the first filter media 2012, as shown in FIGS. 20E, 21B, 22B, and 24B. Then, the dirty flow may leave the main frame 2001 via the secondary outlet 2033, see FIG. 20E. In some cases, instead of the secondary outlet 2033, the dirty flow may leave the main frame 2001 via the main inlet 2032, as shown in FIG. 21B. In some other cases, the filtration system may be a closed system (e.g., during cleaning operation as shown in FIG. 20F, as in, no flow leaves the main frame 2001 during cleaning operation).

During the cleaning operation, depending on design and application requirements, the second filter media 2014 may also be cleaned, though this is not required in all cases. The cleaning operation for the second filter media 2014 may be the same as or similar to the cleaning operation described above for the first filter media 2012 (though, in all abovementioned figures, the relative position of first filter media 2012 and second filter media 2014 may be exchanged with regard to the flow paths).

In some cases, during the cleaning operation, as the flow leaves the first filter media 2012 (or 2014), the particles leave the filter housing 2010 via the secondary outlet 2033 (or another outlet). In some applications, if the main frame 2001 has a secondary inlet 2031, then the flow may leave main frame 2001 via the main inlet 2030, as may be seen in one example presented in FIGS. 21A and 21B.

Referring to FIG. 20B, during cleaning operation, in some embodiments, the raw flow may enter to the filtration system via a secondary inlet 2031 and leave the filtration system via a secondary outlet 2033, where the arrows 2031 (to 2010) and 2033 (from 2020) show the flow path. In some other embodiments, the filtration system may be a closed system (e.g., the flow may not enter or leave the system during the cleaning operation, as shown in FIG. 20F).

### Example Dampers or Valves

FIGS. 21A-B and FIGS. 22A-B illustrate various example flow and filtering arrangements consistent with FIG. 20A-F, which provide the relative locations and status of some dampers or valves to control, regulate, or redirect the flow path during filtering operation and cleaning operation. For example, FIG. 21A illustrates an example of filtering operation, where the raw fluid enters the main frame 2001 via the primary inlet 2030, and the cleaned fluid leaves the main frame 2001 via the primary outlet 2032, given that a first damper or valve 2102 is set open, while a second damper or valve 2104, which is positioned in a fluid path of secondary inlet 2031 is closed.

FIG. 21B further illustrates an example during cleaning operation, where flow direction is reversed. Here, for example, the second damper or valve 2104 is open and the first damper or valve 2102 is closed, such that fluid enters the filtration system via secondary inlet 2031 and passes via the second filter media 2014 from dirty side to clean side and then the cleaned flow enters the first filter media 2012 from the clean side. Namely, the fluid first flows through the second filter media 2014 to clean the fluid further, and then passes through the first filter media 2012 while the first filter media 2012 is shaken at 2110, to release the particles from the first filter media 2012. In this example, the damper or valve 2102 is closed so that no flow may enter nor exit the main outlet 2032 during cleaning operation.

FIGS. 22A and 22B illustrates another example of filtering operation and cleaning operation, respectively. Illustrated in FIGS. 22A and 22B are two inlets: a main inlet 2030 and a secondary inlet 2031, and two outlets, a main outlet 2032 and a secondary outlet 2033. Valves or dampers may be used throughout the channel or duct passageways to adjust, control, regulate, or redirect the flow path during filtering operation and the cleaning operation. For example, as shown in FIGS. 22A and 22B, each inlet and outlet may have a valve or damper to control, regulate, or redirect the flow path. As such, during the normal cleaning operation, the valve 2206 may be placed in the primary inlet 2030. Further, the valve 2202 may be placed in the primary outlet 2032 that is set open, while the valve or damper 2204 is placed in the secondary inlet 2031 and the valve 2208 placed in the secondar outlet 2033 are set as closed. During the cleaning operation, the main values 2206 and 2202 are set closed while the secondary valves or dampers 2204 and 2208 are set open.

### Example Self-Cleaning Unit With Flat Filter

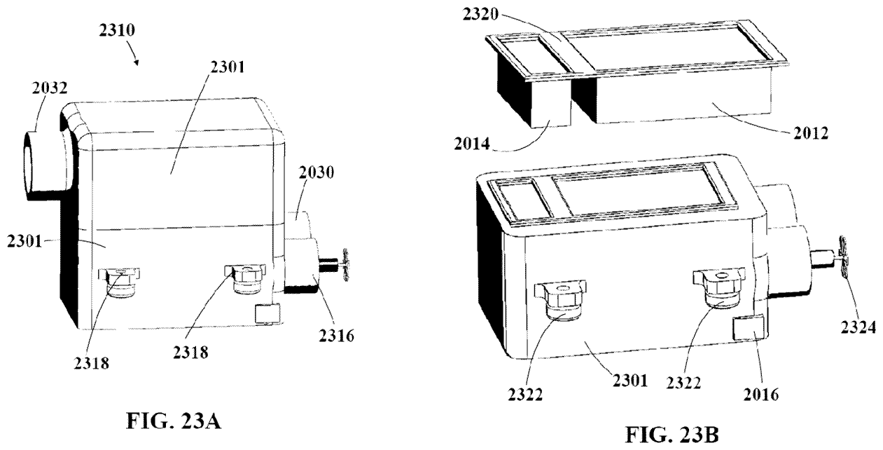

FIGS. 23A and 23B are diagrams depicting closed and exploded views, respectively, of an example self-cleaning filtration system, consistent with examples of the present disclosure. Referring to FIG. 23A, an illustrative diagram of example self-cleaning filtration device 2310 for a motor vehicle is shown in closed view, including a main frame 2301, a main inlet 2030, a main outlet 2032, a secondary outlet 2316, and example attachment points 2318 (e.g., for attaching to a vehicle). FIG. 23B discloses another view of an example filtration system 2310 consistent with FIG. 23A. Referring to FIG. 23B, the illustrative filter shown in the exploded or expanded view comprises a filter structure 2320 including a first filter media 2012 and a second filter media 2014, shock absorbers 2322 that may be attached at the attachment points 2318, a collector 2016 (e.g., for collecting dust, pollen, dirt, etc.) from the air flow, and a blowing or suction component or compartment 2324, such as a suction blower, which may act as a generator during filtering operation. Further, a generator may convert part of kinetic energy of flow to electrical energy. In the example shown in FIG. 23B, the first filter media 2012 and the second filter media 2014 may be connected to each other or may be separated (not shown). In FIG. 23B, the filter structure is shown both in an exploded manner (above the main frame 2301) as well as positioned or situated within the lower main frame 2301 of the filtration system 2310, for purposes of illustration.

FIGS. 24A and 24B are diagrams depicting cross-sectional views of an example self-cleaning filtration device 2310 illustrating direction of fluid flow for both filtering operation (FIG. 24A) and for cleaning operation (FIG. 24B), consistent with examples of certain embodiments of the present disclosure. Referring to FIG. 24A, an example of filtering operation is shown, with raw air flow coming from the main inlet 2030, traveling through the first filter media 2012 from dirty side to clean side and then cleaned air exiting the filtration system from main outlet 2032, as the secondary inlet damper 2404 may be closed. However, in some examples, the raw flow may also be filtered via a second filter media 2014 during filtering operation, depending on application.

Referring to FIG. 24B, one example cleaning operation is shown, with the outlet damper 2432 being closed and the secondary inlet damper 2404 being open while the flow of air is reversed though the first filter media 2012. Here, a flow of air utilized to clean the first filter media 2012 enters from the secondary inlet 2431, travels through the second filter media 2014, cleaning the inlet air, and then such air passes through the first filter media 2012 in the reverse direction (from clean side to dirty side of filter 2012). Thereby dislodging (e.g., removing) particles from the dirty side of the first filter media 2012 while the filter 2012 is shaking to extend the life of the first filter media 2012, as explained in more detail elsewhere herein.

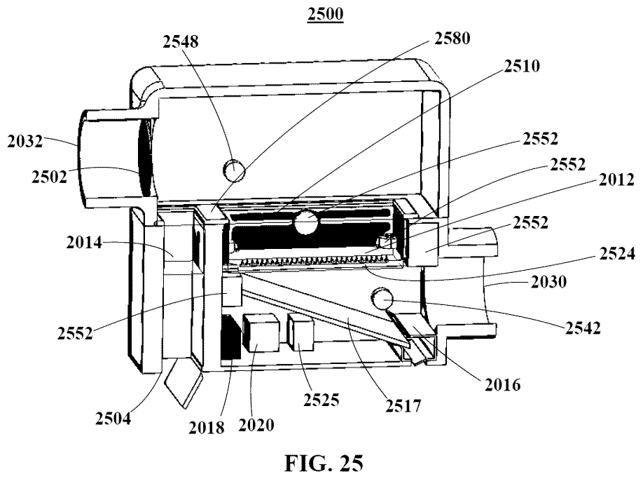

FIG. 25 is a diagram depicting a cross-sectional view of an example filtration device 2310 having planar filter media, consistent with examples of the present disclosure. Referring to FIG. 25, a cross-sectional view 2500 of an example self-cleaning filtration system for vehicles is shown, including a primary inlet 2030, an inlet sensor box 2542, a secondary inlet and damper 2504, a main outlet 2032, an outlet damper 2502, an outlet sensor box 2548, a filter housing 2510, actuators 2552, a force translating compartment 2524 such as a structural rod (e.g., to shake the filter), an ECU 2018, a power supply 2020, a vibration harvester 2525 (which may convert the vibration to the electrical energy), a particle guide 2517 to guide the particles dislodged from the dirty side of the filter during cleaning operations to a collector 2016.

In some embodiments of a self-cleaning filtration system, the filter media may have some other geometries, depending on application and the space allocated to the filtration system. For example, the filter media may be made in cylindrical, conic filter, or any other shape. However, the components or compartments may be connected or placed in the filtration system as the disclosed and explained in this description and permutations mentioned, above, as well as in the drawings.

According to various embodiments herein, the disclosed technologies may be utilized in many other applications (e.g., where the particles may not exit the filtration system during cleaning operation). In some cases, the disclosed systems and methods may be utilized to clean emissions systems. By way of non-limiting examples, the disclosed systems and methods may reduce the emission of internal combustion engine, as well as the emission from power plants by cleaning and improving the efficiency of intake and outlet compartments which are used to clean, filter, absorb, destroy, change, etc. the chemical or physical compositions, or the like. Among other utilizations, for example, the disclosed systems and methods may be used in exhaust systems of any type of motor vehicles, power plants, or the like.

### Examples of Self-Cleaning Filtering Systems With Storage

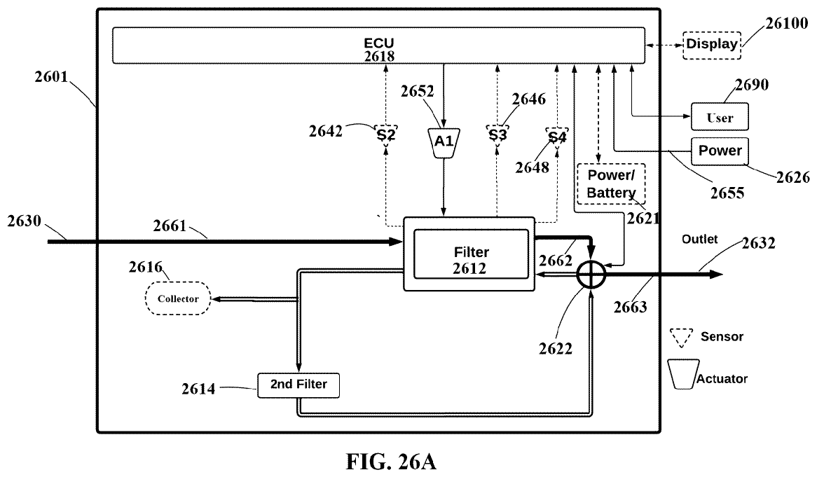

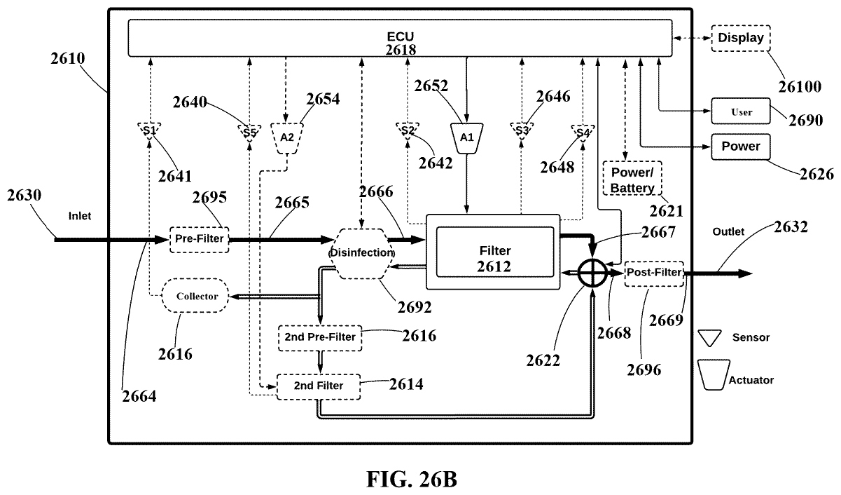

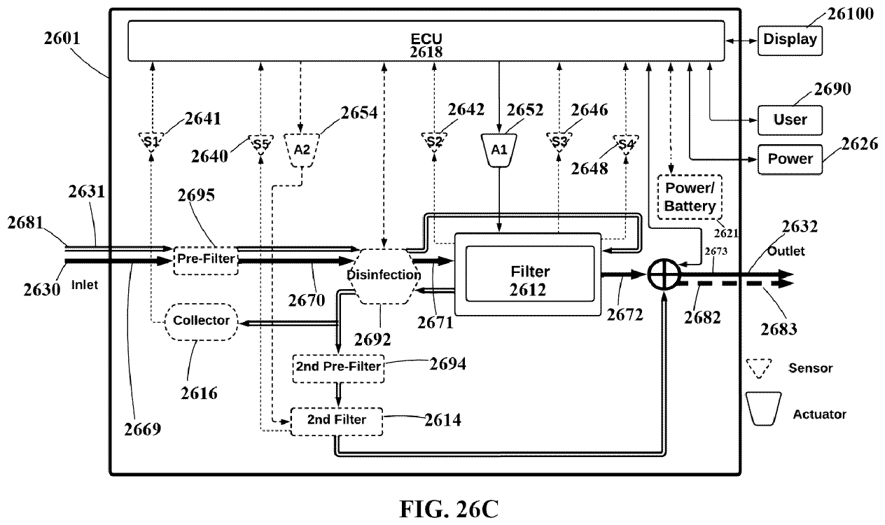

FIGS. 26A-26C are diagrams depicting example air filtration systems and methods, consistent with examples of the present disclosure. Referring first to FIG. 26A, an example automatic self-cleaning air filtration system is depicted, including a main frame 2601, two filters (e.g., first filter media 2612 and secondary filter 2614, one shaking source 2652 (e.g., actuator, energy source, etc.) to shake the filter media 2612 and 2614 during the cleaning operation, an electrical control system (ECU) 2618, various sensors 2642-2648, a main inlet 2630, a main outlet 2632, an electromechanical device or other such device (e.g., a blower) 2622 to generate air flow, one or more valves or dampers to control or redirect the flow path through the filtering operation as well as cleaning operation (shown elsewhere herein), at least one external power source 2620, or internal power source 2621 such as a battery (e.g., to power the ECU 2618, the sensors 2642-2648, the shaking source 2652, or other components), and a collector component 2616 to collect the particles (e.g., dust, drips, etc.), among other elements described below. FIGS. 26A-20C may have certain similarities to FIG. 11 or FIGS. 20A-20F; as such, one or more components or techniques described with respect to FIGS. 26A-26C may be the same as or similar to components or techniques described with respect to FIG. 11 or FIGS. 20A-20F.

In some cases, the ECU 2618 may be configured to send data to or from the sensors 2642, 2646, 2648 and the shaking sources 2652 for various processing or use, e.g., at user components 2690. User components 2690 may be one or more of an operator (e.g., a human operator), at least one computing device, artificial intelligence (AI), a machine, storage, a cloud-based system or service, or the like. In some cases, the ECU 2618 may be configured to control the cleaning operation by an algorithm, AI or machine learning components or techniques, via at least one mobile device such as a cellphone app, other end user control mechanisms, or the like, depending on application. In some cases, the cleaning operation duration may be controlled as a function of filtration time, the mass of the filter, pressure drops, and other relevant data, system parameters, or the like. Further, in certain cases, the user component 2690 can over-write command from the ECU 2618 (e.g., a user can turn on or off, re-program or otherwise control the cleaning operation). The ECU 2618 may send a signal to the components 2690 if anything goes wrong with the filtration system. All the sensors 2642-2648 and the shaking sources 2652 may be mounted in the main frame 2601. The main filter media 2612 and the secondary filter or filter media 2614 may be positioned within separate flow channels or housing (not shown) or they may both be held within one filter structure or one housing. The ECU 2618 may also be placed within the main frame 2601, or outside of the main frame 2601, depending on application. Further, in some cases, the sensors 2640-2648 and the shaking source 2652 may be connected to the ECU 2618 via wired or wireless interconnections (all thin the arrows, to and from the ECU 2618, are representative of connections) to enable sending and receiving signals. Further, whenever it is mentioned that various devices herein are connected to the ECU 2618, any or all such devices may be connected to the ECU 2618 wirelessly or via wired connection.

Referring to FIG. 26A, various illustrative components are shown, e.g., components that are useful in applications where the particles are stored within the filtration system during the cleaning operation. As one example, for this present air purification application, various portable air purifiers may be utilized to purify the air inside of a residential, industrial, or commercial environment. For example, in medical or scientific facilities, it may be particularly important to store the particles, as opposed to releasing the particles back into the facility. In some cases, such filtration system may contain the main body 2601 (in which all the components are placed), the main inlet 2630, the main outlet 2632, the first filter media 2612, the secondary filter media 2614, the collector 2616, the ECU 2618, the shaking sources 2652, the sensor 2646 to measure the performance or status of the shaking sources 2652, or other sensors to measure or characterize the quality of the inlet fluid 2642 and the outlet fluid 2648, at least one source 2622 to generate the flow (e.g., a blower, etc.). In some cases, during filtering operation, the shaking source 2652 may be turned off, while all the sensors 2640-2648 may still be active and configured to measure and send data to the ECU 2618.

According to some cases, filtration systems consistent with FIG. 26A may require external power to operate or internal power such as a battery 2621. Further, in some cases, all the components that need the electrical power, may be connected to the ECU 2618, directly or indirectly, or directly or indirectly to the power sources, whether internal or external. In some cases, the ECU 2618 may be configured to control various components of the filtration system and can be programed via or at the user component 2690 (e.g., by a user) or may control the filtration system via AI or other machine learning techniques. Examples of the user component 2690 may include one or more of an operator, a cloud, AI components or services, etc. Further, in some cases, the filtration system may include an internal power source 2621, for example, a battery, etc.

During cleaning operation, the particles may be collected in the collector 2616. In some cases, the collector 2616 may be frequently dislodged from the filtration system, e.g., to be cleaned or replaced. Also, the filtration system may a have display system 26100 to present various data, characteristics, etc., such as performance, quality of the inlet and outlet fluid, flow rates, operational status, or the like. In some cases, the ECU 2618 may send or receive data from an app.

### Examples of Filtering Operations

In FIG. 26A-26C, 27A, 28A, and 29C, the thicker, solid arrows (e.g., 2661 through 2673, 2630, 2761, and 2763) illustrate example flow paths within a filtration system. In some cases, during filtering operation, the raw fluid (e.g., air) flow enters the filter box housing 2610 via the main inlet 2630. In addition to the main inlet 2030, in certain cases, the raw flow may also enter from the secondary inlet (not shown).

Referring to FIG. 26A, during the filtering operation, the raw fluid enters the filtration system via the main inlet 2630. Then, the fluid passes through the first filter media 2612 from dirty side to clean side of the filter 2612. As a result, the particles are trapped on the dirty side of the filter. Then the cleaned fluid (e.g., air, etc.) leaves the filtration system via the main outlet 2632. To generate the flow, a device (e.g., mechanical, electro-mechanical or other device) 2622, such as blower, may be utilized according to some cases. In some cases, the device may be placed after the first filter media 2612, or it may be placed before the first filter media 2612, depending on application. During filtering operation, the quality or other characteristics or parameters of the raw fluid and cleaned fluid may be measured by sensors 2642 and 2648, before and after cleaning, respectively. Sensor data measured by sensors 2642 and 2648 may then be transferred to the ECU 2618, which, according to some cases, may process or transmit the sensor data to the user components 2690 for presentation to a user (e.g., via one or more displays 26100, or other devices).

Referring to FIG. 26B, in some cases, the filtration system may be equipped with a disinfection system 2692 to destroy, kill, remove, etc. certain pathogens. Such disinfection system 2692 may be placed before the first filter media 2612, or after it. In some cases, the disinfection may be done on the filter media 2612 or 2614 (e.g., the filter media 2612 or 2614 may be coated with materials which destroy the pathogens). Further, the filtration system may be equipped with a heater, a cooler, or a humidifier. The disinfection system 2692 may also be connected to the ECU 2618 and may be controlled or programed by the user component 2690 (e.g., via a cell phone app, computer, tablet, or any other methods). The quality of the fluid and the status of the filtration system may be processed, transmitted, or displayed (e.g., shown on a display system 26100) or otherwise fed back and utilized to monitor or improve operation.

In some cases, the disinfection system 2692 may be placed anywhere before or after the first filter media 2612, depending on application. The disinfection system 2692 may use radiation, waves, energy sources, or other treatment techniques, such as UV, heat, cold-plasma, electrical charge, chemical reaction, to destroy, absorb, remove, etc. pathogens or any particles. Furthermore, in some cases, the filter media 2612 or 2614 may be coated with some materials which may disinfect, destroy, or otherwise treat the pathogens (e.g., using some chemical compounds, which may use radiation to accelerate the rate of disinfection). In some cases, temperature control or humidity control may added to adjust the outlet flow 2632.

FIGS. 26A, 27A, 28A, 29A, and 29C illustrate normal air filtration/flow operation such as 2700 and 2740. During such filtering operation (e.g., solid thick arrows from 2761 and 2763), the raw flow enters the filtration system via main inlet 2730 and the cleaned flow leaves it via main outlet 2732, as follow. The raw fluid enters the filtration system via the primary inlet 2730. Then, the fluid passes through the first filter media 2612 from the dirty side to the clean side. As a result, the particles are trapped on the dirty side of the first filter media 2612. According to some cases, control of fluid flow (e.g. air, etc.) from the primary inlet 2130 to the first filter media 2612 may be controlled via dampers 2702, 2704, 2904, 2910, 2914, 2916, 2918, and 2934. Then, the fluid (e.g., air, etc.) leaves the filtration system via the main outlet 2632. Further, in some cases, a secondary damper, valve, etc. (e.g., the damper 2704) may be closed or off, which thereby isolates and prevents flow to or through the undesired path, (e.g., the damper 2704 can block fluid to flow to the second filter media 2614 during filtering operation).

### Examples of Cleaning Operations

In FIG. 26A-26C, 27B, 28B, and 29D, the thicker, dashed arrows (e.g., between 2681 and 2683) illustrate examples of flow paths that may enter from the main or secondary inlet and may leave from the main or secondary outlet during cleaning operation, depending on application and design.

According to various cases herein, during the cleaning operation, to clean the first filter media 2612, the flow in the first filter media 2612 is reversed (the flow enters the first filter media 2612 from the clean side and leaves from the dirty side). Referring to FIG. 26A, the source 2622 may be used to generate this reverse flow. The thicker, dashed arrows show a possible flow path of one example cleaning operation. During the cleaning operation, the shaking source 2652 shakes the first filter media 2612, while the flow is from clean side to dirty side of the first filter media 2612. As a result, the particles are released from the dirty side of the first filter media 2612. Then, as the flow leaves the first filter media 2612, it may pass through one or more collectors 2616, which may collect the larger particles (or other specifically targeted particles). Then, the flow passes the secondary filter media 2614, from the dirty side to the clean side, which traps the smaller particles (or, again, other specifically targeted particles). Then, the flow enters the clean side of the first filter media 2612. This cycle is repeated as long as the first filter media 2612 satisfies a target that may be defined by the controller, user, or AI (e.g. at the user component 2690). In some cases, the target may be based on the usage time, pressure changes or drops, or any other criteria. As shown in FIG. 26A, to generate the reverse flow during the cleaning operation, the same electro-mechanical device 2622 may be used to generate the flow during the filtering operation, or other flow devices may be utilized as explained elsewhere herein.

As shown in FIG. 26A, the cleaning operation (see thick, dashed arrows) may be a closed system (e.g., no flow enters the filtration system, and no flow leaves the filtration system during cleaning operation). Further, in some such cases, the particles are dislodged from dirty side of the first filter media 2612 and are collected in the collector 2616 or may be trapped on dirty side of the secondary filter media 2614. In such operation, the first filter media 2612 may become cleaner and hence the cleaning aspects (e.g., costs, filter needs, timing between replacements or services, etc.) of the first filter media 2612 are improved.

During various illustrative cleaning operations, as shown in FIG. 26B, one or more pre-filters 2616 may be placed between the dirty side of the first filter media 2612 and the dirty side of the secondary filter media 2614 (before the secondary filter 2614) to trap particles during the cleaning operation. Also, in some cases, one or more disinfection devices 2692 may be placed before or after the first filter media 2612, somewhere in-channels, in a duct or passageway, or the like to destroy, filter, etc. the pathogens during the cleaning operations and filtering operation. By way of one illustrative example, FIG. 26B shows that a disinfection system 2692 may be placed between the first filter media 2612 and the secondary pre-filter 2694, though other placements or configurations are within the ambit of the systems and methods discussed herein.

As shown in FIG. 26B, the secondary filter media 2614 may also be connected to a second source 2654 for shaking or otherwise dislodging particles from the secondary filter media 2614. Also, in some cases, a sensor 2640 may send a signal to the ECU 2618 to report the status of the second shaking source 2654. Cleaning the secondary filter 2614 may be done without generating the reverse flow. Further, in some implementations, a sensor 2641 may be connected to the collector 2616 to report the status (e.g., the fullness of the collector 2616) of the collector 2616 to the ECU 2618.

As shown in FIG. 26C, the cleaning operation may be an open system (e.g., the flow enters the filtration system via a main inlet 2630, or a secondary inlet 2631, or a main outlet and the flow exits via a secondary outlet 2633, a main outlet 2632, or a main inlet 2630). As shown in FIG. 26C, the thicker, dashed arrows show an example flow path for the cleaning operations of the filtration system. Here, for example, the raw flow may pass the pre-filter 2695, pass the disinfection system 2692, enter the main filter media 2612 from clean side, leave the filter media 2612 from dirty side, and again pass the disinfection system 2692. In such cases, at least a portion of the particles may go to the collector 2616, at least a portion of the particles may be trapped by the secondary pre-filter 2694, and at least a portion of the particles may be trapped by secondary filter media 2614. Then, the cleaned fluid may leave the filtration system from secondary outlet 2683 or main outlet 2632 during cleaning operation.

Referring to FIG. 26C, another example flow path is shown during the cleaning operation with thicker, dashed arrows between 2681, 2682, and 2683. In some cases, the raw fluid (or pre-cleaned fluid) may enter from clean side of the first filter media 2612 while the first filter media 2612 is shaken, jostled, oscillated, impinges with energy, etc. Hence, particles release from the dirty side of the first filter media 2612 and are collected in the collector 2616 or may be trapped by the dirty side of the second pre-filter 2694 or the second filter media 2614. In such cases, the cleaned fluid may leave the filtration system during the cleaning operation, as well. In some cases, during the cleaning operation, the inlet flow may enter the filtration system from the secondary inlet 2631 and the cleaned flow may leave the filtration system from the secondary outlet 2633. However, in some cases, the secondary inlet 2631 and the secondary outlet 2633 may be the same as the main inlet 2630 and the main outlet 2632 (e.g., see FIG. 23C and 23D where the fluid enters and exits the filtration system from same inlet and outlet), respectively, during filtering operation.

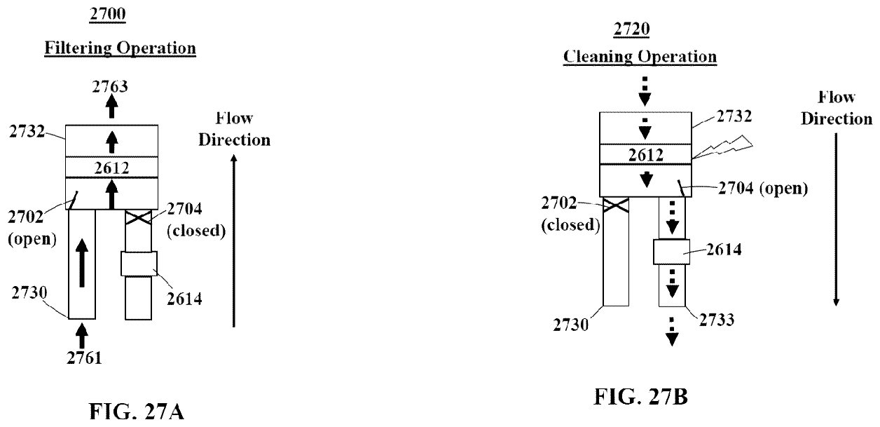

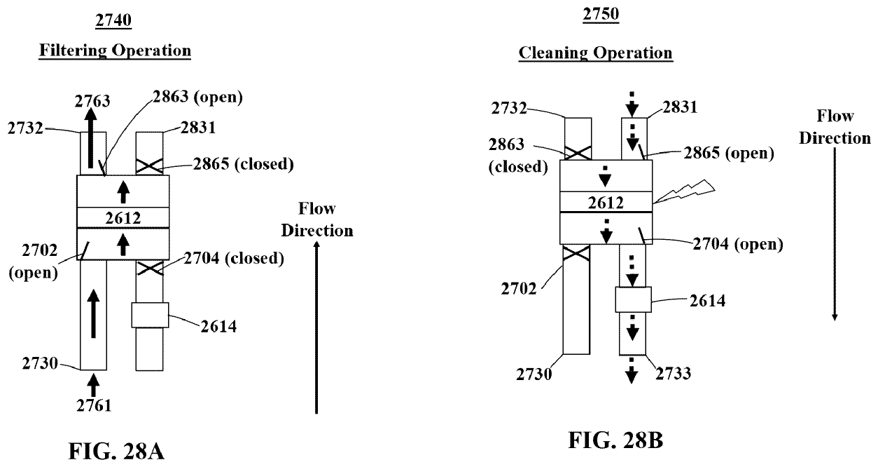

FIGS. 27B and 28B illustrate cleaning operations 2720 and 2750, respectively. FIGS. 27B and 28B include example dampers or valves to control or redirect the flow. Referring to FIG. 27B, an example cleaning operation is shown for a system in which the flow enters the filtration system via the main outlet 2732 during the cleaning operation. In the example shown in FIG. 21B, flow of fluid is reversed and the primary damper 2702 is closed. Further, the secondary damper 2704 is opened such that the reversed flow of fluid flows from the clean side, in the opposite direction, through the first filter media 2612 (e.g., while it is shaken). The particles that are thereby dislodged from the first filter media 2612 then travel out past the open secondary damper 2704 to the secondary outlet 2733. Hence, the particles are trapped on dirty side of the secondary filter media 2614 before the fluid leaves the filtration system. As a result, the cleaned fluid may leave the filtration system during the cleaning operation.

Referring to FIG. 28B, this illustrates yet another ducting system and method vis-à-vis the cases of FIG. 27B in that there are two inlets 2730 and 2831 and two outlets 2732 and 2733. During filtering operation, the raw fluid may enter the filtration system via the main inlet 2730 and the cleaned fluid may leave the filtration system via the main outlet 2132. Further, during the cleaning operation, the fluid may enter from the secondary inlet 2831, and the cleaned fluid may leave the filtration system via the secondary outlet 2733 after the underside particles are trapped by the secondary filter 2614. In some cases, various valves or dampers may control or redirect the flow by opening or closing in certain ways during cleaning operation and filtering operation. For example, the dampers 2702 and 2803 may be closed during cleaning operation to block the fluid from entering the main inlet 2130 and the main outlet 2132, respectively, while the dampers 2805 and 2704 may open during cleaning operation to allow the fluid to enter from the secondary inlet 2831 and leave from the secondary outlet 2133. In certain cases, during the cleaning operation, the outlet fluid may be cleaned before leaving the filtration system. By way of one example, as shown in FIGS. 26C, 27B, 28B, and 29D, the outlet fluid may pass the secondary filter media 2614 before leaving the filtration system during the cleaning operation.

### Damper and Valves

Furthermore, according to one or more cases of the disclosed systems and methods, the filtration system may have one or more dampers or valves to control, direct, or redirect the flow to the right channel or duct during filtering operation and the cleaning operation. In some cases, the dampers or valves may be connected to the ECU 2618 or may be controlled by the ECU 2618.

### Example Portable Air Purifier Implementations

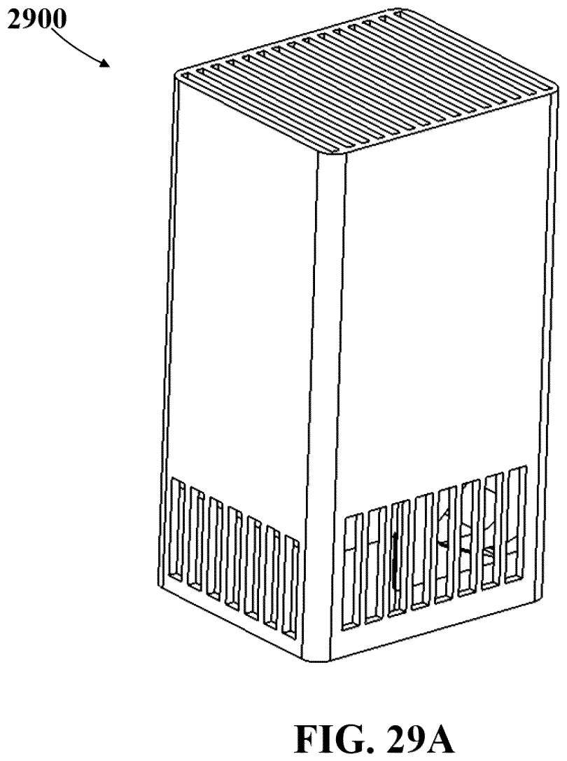

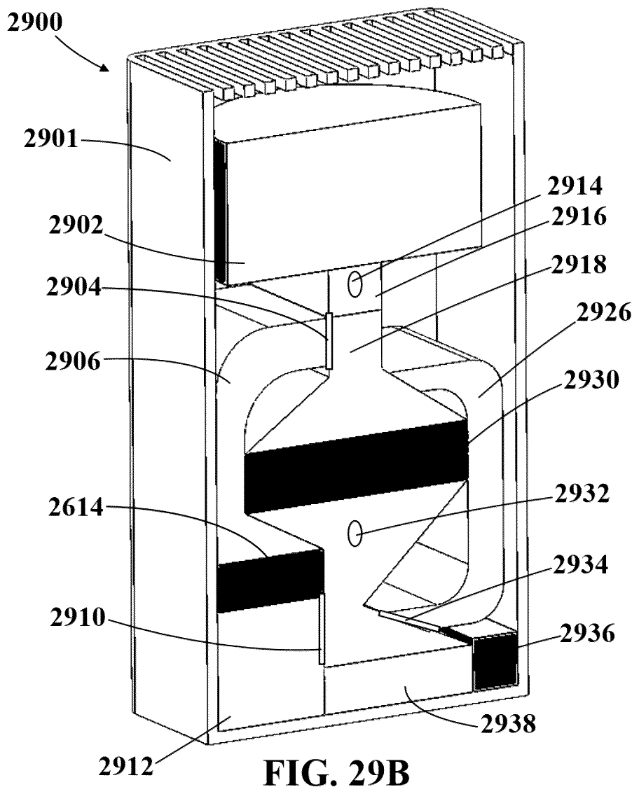

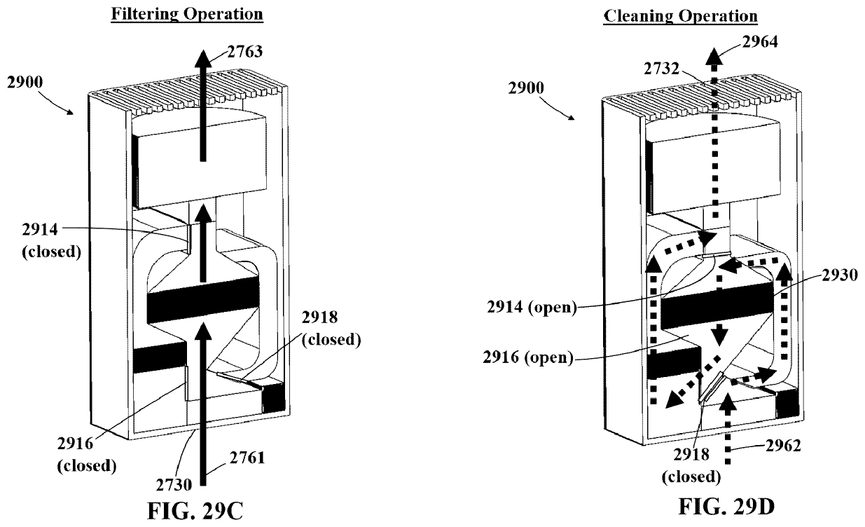

FIGS. 29A-29D are diagrams depicting illustrative operations of one example of a portable air purification system 2900, consistent with examples of the present disclosure. FIG. 29A illustrates the exterior of the air purification 2900, according to some examples. FIG. 29B illustrates a cross-sectional view of one example of the air purification system 2900, including one or more of a main frame 2901, a fan/blower/motor system 2902, a first damper 2904, a first air duct 2906, a secondary filter 2614, a second damper 2910, a collector 2912, one or more outlet sensors 2914, a second air duct 2916, a third air duct 2918, a fourth air duct 2920, a main filtration system 2930, one or more inlet sensors 2932, a third damper 2934, an ECU or power system 2936, and one or more pre-filters 2938. Further, one or more post-filters may be utilized after the main filter 2930, as set forth elsewhere herein.

In some cases, the main filter 2930 may include a filter housing, a reinforced structure, one or more shaking sources to shake the main filter 2930, and additional sensors. The main filter 2930 may be the same as or similar to various filtration systems discuss herein, such as FIGS. 7A-7D or FIGS. 10A-10C.

FIGS. 29C and 29D illustrate an example of a filtering operation 2910 and an example cleaning operation 2920, respectively, for air purification system 2900 shown in FIGS. 29A and 29B. The flow path of the filtering operation 2910 is shown in FIG. 29C by the solid thick arrows, 2761 through 2763. The raw fluid enters the air purification system 2900 from the main inlet 2130. Then, in some cases, the raw flow may pass through a prefilter, then passes through the main filter 2930 from the dirty side to the clean side. After the particles are trapped or filtered by the main filter 2930, the cleaned air leaves the air purification system 2900 via the main outlet 2912. To generate the flow, a blower may be placed before or after the main filter 2930. Further, in some cases, at least a portion of the sensors (e.g., the outlet sensors 2914 or the inlet sensors 2934) may measure or characterize the raw flow and the cleaned air before and after filtration by the air purification system 2900. In some cases, the ECU 2936 may process or transmit data to one or more devices or computing components (e.g., a display system, a cloud, a user, a mobile device, etc.). Parameters such as speed, humidity, temperature, disinfection systems or results may be controlled (e.g., by the ECU 2936, an end user, a program, AI, etc.) wirelessly or by wired connection. The data may be stored within the ECU 2936 or saved somewhere else, such a cloud. The flow may be directed by several valves or dampers (e.g., the damper 2916) through the ducting path to control and direct flow path during cleaning operation and during filtering operation. During filtering operation, the damper 2916 may be closed, which blocks the air from entering the collector 2912. Also, the damper 2918 may be closed to prevent uncleaned air from leaving the air purification system 2900.

Referring to FIG. 29D, an example cleaning operation is illustrated which depicts an open system (e.g., the raw air enters air purification system 2900 and the cleaned air leaves the air purification system 2900 during the cleaning operation. The dashed arrows (2962 through 2964) illustrate the flow path during such cleaning operation.

Although FIGS. 29A-29D illustrate, by way of example and not limitation, one example air purifier, the air purification system 2900, the disclosed systems and methods may be utilized in various other applications, such as HVAC systems for residential and industrial environments, airplane filtration systems, submarines and other vessels, space shuttles, and any other application where the particles are maintained within the filtration system during a cleaning operation or stored inside the filtration system (e.g., may be collected and stored in a collector).

Although FIGS. 29A-29D illustrate, by way of example and not limitation, one example air purifier, the air purification system 2900, the disclosed systems and methods may be utilized in various other geometries, configurations, and implementations. Among other examples, the filter may be flat, cylindrical, conic or any other geometry, depending on applications and design. In some cases, the cleaning operation may be started when motion is not detected in proximity to the filtration system (e.g., there are no humans near the air purifier). Here, for example, one or more sensors, such as motion detectors, sound detectors, heat detectors, or the like may be used to detect a human presence. Accordingly, in such cases, the cleaning operation may be stopped when somebody enters the area of the air purifier. Also, the cleaning operation may be equipped with AI or machine learning, which based on its algorithms, may decide how the cleaning operation works (e.g., the start time, the stop time, the duration of filtration, the flow rate, temperature, humidity, etc.).

According to various cases herein, the disclosed systems and methods may be utilized in many other applications, e.g., where the particles are stored or maintained within the filtration system during cleaning operation. In certain cases, for example, the disclosed systems and methods may be utilized to clean emissions systems. By way of non-limiting examples, the disclosed systems and methods may reduce the emissions of internal combustion engines or the emissions from power plants (e.g., by cleaning and improving the efficiency of intake and outlet compartments used to clean, filter, absorb, destroy, change, etc. chemical or physical compositions). Among other utilizations, for example, the disclosed systems and methods may be used in exhaust systems of any type of motor vehicles, power plants, or the like.

### Examples of Filter Media With Grilles

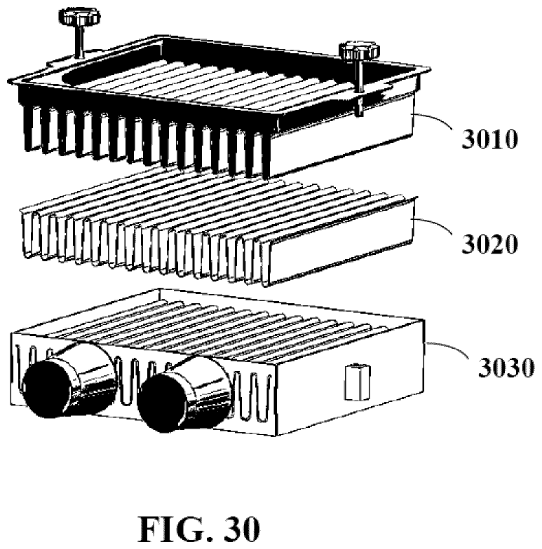

FIG. 30 illustrates an exploded view of an example self-cleaning filtration system, consistent with certain examples of the present disclosure. More specifically, FIG. 30 illustrates a grille 3010, a filter media 3020, and a main frame 3030. The filtration system of FIG. 30 may be the same as or similar to, in one or more respects, various filtration systems discussed herein.

The grille 3010 may serve a similar purpose as the various reinforced structures (e.g., the reinforced structure 720 of FIG. 7A) discussed herein. For example, the grille 3010 may protect and reinforce the filter media 3020 (as, for example, the filter media 3020 may be flexible or fragile). Furthermore, the grille 3010 may aid in transmitting shaking from shaking sources to the filter media 3020. The grille 3010, as illustrated, includes two screw-downs. The two screw-downs may help to secure the grille 3010 to the filter housing 3030 with the filter media 3020 in between. As such, the filter media 3020 may be secured and hold tightly during filtering operation and cleaning operation. Once the lifetime of the filter media 3020 is met, the screw-downs may be released, enabling the filter media 3020 to be removed and replaced.

The filter housing and reinforced structure 3030 may serve a similar purpose as the various filter housing (e.g., the filter housing 705 of FIG. 7A) discussed herein. The grille may be made of a more rigid material (e.g., metal) than the filter media 3020. For example, the filter housing and reinforced structure 3030 may protect and reinforce the filter media 3020 (as, for example, the filter media 3020 may be flexible or fragile). Also the filter housing and reinforced structure 3030 transfer/transmit the mechanical vibration, mechanical wave to the filter media which facilitate the particle release during cleaning operation. As illustrated, the main frame 3030 may include integrated actuators for shaking the filter housing and reinforced structure 3030 and as result the filter media 3020. As also illustrated, the filter housing and reinforced structure 3030 may further include an integrated reinforcement structure for supporting the bottom side of the filter media 3020.

In some cases, the filter media 3020 may be placed between the grille 3010 and the filter housing or reinforced structure 3030. In some cases, the filter media 3020 may be secured via a screw or any other mechanism to hold the grille 3010 and the filter housing and reinforced structure 3030 together, such that the filter media 3020 has no or very small relative motion.

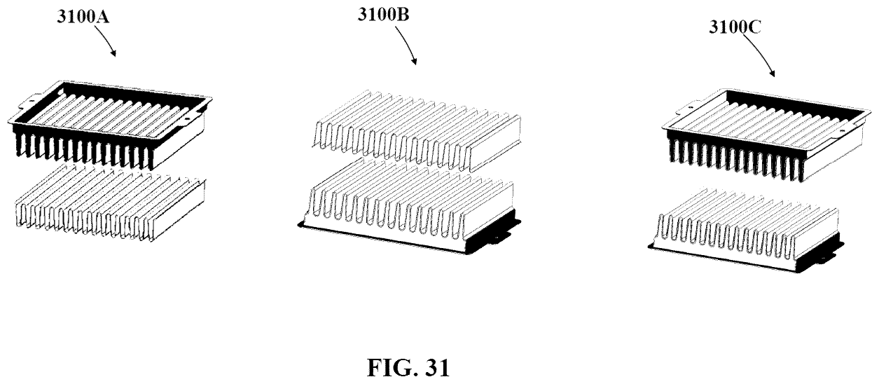

FIG. 31 illustrates an example process for assembling a filter structure using a top grille and a bottom grille (one or both of which may be the same as or similar to the grille 3010 of FIG. 30), consistent with certain examples of the present disclosure. At 3100A, a first filter media is inserted into the top grille, forming an upper filter structure. At 3200B, a second filter media is inserted into the bottom grille, forming a lower filter structure. Then, at 3200C, the upper filter structure and the lower filter structure are inserted into each other, forming the filter structure that is rigid, due to, for example, the top grille and the bottom grille, and includes two filter media. The filter structure presents certain advantages. For example, the rigidity of the structure may enable the filter structure to be used in more unpredictable or harsh environments (e.g., construction equipment, off-road vehicles, etc.). As another advantage, it provides an easy and user friendly experience when filter media need to be replaced. In another example, the dual filter nature of the filter structure may improve the filter ability of the filter structure.

### Further Examples of Collectors

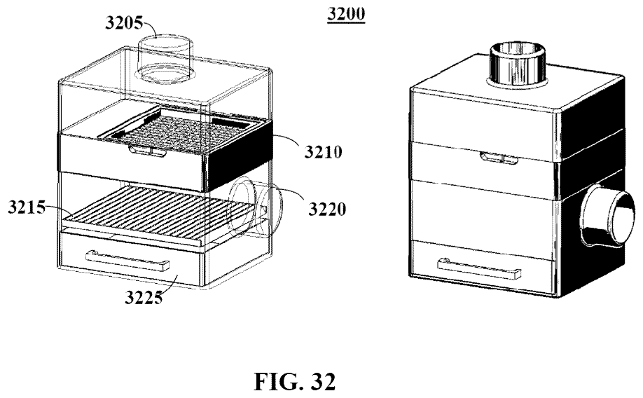

FIG. 32 illustrates two perspectives of another example self-cleaning filtering system 3200, consistent with example aspects of certain examples of the present disclosure. More specifically, FIG. 32 illustrates the filtering system 3200 in a view that may be seen by a human eye and in a semi-transparent view. For ease of description, FIG. 32 will be described herein with reference to the semi-transparent view. The filtering system 3200 may be the same as or similar to, in one or more respects, various filtering systems discussed herein. The filtering system 3200 may further include an outlet 3205, a grille 3215, an inlet 3220, and a collector 3225. The particles may be collected in the collector 3225 during cleaning process. The collector 3225 may need to get empty frequently by human or by some actuator(s), depending on application and design.

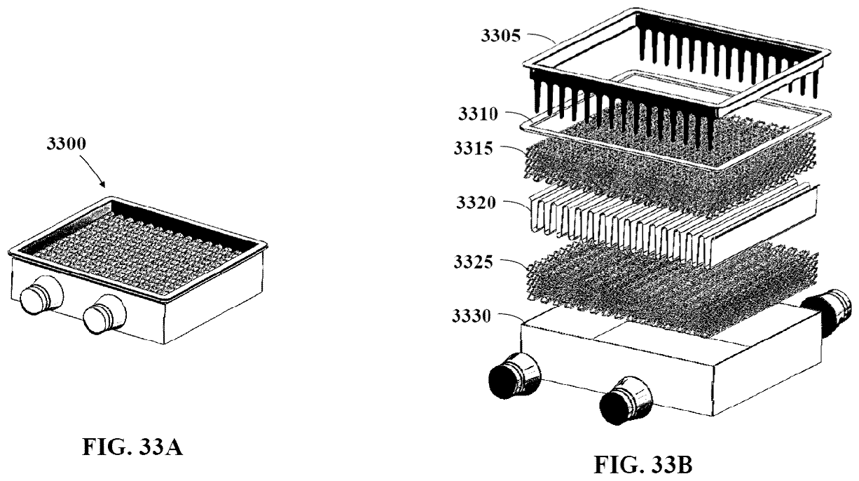

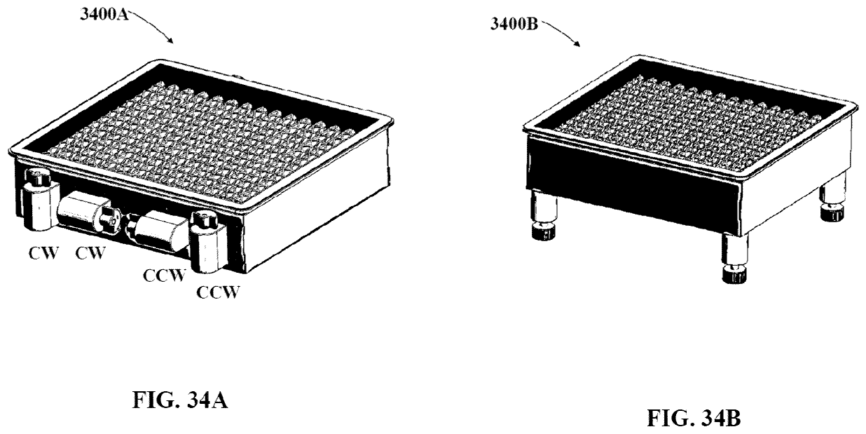

During filtering operation, fluid may flow may be from the inlet 3220 upward, through the mesh filer structure 3210, and out the outlet 3205. As such, particles may accumulate (e.g., diffuse, permeate, attach, adhere, build up, become trapped, etc.) at the underside of the filter media compartment 3210, forming a dirty side. During cleaning operation, actuator(s) may generate mechanical wave, vibration, force, etc. to shake the filter media as discussed in detail before. (e.g., using any of the methods for generation or controlling fluid flow discussed herein) from the inlet 3220 to the mesh filter structure 3210, and out the outlet 3205. In some cases, the mesh filter 3210 may be shook in addition or in alternative to the reverse flow. During the cleaning operation, as a result of one or both of shaking the mesh filter structure 3210 or the reverse flow, at least some of the particles may be dislodged from the dirty side of the mesh filter structure 3210. The particles may fall through the grille 3215, and into the collector 3225. In some cases, the grille 3215 may be opened during cleaning operation and closed during filtration operation. For example, the grille 3215 may be closed during filtering operation and may be opened during the cleaning operation. The filter compartment 3210 may be described in further detail with respect to FIGS. 33A, 33B, 34A, and 34B.

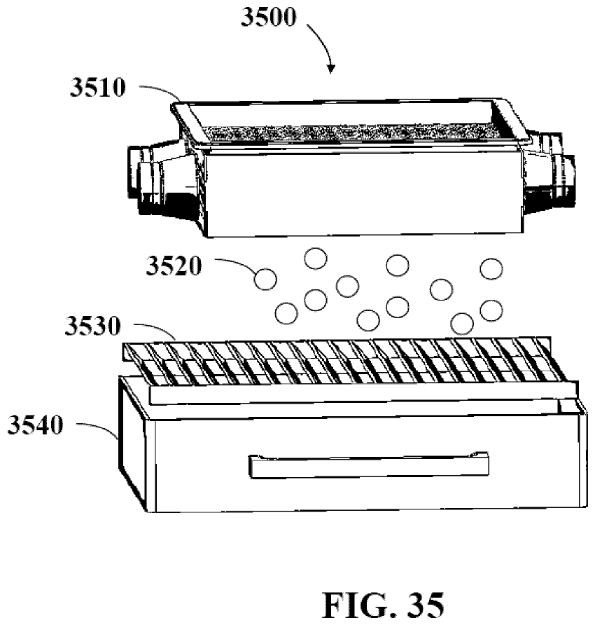

FIG. 35 illustrates an example self-cleaning filtration system 3500 with filter structure 3510, a grille 3530, and a collector 3540, consistent with example aspects of certain examples of the present disclosure. The filter compartment 3510, the grille 3530, and the collector 3540 may each be the same as or similar to their respective elements described with respect to FIG. 32 and elsewhere herein.

In some cases, the shaking process may be designed to prevent particles 3520 from re-accumulating to the filter compartment 3510 during the shaking and/or during filtration process. In some cases, the filter compartment 3510 is shaken such that the applied force has one component in Z-direction (Z-axis is defied to be perpendicular to the ground (here the ground is parallel to the XY-plane) and the positive Z-direction is defined from bottom to top, such that the positive Z-direction is defined to be in oppositive direction of gravitational force of the Earth). During the cleaning operation, the component of the net applied force in Z direction, F_{Z}, on the filter compartment 3510 in the Z-direction may be zero or positive to reduce the diffusion of particles into the filter media. The net acceleration (assuming operation in a vacuum) of particles in Z-direction is equal to g+a, where g is the gravitational acceleration of the Earth (−9.81 m/s²) and a is the value of acceleration of the particles due to the reverse flow in Z-direction. When the shaking force is applied to the filter housing or reinforced structure, the frequency of net applied load in Z-direction may be set lower than √(|g+a|/2X), where X is the maximum distance that the filter structure 3510 travels during half of a cycle of shaking.

FIGS. 33A and 33B illustrate perspective and exploded views, respectively, of an example self-cleaning filtering system 3300, consistent with example aspects of certain examples of the present disclosure. With reference to FIG. 34B, the filtering system 3300 includes a reinforced structure 3305, a sealing element 3310, a top mesh 3315, a filter media 3320, a bottom mesh 3325, and a filter housing 3330. The reinforced structure 3305, the sealing element 3310, the filter media 3320, and the filter housing 3330 may each be the same as or similar to their respective components described in further detail elsewhere herein.

The top mesh reinforcement structure 3315 and the bottom mesh reinforcement structure 3325 may serve a similar purpose as the reinforcement structures (e.g., the reinforcement structure 720 of FIG. 7A) described herein. The top mesh reinforcement structure 3315 and the bottom mesh reinforcement structure 3325 may be made of metallic materials, plastic materials, polymer materials, composite materials, or any other structural materials or a combination of several materials. In some cases, the top mesh reinforcement structure 3315 and the bottom mesh reinforcement structure 3325 may enable the indirect application of shaking forces from one or more shaking sources (e.g., actuators) to the filter media 3320, thereby reducing the strain and possibility of damage to the filter media 3320 due to shaking. The top mesh reinforcement structure 3315 and the bottom mesh reinforcement structure 3325 may further aid the filter media 3320 in maintaining shape and structure, especially during the shaking process. The top mesh reinforcement structure 3315 and the bottom mesh 3325, due to their geometries, may enable particles to flow largely unimpeded through the top mesh reinforcement structure 3315 and the bottom mesh 3325. The top mesh reinforcement structure 3315 and the bottom mesh reinforcement structure 3325 may be shaped with overall profiles to match the profile of the filter media 3320, which as illustrated, is a zig-zag shape.

FIGS. 34A and 34B illustrate example self-cleaning filtering systems with rotary eccentric mass and linear motion mass actuators, respectively, consistent with example aspects of certain examples of the present disclosure. At FIGS. 34A and 34B the rotary and linear actuators are respectively applied to self-cleaning filtering systemsto. The mesh in the self-cleaning filtering system of FIG. 34A may enable the actuators to effectively apply the shaking to filter media included therein with reduced risk of damaging the filter media. In some cases, there may be one or more damping springs between the top mesh reinforcement structure 3315 and the filter media 3320 or the bottom mesh reinforcement structure 3325 and the filter media 3320.

At FIG. 34A, rotary eccentric mass actuators may be used. To provide shaking in desired directions, the rotational directions of rotatory actuators may be in the opposite directions, thereby canceling out the motion in the undesired directions. At FIG. 34B, linear actuators with an attached mass may induce shaking. In some cases, the relative acceleration vector may be positive between the dirty side of the filter media and the reinforced structures (e.g., the mesh, as illustrated) or housing to prevent defusing of the particles into the filter media due to imposed shaking (as explained with respect to FIG. 4D and FIG. 35).

### Example Autonomous Vacuum Unit

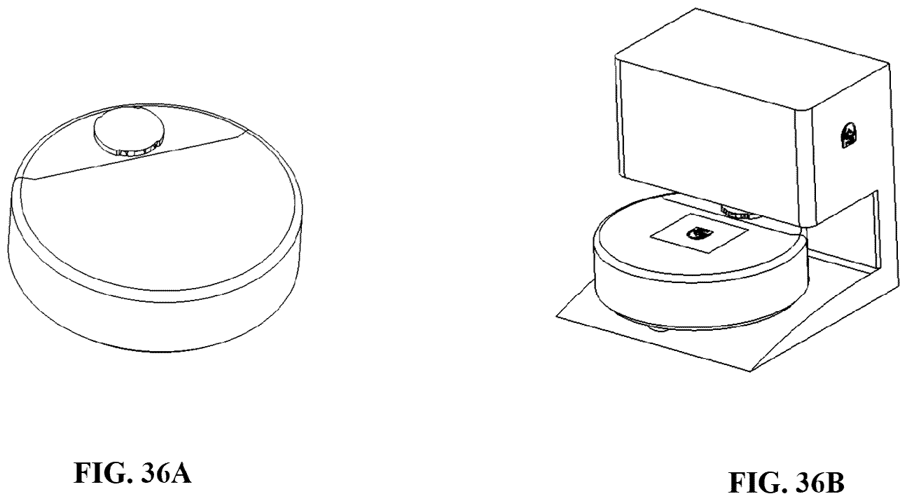

FIGS. 36A and 36B illustrate an example autonomous vacuum unit implementing an example self-cleaning filtering system, consistent with example aspects of certain examples of the present disclosure. The systems and methods for self-cleaning filtering systems described herein may be particularly suited for the autonomous vacuum unit implementation in that the systems and methods may require less frequent maintenance or human intervention. As such, the autonomous vacuum unit depicted in FIGS. 36A and 36B may include self-cleaning filtering systems that may be the same as or similar to one or more filtering systems described herein.

In some cases, filtering operation of the filtering system may occur while the autonomous vacuum unit is cleaning (e.g., cleaning a floor). Conversely, when the autonomous vacuum unit is done cleaning the floor (e.g., when the autonomous vacuum unit is in station), the filtering system may undergo one or more of the cleaning operations discussed herein. For example, the filtering system in the autonomous vacuum unit may use shaking techniques (e.g., as described herein) to clean filter media inside the autonomous vacuum unit while the autonomous vacuum unit is at station. In some cases, the reverse flow may be used in addition of the shaking to enhance the cleaning operation of the filter media at the station. In some cases, the autonomous vacuum unit may include a plurality of filter media such that one or more filter media may be in filtering operation while one or more other filter media are in the cleaning operation (e.g., as described with respect to FIGS. 19A-19C). In such cases, the autonomous vacuum unit may be able to clean for long periods of time (e.g., 12 hours or more) and may be limited by the power capacity of the autonomous vacuum unit, not by the state of the filters within the autonomous vacuum unit. In some cases, when the filter media within the autonomous vacuum unit have reached their lifetime, (i) the filter media or (ii) the filter media plus the reinforced structures or the filter housing may be replaced (not, e.g., the actuators, the main frame, etc.).

### Example Performance Data

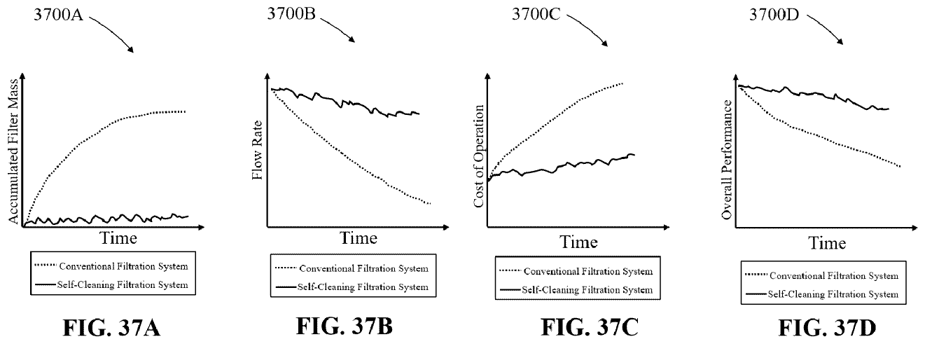

FIGS. 37A, 37B, 37C, and 37D illustrate various schematic example performance data 3700A-3700D of a self-cleaning filtering system, consistent with examples of the present disclosure. The example schematic performance data 3700A-3700D may include schematic performance data that corresponds to (i) a conventional filtering system, and (ii) a self-cleaning filtering system that is consistent with examples of the present disclosure.

FIG. 37A includes example schematic performance data 3700A that plots accumulated mass on filter media as a function of time. The accumulated mass represents the mass gained to the filter media by particles accumulating at the filter media. As illustrated in the schematic performance data 3700A, as time increases, the conventional filtering system increases accumulated mass at a decreasing rate, as the conventional filtering system approaches saturation of particles. The self-cleaning filtering system, as illustrated in the experimental performance data 3700A, increases in accumulated mass at a slower rate than the conventional filtering system and does so with a zig-zag pattern. In the zig-zag pattern, each downward portion may correspond to a cleaning operation (e.g., shaking the filter media in the self-cleaning filtering system).

FIG. 37B includes example schematic performance data 3700B that plots flow rate as a function of time. The flow rate represents the rate fluid may flow through the filter media during filtering operation. As illustrated in the schematic performance data 3700A, as time increases, the conventional filtering system increases accumulated mass, and, as such, in the conventional filtering system, the flow rate may decrease during the time The self-cleaning filtering system, as illustrated in the schematic performance data 3700A, increases in accumulated mass at a slower rate than the conventional filtering system, and, as such, the self-cleaning filtering system decreases in flow rate at a lower rate (again with the zig-zag pattern that may correspond to the cleaning operation) than the conventional filtering system.

FIG. 37C includes example schematic performance data 3700C that plots cost of operation as a function of time. The cost of operation may represent the power or energy consumed during filtering operation as well as the cost of replacing the filter. As illustrated in the schematic performance data 3700A, as time increases, the conventional filtering system increases accumulated mass, and, as such, the conventional filtering system suffers from a cost of operation that increases. The self-cleaning filtering system, as illustrated in the schematic performance data 3700A, increases in accumulated mass at a slower rate than the conventional filtering system, and, as such, the self-cleaning filtering system increases in cost of operation at a lower rate (again with the zig-zag pattern that may correspond to the cleaning operation) than the conventional filtering system.

FIG. 37D includes example schematic performance data 3700D that plots overall performance as a function of time. The overall performance represents the accumulative effects of the accumulated mass, the flow rate, and the cost of operation, each plotted for the experimental performance data 3700A, 3700B, and 3700C, respectively. As illustrated in the schematic performance data 3700D, as time increases, the overall performance of the conventional filtering system decreases. The self-cleaning filtering system, as illustrated in the experimental performance data 3700D, also decreases in overall performance (again with the zig-zag pattern that may correspond to the cleaning operation), but at a much lower rate than the conventional filtering system.

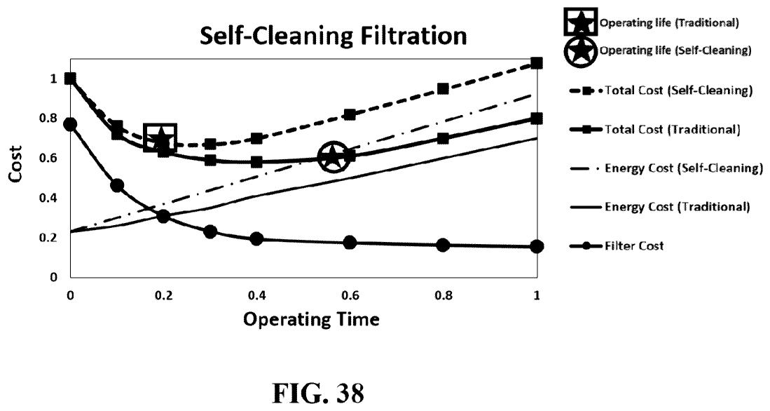

FIG. 38 illustrates example schematic of operating cost data of a self-cleaning filtering system, consistent with example aspects of certain examples of the present disclosure. FIG. 38 includes example schematic of operating cost data 3800 that plots cost as a function of time for both (i) a conventional filtering system, and (ii) a self-cleaning filtering system that is consistent with examples of the present disclosure. The operating cost data 3800 represents the amount of time filter media may be used before being replaced, based on energy cost and filter cost. As illustrated, once total cost for the conventional filter system and the self-cleaning filter system equal 0.3 for the unit time, it is cost effective to replace the filter media in the conventional filter system and the self-cleaning filter system. As illustrated in the operating life data 3800, the filter media of the conventional filtering system may be replaced in half the time that the filter media of the self-cleaning filtering system may be replaced. In doubling the lifetime of the filter media, the self-cleaning filter system reduces cost as well as waste and use of excess filter media. In some cases, the life of the filter media may be extended on the order of tens, depending on application and design.

### Example Computer Systems

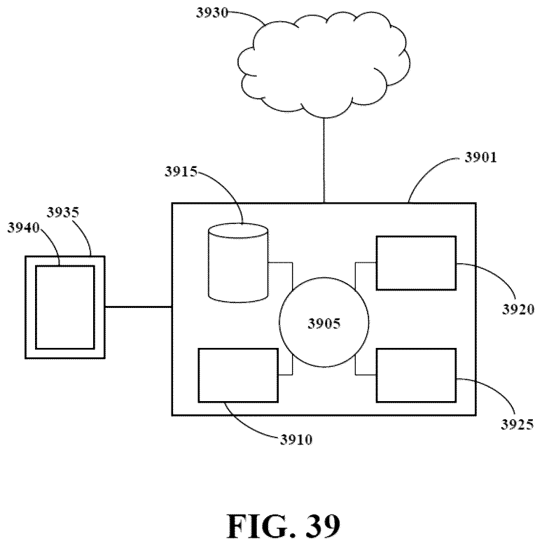

FIG. 39 shows a computer system 3901 that is programmed or otherwise configured to operate any method, system, computer-readable media, process, or technique described herein (such as systems or methods of self-filtering media, described herein). For example, the computer system 3901 may be the same as or similar to (or an implementation of) the ECU 1118, the ECU 2018, the ECU 2618, or the ECU 2936.

The computer system 3901 can regulate various aspects of the present disclosure. The computer system 3901 can be an electronic device of a user or a computer system that is remotely located with respect to the electronic device. The electronic device can be a mobile electronic device.

The computer system 3901 includes a central processing system (CPU, also “processor” and “computer processor” herein) 3905, which can be a single core or multi core processor, or a plurality of processors for parallel processing. The computer system 3901 also includes memory or memory location 3910 (e.g., random-access memory, read-only memory, flash memory), electronic storage system 3915 (e.g., hard disk), communication interface 3920 (e.g., network adapter) for communicating with one or more other systems, and peripheral devices 3925, such as cache, other memory, data storage or electronic display adapters. The memory 3910, storage system 3915, interface 3920 and peripheral devices 3925 are in communication with the CPU 3905 through a communication bus (solid lines), such as a motherboard. The storage system 3915 can be a data storage system (or data repository) for storing data. The computer system 3901 can be operatively coupled to a computer network (“network”) 3930 with the aid of the communication interface 3920. The network 3930 can be the Internet, an internet or extranet, or an intranet or extranet that is in communication with the Internet. The network 3930 in some cases is a telecommunication or data network. The network 3930 can include one or more computer servers, which can enable distributed computing, such as cloud computing. The network 3930, in some cases with the aid of the computer system 3901, can implement a peer-to-peer network, which may enable devices coupled to the computer system 3901 to behave as a client or a server.

The CPU 3905 can execute a sequence of machine-readable instructions, which can be embodied in a program or software. The instructions may be stored in a memory location, such as the memory 3910. The instructions can be directed to the CPU 3905, which can subsequently program or otherwise configure the CPU 3905 to implement methods of the present disclosure. Examples of operations performed by the CPU 3905 can include fetch, decode, execute, and writeback.

The CPU 3905 can be part of a circuit, such as an integrated circuit. One or more other components of the system 3901 can be included in the circuit. In some cases, the circuit is an application specific integrated circuit (ASIC).

The storage system 3915 can store files, such as drivers, libraries and saved programs. The storage system 3915 can store user data, e.g., user preferences and user programs. The computer system 3901 in some cases can include one or more additional data storage systems that are external to the computer system 3901, such as located on a remote server that is in communication with the computer system 3901 through an intranet or the Internet.

The computer system 3901 can communicate with one or more remote computer systems through the network 3930. For instance, the computer system 3901 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 3901 via the network 3930.

Methods as described herein can be implemented by way of machine (e.g., computer processor) executable code stored on an electronic storage location of the computer system 3901, such as, for example, on the memory 3910 or electronic storage system 3915. The machine executable or machine readable code can be provided in the form of software. During use, the code can be executed by the processor 3905. In some cases, the code can be retrieved from the storage system 3915 and stored on the memory 3910 for ready access by the processor 3905. In some situations, the electronic storage system 3915 can be precluded, and machine-executable instructions are stored on memory 3910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 3901, can be embodied in programming. Various aspects of the technology may be thought of as “products” or “articles of manufacture” typically in the form of machine (or processor) executable code or associated data that is carried on or embodied in a type of machine readable medium. Machine-executable code can be stored on an electronic storage system, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code (e.g., computer-readable media), may take many forms, including but not limited to, a tangible storage medium, a carrier wave medium or physical transmission medium. Non-volatile storage media include, for example, optical or magnetic disks, such as any of the storage devices in any computers or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 3901 can include or be in communication with an electronic display 3935 that comprises a user interface (UI) 3940. Examples of UI's include, without limitation, a graphical user interface (GUI) and web-based user interface.

Methods and systems of the present disclosure can be implemented by way of one or more algorithms. An algorithm can be implemented by way of software upon execution by the central processing system 3905.

### Example Method

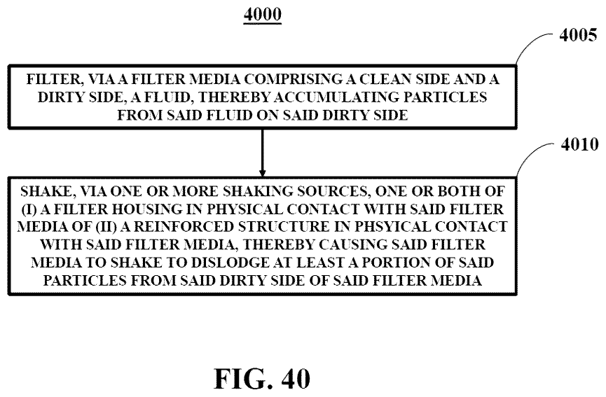

FIG. 40 illustrates an example method 4000 for self-filtering media, consistent with certain examples of the present disclosure. The method may include (a) filtering, via a filter media comprising a clean side and a dirty side, a fluid, thereby accumulating particles from said fluid on said dirty side (block 4005); and (b) shaking, via one or more shaking sources, one or both of (i) a filter housing in physical contact with said filter media or (ii) a reinforced structure in physical contact with said filter media, thereby causing said filter media to shake to dislodge at least a portion of said particles from said dirty side of said filter media (block 4010). The method 4000 may implement one or more of the systems, methods, computer-readable media, techniques, processes, operations, or the like that are described herein.

### Additional Considerations

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the” or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where values are described in the application and claims, unless otherwise stated the term “about” meaning within an acceptable error range for the particular value may be assumed.

It should be noted that various illustrative or suggested ranges set forth herein are specific to their example embodiments and are not intended to limit the scope or range of disclosed technologies, but, again, merely provide example ranges for frequency, amplitudes, etc. associated with their respective embodiments or use cases.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A self-cleaning filtration system, comprising:
a filter media comprising a clean side of said filter media and a dirty side of said filter media, wherein said dirty side of said filter media is configured to accumulate particles from a fluid while performing a filtering operation on said fluid;
one or both of (i) a filter housing in physical contact with said filter media or a (ii) reinforced structure in physical contact with said filter media; and
one or more shaking sources configured to shake one or more of said filter housing, said reinforced structure, or said filter media, thereby causing said filter media to shake to dislodge at least a portion of said particles from said dirty side of said filter media.

2. The self-cleaning filtration system of claim 1, further comprising:
one or more flow stream sources configured to, via one or more valves or one or more dampers, direct a flow stream from said clean side of said filter media to said dirty side of said filter media to dislodge at least one of said particles from said dirty side of said filter media.

3. (canceled)

4. The self-cleaning filtration system of claim 1, further comprising a second filter media, and wherein said one or more shaking sources are configured to shake one or more of said filter housing, said reinforced structure, or said filter media, thereby causing said filter media to shake while said second filter media performs a second filtering operation on a second fluid, wherein said second filter media is in physical contact with one or both of (i) a second filter housing or (ii) a second reinforced structure.

5-8. (canceled)

9. The self-cleaning filtration system of claim 1, wherein
(i) said filter media is oriented such that said clean side of said filter media is at a first position and said dirty side of said filter media is at a second position, wherein said first position is at a higher gravitational potential than said second position; and
(ii) said one or more shaking sources are configured to shake one or more of said filter housing, said reinforced structure, or said filter media with a downward acceleration not exceeding a gravitation acceleration of the Earth.

10. (canceled)

11. (canceled)

12. The self-cleaning filtration system of claim 1, wherein said one or more shaking sources comprise one or more high-frequency actuators that are configured to shake one or more of said filter housing, said reinforced structure, or said filter media, at a frequency of 10 kHz-200 kHz; and wherein one or both of:
(i) said one or more high-frequency actuators comprise one or both of a piezoelectric actuator or an ultrasonic transducer; or
(ii) said one or more high-frequency actuators are mechanically coupled to one or more of said filter housing, said reinforced structure, or said filter media.

13-17. (canceled)

18. The self-cleaning filtration system of claim 1, wherein said one or more shaking sources are configured to shake one or more of said filter housing, said reinforced structure, or said filter media with a shaking force that has a zero or negative component along a normal surface vector of said dirty side of said filter media, wherein a positive direction of said normal surface vector is defined from said dirty side of said filter media to said clean side of said filter media.

19. The self-cleaning filtration system of claim 1, further comprising:
one or more elastic components mechanically coupled to one or both of said filter housing or said reinforced structure, and wherein said one or more shaking sources comprise one or more low-frequency actuators that are configured to shake one or more of said filter housing, said reinforced structure, or said filter media at a frequency of 0.1 Hz-1 kHz.

20-22. (canceled)

23. The self-cleaning filtration system of claim 1, wherein
said one or more shaking sources are configured to sequentially shake one or both of said filter housing or said reinforced structure at a first frequency and then a second frequency, and wherein;
(i) said first frequency is between 0.1 Hz and 1 kHz and said second frequency is between 10 kHz and 200 kHz; or
(ii) said first frequency is between 10 kHz and 200 kHz and said second frequency is between 0.1 Hz and 1 kHz.

24. The self-cleaning filtration system of claim 1, wherein one or more of said reinforced structure, said filter housing, or said filter media, comprise one or more metallic materials.

25. The self-cleaning filtration system of claim 1, wherein said one or more shaking sources are mechanically coupled to one or more of said reinforced structure, said filter housing, or said filter media.

26. The self-cleaning filtration system of claim 25, wherein said one or more shaking sources are configured to shake one or more of said reinforced structure, said filter housing, or said filter media at least in part by generating one or more waves that propagate through one or more of said reinforced structure, said filter housing, or said filter media.

27-33. (Canceled)

34. A self-cleaning filtering method, comprising:
filtering, via a filter media comprising a clean side of said filter media and a dirty side of said filter media, a fluid, thereby accumulating particles from said fluid on said dirty side of said filter media; and
shaking, via one or more shaking sources, one or more of (i) a filter housing in physical contact with said filter media, (ii) a reinforced structure in physical contact with said filter media, or (iii) said filter media, thereby causing said filter media to shake to dislodge at least a portion of said particles from said dirty side of said filter media.

35. (canceled)

36. The self-cleaning filtering method of claim 34, wherein said one or more flow stream sources are configured to direct, via one or more valves or one or more dampers, said flow stream from said clean side of said filter media to said dirty side of said filter media.

37. The self-cleaning filtering method of claim 34, wherein
said one or more shaking sources are configured to shake one or more of said filter housing, said reinforced structure, or said filter media, thereby causing said filter media to shake while a second filter media performs a second filtering operation on a second fluid, wherein said second filter media is in physical contact with one or both of (i) a second filter housing or (ii) a second reinforced structure.

38-41. (canceled)

42. The self-cleaning filtering method of claim 34, wherein:
(i) said filter media is oriented such that said clean side of said filter media is at a first position and said dirty side of said filter media is at a second position, wherein said first position is at a higher gravitational potential than said second position; and
(ii) said one or more shaking sources are configured to shake one or more of said filter housing, said reinforced structure, or said filter media with a downward acceleration not exceeding a gravitation acceleration of the Earth.

43. (canceled)

44. (canceled)

45. The self-cleaning filtering method of claim 34, wherein said one or more shaking sources comprise one or more high-frequency actuators that are configured to shake one or both of said filter housing or said reinforced structure at a frequency of 10 kHz-200 kHz and wherein one or both of:
(i) said one or more high-frequency actuators comprise one or both of a piezoelectric actuator or an ultrasonic transducer; or
(ii) said one or more high-frequency actuators are mechanically coupled to one or more said filter housing, said reinforced structure, or said filter media.

46-50. (canceled)

51. The self-cleaning filtering method of claim 34, wherein said one or more shaking sources are configured to shake one or more of said reinforced structure, said filter housing, or said filter media with a shaking force that has a zero or negative component along a normal surface vector of said dirty side of said filter media, wherein a positive direction of said normal surface vector is defined from said dirty side of said filter media to said clean side of said filter media.

52-55. (canceled)

56. The self-cleaning filtering method of claim 34, wherein
said one or more shaking sources are configured to sequentially shake one or both of said filter housing or said reinforced structure at a first frequency and then a second frequency, and wherein:
(i) said first frequency is between 0.1 Hz and 1 kHz and said second frequency is between 10 kHz and 200 kHz; or
(ii) said first frequency is between 10 kHz and 200 kHz and said second frequency is between 0.1 Hz and 1 kHz.

57. The self-cleaning filtering method of claim 34, wherein;
(i) one or more of said reinforced structure, said filter housing, or said filter media, comprise one or more metallic materials; and
(ii) said one or more shaking sources are mechanically coupled to one or more of said reinforced structure, said filter housing, or said filter media.

58. The self-cleaning filtering method of claim 34, wherein said one or more shaking sources are configured to shake one or more of said reinforced structure, said filter housing, or said filter media at least in part by generating one or more waves that propagate through one or more of said reinforced structure, said filter housing, or said filter media.

59-66. (canceled)
